(19) United States
(12) Patent Application Publication
(10) Pub. No.: US 2016/0209869 A1
(43) Pub. Date: Jul. 21, 2016

(54) Wearable propping display holder apparatus

(71) Applicant: Charles Augustus Daley, III, Rawai (TH)

(72) Inventor: Charles Augustus Daley, III, Rawai (TH)

(21) Appl. No.: 14/999,009

(22) Filed: Mar. 17, 2016

Related U.S. Application Data
(63) Continuation-in-part of application No. 14/998,517, filed on Jan. 13, 2016.
Application No. 14/998,517 is a continuation-in-part of application No. 14/757,169, filed on Nov. 30, 2015.
Application No. 14/757,169 is a continuation-in-part of application No. 14/121,914, filed on Nov. 3, 2014.
(60) Provisional application No. 62/177,589, filed on Mar. 19, 2015.
(60) Provisional application No. 62/177,911, filed on Mar. 27, 2015.
(60) Provisional application No. 62/178,802, filed on Apr. 20, 2015.
(60) Provisional application No. 62/179,337, filed on May 5, 2015.
(60) Provisional application No. 62/179,821, filed on May 20, 2015.
(60) Provisional application No. 62/230,065, filed on May 27, 2015.
(60) Provisional application No. 62/230,926, filed on Jun. 19, 2015.
(60) Provisional application No. 62/231,806, filed on Jul. 16, 2015.

(51) Int. Cl. G06F 1/16; A45F 5/00

(52) U.S. Cl. CPC G06F 1/163; A45F 5/00; G06F 1/1675; A45F 2005/006

(57) ABSTRACT

The disclosed apparatus is a wearable display panel holder that suspends the display from an operator's neck (or shoulder) by a strap and includes a prop to push the display panel away from the operator's stomach/chest and into his comfortable view without using his hands. The bottom end of the prop makes contact with the operator using an interface designed to provide lateral tipping stability and sliding stability in all directions. The prop may include an adjustable extension to better position the display. Embodiments may hold single panel displays or two panel notebook computers. The notebook version uses an interface component and strap/holder component with the computer body panel being the prop.

### CROSS-REFERENCE TO RELATED APPLICATIONS

This application is a Continuation-In-Part of U.S. copending patent application Ser. No. 14/998,517, filed on Jan. 13, 2016, the entire teachings of which are incorporated herein by reference.

This application is a Continuation-In-Part of U.S. copending patent application Ser. No. 14/757,169, filed on Nov. 30, 2015, the entire teachings of which are incorporated herein by reference.

This application is a Continuation-In-Part of U.S. copending patent application Ser. No. 14/121,914, filed on Nov. 3, 2014, the entire teachings of which are incorporated herein by reference.

This application claims the filing benefit under 35 U.S.C. §119(e) of U.S. Provisional Application No. 62/177,589, filed on Mar. 19, 2015, the entire teachings of which are incorporated herein by reference.

This application claims the filing benefit under 35 U.S.C. §119(e) of U.S. Provisional Application No. 62/177,911, filed on Mar. 27, 2015, the entire teachings of which are incorporated herein by reference.

This application claims the filing benefit under 35 U.S.C. §119(e) of U.S. Provisional Application No. 62/178,802, filed on Apr. 20, 2015, the entire teachings of which are incorporated herein by reference.

This application claims the filing benefit under 35 U.S.C. §119(e) of U.S. Provisional Application No. 62/179,337, filed on May 5, 2015, the entire teachings of which are incorporated herein by reference.

This application claims the filing benefit under 35 U.S.C. §119(e) of U.S. Provisional Application No. 62/179,821, filed on May 20, 2015, the entire teachings of which are incorporated herein by reference.

This application claims the filing benefit under 35 U.S.C. §119(e) of U.S. Provisional Application No. 62/230,065, filed on May 27, 2015, the entire teachings of which are incorporated herein by reference.

This application claims the filing benefit under 35 U.S.C. §119(e) of U.S. Provisional Application No. 62/230,926, filed on Jun. 19, 2015, the entire teachings of which are incorporated herein by reference.

This application claims the filing benefit under 35 U.S.C. §119(e) of U.S. Provisional Application No. 62/231,806, filed on Jul. 16, 2015, the entire teachings of which are incorporated herein by reference.

### TECHNICAL FIELD

The present invention relates to a wearable electronic display holder designed for mobile use.

### BACKGROUND OF THE INVENTION

With the ubiquitous use of computers mobile computing has become normal. Computer manufacturers have approached mobile computing with two machines; the handheld mobile telephone/computer and the “notebook” computer (two pivotally attached panels).

The “notebook” computer has the advantage of standard programming capability, keyboard, more connections for accessories and bigger display. Their disadvantage is their size, weight and poor adaptation for usage while moving. Even around a house equipped with wireless telecommunication the notebook has mobility problems. Suitable places for setting the notebook may not be close enough to or align with the operator's position (for example on a coffee table or on a bed). Balancing a notebook computer on the lap includes the worry of slipping off.

The handheld mobile telephone/computer is, of course, reduced in capability compared to the notebook computer. It has the further disadvantage of requiring hand holding and small display, a limiting disadvantage when viewing material for a longer period.

There are many inventions for holding computers for mobile use. Related patents include devices aimed at holding a separate computer in an operating position on the operator's body. For example,

U.S. Pat. No. 5,639,004 shows a box with roll up cover meant to hold a computer. Straps suspend it from his shoulders/neck while the box is propped against his stomach. The rolled cover may be a cushion between the box and operator's body.
U.S. Pat. No. 6,659,319 shows a carrying case for computer with arms and props for chair mounting. It collapses into a compact case.
U.S. Pat. No. 6,381,127 shows a platform for a lap top computer. Included straps suspend the platform from each of the operator's shoulders.
U.S. Pat. No. 5,639,004 shows a box to hold computer. It includes a pivoting cover that becomes a platform for holding the computer while in operation. It may be suspended with straps from the operator.
U.S. Pat. No. 5,887,777 shows a wearable bag for holding and using a tablet computer.

Most of these computer holders include a container to protect the computer when stored. For around the house usage, where most notebook computing time is spent, the container is not needed and only adds weight and bulk. Most existing mobile computer holders use a waist strap or multiple shoulder straps to attach the holder to the operator. This is a time consuming component that makes set up more difficult. Most existing mobile computer holders are meant to hold the computer in front of the operator not to prop the display panel away from the operator's body.

To design away the shortcomings of existing computer holders, a minimized, lightweight, wearable holder is envisioned that positions the display for comfortable viewing for extended periods without using the hands. This holder may be in different versions to accommodate either hand held computer, tablet computers or notebook computers. Other considerations include compactness for storage or travel, quick setup, easy mounting to and dismounting from the operator's body.

For this inventor, the origin of this idea is the bag computer. For example, U.S. Pat. No. 7,978,464 (FIGS. 2 and 3) shows an operator with a bag used as a prop pressed against his body (lap or stomach) while the strap stabilizes it in an operating position with the display in the view of the operator. Adapting this arrangement, the prop (bag) may be of a different form and include an interface to stabilize the prop on the operator's body (for example, to stop tipping or sliding while standing). The prop may be, for example, a panel, a bar, a tube or a computer body panel that pushes the display away from the operator's body and into an operating position for better viewing as the display is suspended by a strap.

### BRIEF DESCRIPTION OF THE INVENTION

### Sheet 1—

The wearable propping display holder apparatus is configured to hold a display to an operator by using a strap (suspension device) extending from the operator's neck and a prop (operator body prop) to push the display into the operator's view. The prop includes an operator body interface to stabilize the prop and display on the operator's body. On sheet 1, the holder is shown with a display panel clasp to hold the display panel, suspension device attachments to secure the suspension device to the apparatus, an operator body prop to push the display panel away from the operator's body and an operator body interface including tipping stability and sliding stability features to stabilize the apparatus on the operator's body. Also show is a operator body prop length adjusters, a part of the operator body interface, to adjust the length of the operator body prop to fit various operator viewing situations.

### Sheet 2—

Other ways to adjust the operator body prop length may include a length adjuster with a sliding leg or a sliding panel or an operator body prop length expander, a part of the operator body prop, which may be located anywhere on the operator body prop. The display panel clasp may be hingedly attached to the operator body prop.

### Sheet 3—

The operator body interface stabilizes the apparatus while in an operating position. It may include a friction enhancing feature to resists slipping in all directions on the operator's body. A lateral stability member resists lateral tipping. The operator body interface allows tipping in the toward/away direction from the operator's face so that the suspension device can be used to adjust the distance of the display from the operator's face.

### Sheet 4-Sheet 5

A wide variety of features may be included on the operator body interface to provide tipping and sliding stability. Sliding stability features may include friction enhancing features such as elastomeric bumps, points, sticking materials or patterns, to mention a few. Sliding stability features may include attachments to attach to an incidental or intentional object on the operator. For tipping stability the operator body interface may include laterally separated surfaces provided by legs or shaping.

### Sheet 6-Sheet 7

One embodiment of the wearable propping display holder apparatus may take the form of a bar-like or rod-like operator body prop with a display panel clasp at one end an operator body interface perpendicularly attached to the other end. The operator body prop may be in more than one detachable pieces and the operator body interface may be detachable.

### Sheet 8-Sheet 9

The disassembled part of the apparatus of sheets 6 and 7 may be provided with packaging attachments so the parts may be attached together for compact storage.

### Sheet 10-Sheet 11

Another embodiment of the wearable propping display holder apparatus may be a wearable easel-like frame for holding a tablet computer. The display panel clasp includes a top and bottom jaw to hold the display panel to the operator body prop and operator body interface. The jaw arrangement may vary. Suspension device attachments are included.

### Sheet 12-Sheet 13

Another embodiment of the wearable propping display holder apparatus is a wearable easel-like frame for holding a two panel folding notebook computer. One or more operator body props connect the operator body interface with a display panel clasp which takes the form of a horizontal bar. The operator body interface includes a computer body panel bottom end holder and the clasp bar includes attachments for the suspension device and a clasp release which holds the computer body panel top end to the clasp bar. The clasp release may be an elastomeric band.

### Sheet 14-Sheet 15—

The suspension device and the clasp release may attach to the display panel clasp bar in a variety of ways in combination or separately.

### Sheet 16-Sheet 17

Operator body prop length adjusters may be included and may be attached to the operator body interface or to the operator body prop in various ways. The operator body prop length adjuster may include a second separate operator body interface. The operator body prop length adjuster may include an operator body interface which may be used when the adjuster is retracted or extended.

### Sheet 18—

In another embodiment of the wearable propping display holder apparatus the computer body panel of a notebook computer is used to substitute for the operator body prop of the apparatus. One component included the display panel clasp and the suspension device (or suspension device attachment). A second component includes the operator body interface.

### Sheet 19—

The operator body interface components may include a computer bottom end holder and this holder may include mounting features, such as clamping or wedging mechanisms, to keep the computer body panel bottom end in the holder. The operator body interface may include one or more length adjusters.

### Sheet 20—

The display panel clasp and suspension device may be combined or separate. The display panel clasp may be a circular band surrounding the computer and may include a clasp release fastener or tightener. The display panel clasp may include fiction enhancing features or may include attachments to hold a suspension device to the clasp.

### Sheet 21-Sheet 22-Sheet 23

The display panel clasp may include jaws and a way to tighten the jaws to the right and left edges of the computer. The display panel clasp jaws may include friction enhancing features, gripping features or attachment features to hold the jaws to the computer. The jaws may include a variety of fairleads, gripping fairleads or attachments to facilitate the attachment of the jaws to the computer and to the suspension device.

### Sheet 24—

The operator body interface may include mounting features and these may include attachments to match attachments on the computer body panel. The interface may include attachments for carrier straps attaching the interface to the display panel clasp and/or suspension device.

### Sheet 25—

To facilitate carrying the apparatus and computer in a storage position, for example, from the operator's shoulder, carrier straps may be included and configured to attach the operator body interface to the display panel clasp and/or suspension device.

### Sheet 26—

The carrier straps may take the form of a sling to hold the operator body interface and computer body panel bottom end to the display panel clasp and/or suspension device.

### Sheet 27—

A series of figures shows how the display panel clasp of the circular band type may be slid down to shut the computer display panel to the body panel and then slid back up around both panels for carrying from the operator's shoulder. The figures also show how the carrier straps position the display panel clasp for secure carrying.

### Sheet 28—

The connection of the display panel clasp, suspension device and carrier strap may be simplified for light weight and easy construction. The carrier straps (and suspension device) may be attached to the back of the operator body interface and display panel clasp to make the apparatus more compact.

### Sheet 29—

A series of figures shows the operator wearing a notebook computer in the apparatus in an operating position and in a closed storage position hanging from the operator's shoulder.

### BRIEF DESCRIPTION OF THE SEVERAL VIEWS OF THE DRAWINGS

FIG. 1 This figure shows a display panel clasp (and display panel) attached to an operator body prop that includes an operator body interface.

FIG. 2 This is the holder apparatus of FIG. 1 but also including a pivoting length adjuster.

FIG. 3 This is the holder apparatus of FIG. 1 but also including a sliding length adjuster (two rods).

FIG. 4 This is the holder apparatus of FIG. 1 but also including a sliding length adjuster comprised of a sliding panel.

FIG. 5 This is a holder similar to FIG. 1 but including an operator body prop length expansion mechanism to adjust the length of the prop.

FIG. 6A This is the holder apparatus of FIG. 1 but also including a sliding length adjuster with one bar-like prop with operator body interface including a lateral stability member with two laterally separated surfaces. An area has been circled for magnification.

FIG. 6B This is a magnification of the apparatus of FIG. 6A showing the pivoting connection between the display panel clasp and the operator body prop.

FIG. 7 This figure is a front view of the operator with apparatus showing the stability characteristics of the wearable display panel holder and the related components.

FIG. 8 This figure is a side view of the operator with apparatus showing the stability characteristics of the wearable display panel holder and the related components.

FIG. 9A This is the wearable display panel holder of FIG. 1 with a circle showing the magnification area for the operator body interface drawings 9B through 9F.

FIG. 9B This is a magnification of the circled area of FIG. 9A showing the operator body interface may include tipping stability and sliding stability components. (example #1).

FIG. 9C This is a magnification of the circled area of FIG. 9A showing the operator body interface may include tipping stability and sliding stability components. (example #2).

FIG. 9D This is a magnification of the circled area of FIG. 9A showing the operator body interface may include tipping stability and sliding stability components. (example #3).

FIG. 9E This is a magnification of the circled area of FIG. 9A showing the operator body interface may include tipping stability and sliding stability components. (example #4).

FIG. 9F This is a magnification of the circled area of FIG. 9A showing the operator body interface may include tipping stability and sliding stability components. (example #5).

FIG. 10A This is the wearable display panel holder of FIG. 1 with a circle showing the magnification area for the operator body interface drawings 10B through 10F.

FIG. 10B This is a magnification of the circled area of FIG. 10A showing the operator body interface may include tipping stability and sliding stability components. (example #1).

FIG. 10C This is a magnification of the circled area of FIG. 10A showing the operator body interface may include tipping stability and sliding stability components. (example #2).

FIG. 10D This is a magnification of the circled area of FIG. 10A showing the operator body interface may include tipping stability and sliding stability components. (example #3).

FIG. 10E This is a magnification of the circled area of FIG. 10A showing the operator body interface may include tipping stability and sliding stability components. (example #4).

FIG. 10F This is a magnification of the circled area of FIG. 10A showing the operator body interface may include tipping stability and sliding stability components. (example #5).

FIG. 11A This is a one third scale figure of FIG. 11B and constructed of one or two pieces (operator body interface and operator body prop).

FIG. 11B This is a display panel holder including an operator body interface and an operator body prop including a clasp for a display panel (shown). The holder apparatus may be in three or more pieces attachable to each other.

FIG. 12A This the apparatus of FIG. 11B assembled and including the suspension device.

FIG. 12B This is a side view (profile) of the operator wearing the apparatus and showing some of its stability characteristics.

FIG. 13 This is the second section of the operator body prop. It includes the display panel clasp.

FIG. 14A This is the front side of the operator body interface. Operating position and packaging position attachments are shown.

FIG. 14B This is the back side of the operator body interface.

FIG. 15 This is the first section of the operator body prop including a attachments for the operator body interface and operator body prop second section.

FIG. 16A This is the operator body prop second section in a packaging position attached to the front side of the operator body interface.

FIG. 16B This is the operator body prop first section in a packaging position attached to back side of the operator body interface.

FIG. 17A This shows the back side of the operator body prop second section including the display panel clasp. A first type of clasp release is shown.

FIG. 17B This shows the back side of the operator body prop second section including the display panel clasp. A second type of clasp release is shown.

FIG. 18 This is a side view (profile) of the operator body prop second section and display panel clasp shown in FIG. 17B. Vertical and horizontal display mounting channels are shown.

FIG. 19 This shows the front side of the operator body prop second section and display panel clasp with the display panel mounted in the clasp in a vertically oriented display mounting position.

FIG. 20A This is a side view (profile with the front side to the right and back side to the left) of the operator body prop first section. An accessory holder (eyeglass holder) is shown on its front side in a closed position.

FIG. 20B This is a side view (profile with the front side to the right and back side to the left) of the operator body prop first section. An accessory holder (eyeglass holder) is shown on its front side in an open position.

FIG. 21 This figure shows a tablet computer holder adapted for wearable use. There is a single operator body prop.

FIG. 22 This is a cross section view (at c/d of FIG. 21) of the apparatus of FIG. 21. Note the clamping movement of the top jaw.

FIG. 23 This wearable holder for tablet computer has two operator body props and two jaws for holding the tablet.

FIG. 24 This is a cross section view (at a/b of FIG. 23) of the apparatus of FIG. 23. Note the clamping movement of the bottom jaw.

FIG. 25 This figure shows a tablet computer holder adapted for wearable use. There is a single operator body prop.

FIG. 26A This shows the disassembled parts of the operator body prop and display panel clasp (jaws) of the apparatus of FIG. 25.

FIG. 26B This is a cross section view (at c/d in FIG. 25) of the apparatus components shown in FIG. 26A. The scale in this figure is slightly larger than FIG. 26A.

FIG. 27 This is the tablet computer holder of FIG. 25 holding a tablet computer.

FIG. 28A This is a view from the front of the notebook computer holder with the parts disassembled.

FIG. 28B This is a view from the left side of the apparatus of FIG. 28A showing the attachment for the computer and the operator body prop separating them.

FIG. 28C This is a view from the top of the clasp bar part of apparatus of FIG. 28A.

FIG. 29A This shows the holder as a wearable frame or easel with a notebook computer to be held in it.

FIG. 29B This shows the holder of FIG. 29A with the notebook computer in the holder.

FIG. 29C This shows the holder of FIG. 29B, ready for wearing and including the display panel clasp and suspension device.

FIG. 30 This is the holder for a notebook computer with an operator body prop comprised of a panel. The operator body interface includes legs and a contact band.

FIG. 31 This is the holder for a notebook computer with one pipe-like or rod-like operator body prop and the operator body interface divided into a bottom end holder part and a body contact part separated by a retractable/extendable length adjuster (a part of the operator body interface).

FIG. 32A This is a front view of the display panel clasp as a clasp bar configured as a right to left rod or tube attachable to the operator body prop.

FIG. 32B This is a left side view of the clasp bar of FIG. 32A.

FIG. 33A This is a top view showing the attachment of the clasp bar to the computer using the clasp release and the attachment of the clasp bar to the operator using the suspension device.

FIG. 33B This figure shows the suspension device attached to the clasp bar so that it serves as both a suspension device and as a clasp release.

FIG. 33C This shows the clasp bar with multipurpose attachments that may be used for either or both the suspension device and/or clasp release.

FIG. 33D This shows the suspension device attached separately to the clasp bar. The clasp release uses attachments adapted to hold the computer body panel and found on the clasp bar.

FIG. 33E This shows the clasp bar including right and left clasp bar “horns” (round cross section) for attaching, looping or coiling suspension device length or clasp release length to the bar.

FIG. 33F This shows a clasp bar horn end line retainer knob for fixing and retaining the suspension device or clasp release to the clasp bar horn.

FIG. 34A This is the frame-like or easel-like notebook computer holder and with a length adjuster disassembled. (suspension device and clasp release not shown).

FIG. 34B This is a left side view of the notebook computer holder of FIG. 34A.

FIG. 34C This is a slightly enlarged partial cross section (at NB of FIG. 34A) view of the holder of FIG. 34B showing details of the area near the operator body prop.

FIG. 34D This is a type of second operator body interface to fit the contact ends of the length adjuster.

FIG. 34E This is a type of second operator body interface to fit the contact ends of the length adjuster.

FIG. 34F This is a type of second operator body interface to fit the contact ends of the length adjuster.

FIG. 35A This is a side view of the holder's operator body prop with display panel clasp and operator body interface. In this arrangement, a length adjuster slidably stores inside the operator body prop.

FIG. 35B This is a cross section view (at A/B or FIG. 34A) of FIG. 35A.

FIG. 36A This is a side view of the holder's operator body prop with display panel clasp and operator body interface. In this arrangement, a combined body prop length adjuster slidably attaches to the clasp and interface for fitting the apparatus to the computer.

FIG. 36B This is a cross section view (at A/B or FIG. 34A) of FIG. 36A.

FIG. 37A This figure shows a “notebook” computer with an embodiment of the invention including two components; 1) a combination display panel clasp and suspension device component and 2) an operator body interface component.

FIG. 37B This shows the computer and apparatus components of FIG. 37B assembled and ready for wearable use.

FIG. 38A This figure shows a notebook computer mounted to the combination display panel clasp and suspension device component and an operator body interface component.

FIG. 38B This is a left side view of the operator body interface component showing detail of mounting features.

FIG. 38C This is a second left side view of the operator body interface component showing detail of mounting features.

FIG. 38D This is a third left side view of the operator body interface component showing detail of mounting features.

FIG. 38E This is a view of the front of the operator body interface including a two leg interface part.

FIG. 38F This is an alternative interface part suitable for the operator body interface of FIG. 38E.

FIG. 38G This is a second alternative interface part suitable for the operator body interface of FIG. 38E.

FIG. 39A This is a semi-schematic view of the combination display panel clasp and suspension device component with a loop as the display panel clasp.

FIG. 39B This is the display panel clasp of FIG. 39A with alternative detail parts.

FIG. 39C This is the display panel clasp of FIG. 39A with alternative detail parts.

FIG. 39D This shows that the display panel clasp part of the combination display panel clasp and suspension device component may include rigid jaws to fit the right and left side edges of the computer. A tightener holds the jaws to the computer.

FIG. 39E This shows that the display panel clasp component may include suspension device attachments suited to hold a removable suspension device.

FIG. 39F This shows that the display panel clasp may include a retractor mechanism, such as ratcheting equipment, to pull the jaws together on the computer.

FIG. 40A This is a semi schematic view from the top of an operator wearing a suspension device with a display panel clasp that includes jaws to hold the computer body. The arrangement of the engagement of the jaws to the computer body is detailed. The suspension device pulls the jaws together. An area has been circled for magnification.

FIG. 40B This is a magnification of the circled area of FIG. 40A showing details of the jaw and its material.

FIG. 41 This is the same view of FIG. 40A with the suspension device (operator's head removed) showing a second arrangement of the details of engagement of the jaws to the computer body. The suspension device pulls the jaws to the right and left.

FIG. 42 This is the same view of FIG. 40A with the suspension device (operator's head removed) showing a third arrangement of the details of engagement of the jaws to the computer body. The jaws attach to the computer body individually on either side.

FIG. 43A This is a view from the top side of a display panel clasp jaw showing various possible features.

FIG. 43B This is a view of the jaw of FIG. 43A shown from the right side and showing various possible features.

FIG. 43C This is a view of the jaw of FIG. 43A shown from the back side and showing various possible features.

FIG. 44A This is a view from the top side of a display panel clasp jaw showing various possible features.

FIG. 44B This is a view of the jaw of FIG. 44A shown from the left side and showing various possible features.

FIG. 44C This is a view of the jaw of FIG. 44A shown from the back side and showing various possible features.

FIG. 45A This is a facsimile jaw including two types of fairleads usable on a display panel clasp jaw.

FIG. 45B This is a facsimile jaw including an adjustable suspension device attachment buckle usable on a display panel clasp jaw.

FIG. 45C This is a facsimile jaw including an adjustable suspension device attachment pinching device usable on a display panel clasp jaw.

FIG. 45D This is a facsimile jaw including an eyelet usable on a display panel clasp jaw.

FIG. 45E This is a facsimile jaw including an adjustable suspension device attachment buckle usable on a display panel clasp jaw.

FIG. 45F This is a facsimile jaw including a rotating cam configured to wedge and jam a line usable on a display panel clasp jaw.

FIG. 45G This is a facsimile jaw including a hook fairlead usable on a display panel clasp jaw.

FIG. 45H This is a facsimile jaw including an opening fairlead usable on a display panel clasp jaw.

FIG. 45I This is a facsimile jaw including an channel fairlead usable on a display panel clasp jaw.

FIG. 46A This is a view of the back side of the operator body interface. Attachment details are shown.

FIG. 46B This is a view of the operator body interface of FIG. 46A viewed from the right side at cross section a/b of FIG. 46A. An area has been circled for magnification.

FIG. 46C This is a magnification of the circles area of FIG. 46B. Details of friction jaws mounting feature attachment are shown.

FIG. 46D This is a view of the operator body interface of FIG. 46A viewed from the right side at cross section c/d of FIG. 46A. An area has been circled for magnification.

FIG. 46E This is a magnification of the circles area of FIG. 46D. Details of rotating cam mounting feature attachment are shown.

FIG. 46F This is a view of the operator body interface of FIG. 46A viewed from the right side at cross section c/d of FIG. 46A. An area has been circled for magnification.

FIG. 46G This is a magnification of the circles area of FIG. 46F. Details of pivoting arm wedging device mounting feature attachment are shown.

FIG. 47A This is the operator body interface including mounting feature attachments specifically meant to match attachments on the computer body (in this case pins to match sockets).

FIG. 47B This is a view of FIG. 47A from the left side.

FIG. 47C This is the bottom left section of a computer body panel (cut off to the top and left with jagged lines) showing the matching attachment to match the attachment on the operator body interface of FIG. 47A.

FIG. 48 This is a view of the disassembled parts of an operator body prop and combination display panel clasp and suspension device component attached together for carrying by carrier straps.

FIG. 49 This is the parts of FIG. 48 assembled.

FIG. 50 This is a view of the disassembled parts of an operator body prop and combination display panel clasp and suspension device component attached together for carrying by a carrier sling.

FIG. 51 This is the parts of FIG. 50 assembled.

FIG. 52 To demonstrate the mobile operation of the carrier strap arrangement, this figure shows the computer in an open operating position with the combination display panel clasp and suspension device component slid downward and the carrier straps collapsed.

FIG. 53 This figure shows the computer of FIG. 52 with the combination display panel clasp and suspension device component slid upward around both the display panel and computer body panel, now folded together in a closed storage position.

FIG. 54 In this figure the carrier straps are shorter to position the combination display panel clasp and suspension device component well downward from the computer body panel top end while in the closed storage position.

FIG. 55 This is the computer of FIG. 54 in an open operating position. The shorter carrier straps have been disconnected so the combination display panel clasp and suspension device component may be slid upward to near the computer body panel top end.

FIG. 56A This is a view of the operator body prop and combination display panel clasp and suspension device component meant for carrying by carrier straps. The two components are separated. Three areas have been circled for magnification.

FIG. 56B This is a magnification of the area of attachment between the carrier strap and the operator body interface carrier attachment on the operator body prop.

FIG. 56C This is a magnification of the area of attachment between the carrier strap, suspension device and the display panel clasp. A sewn attachment is shown.

FIG. 56D This is a magnification of the area of the display panel clasp's clasp release part (here shown as an elastomeric strip (bungee)).

FIG. 57 This is a view of the operator body prop and combination display panel clasp and suspension device component meant for carrying by carrier straps. The clasp and prop are separated. The carrier straps and the operator body interface carrier attachments, and display panel clasp carrier attachments have been moved to the back of the operator body interface and display panel clasp to increase compactness.

FIG. 58 This is a front view (operator facing the application reader) of the operator wearing a notebook computer including the removable operator body prop and combination display panel clasp and suspension device component

FIG. 59 This is a side view (profile) of the upper body of the operator, computer and apparatus shown in FIG. 58.

FIG. 60 This is a full length body of the operator, computer and apparatus shown in FIG. 59. The computer and apparatus are shown in a closed storage position and hanging from the operators shoulder.

### DETAILED DESCRIPTION OF THE INVENTION

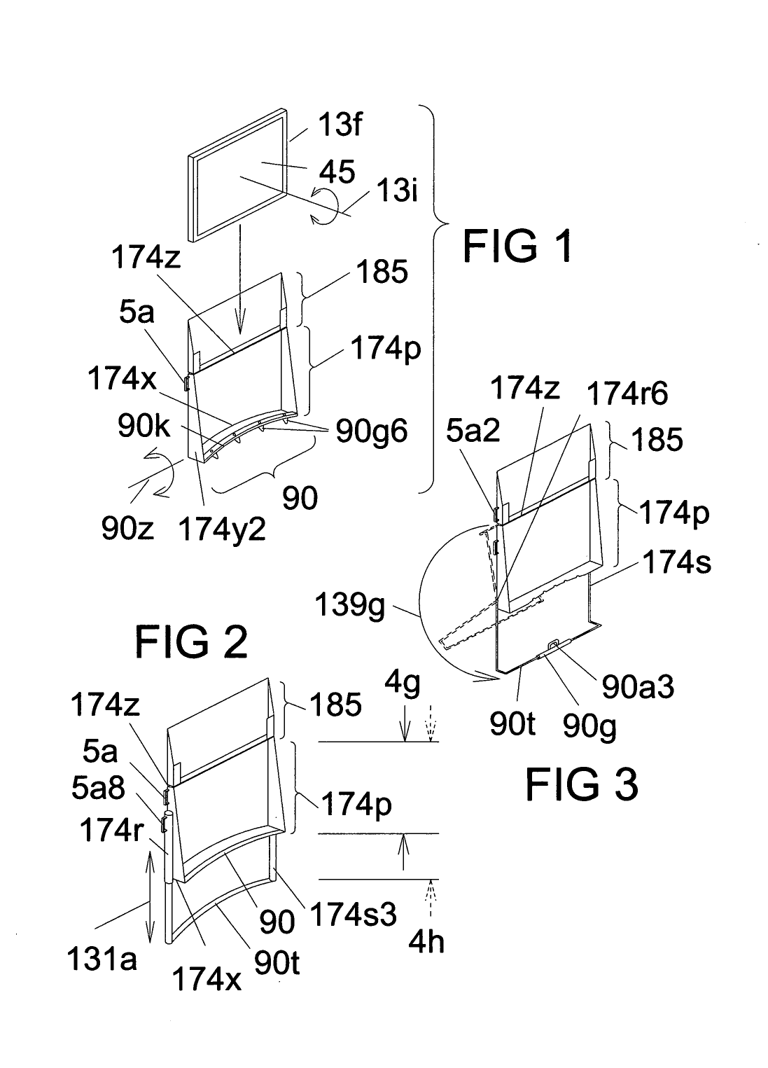

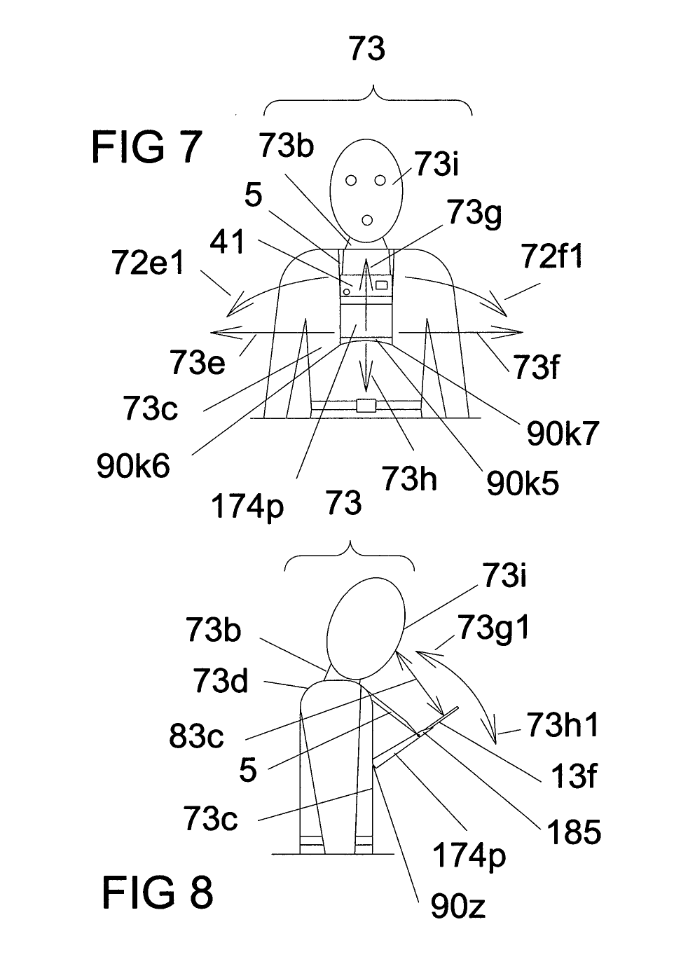

FIG. 1 shows a wearable propping display holder apparatus for attaching to and holding a display panel 13f, including an electronic display 45, to an operator's body in an operating position (see FIGS. 7 and 8). The display panel may include electronics such as a computing unit and telecommunication equipment and may be identical to computer equipment commonly known as a tablet computer or a smart phone. The apparatus includes a display panel clasp 185 designed to hold the display panel to an operator body prop 174p while leave exposed a large portion of the display.

In this figure, the operator body prop is panel-like but may alternatively be (but not limited to) bar-like or be comprised of one or more leg-like parts. The operator body prop may include a right side and left side (left side 174y2 shown). The display panel clasp attaches to the operator body prop and is positioned to hold the display panel near the top end 174z of the operator body prop. Attached to the operator body prop and positioned near its bottom end 174x is an operator body interface 90. The operator body interface may include features such as (but not limited to) shaping 90k to compliment the operator's body and provide tipping stability on the operator's body and/or friction enhancing features (for example, gripping protections 90g6) designed to enhance the friction between the interface and the operator's front body stomach/chest surface area so the operator body interface will temporarily adhere to the operator (with or without attachments) while the suspension device and suspension device attachment 5a suspend the apparatus and display panel from the operator's neck and/or shoulder area and the wearer can view the display. (see FIG. 7 and FIG. 8). For the purpose of adhesion to the operator and comfort for the operator, the operator body interface may be made of rigid material or elastomeric material or a combination of these materials.

The apparatus may include a lateral pivot axis 90z extending in a right/left direction across the operator body interface and comprised of, for example (but not limited to), an operator body interface relatively thin (see FIG. 6A, 174x2, arrows show thin profile) in a front to back (profile) direction relative to its width (see FIG. 6A, 174x1) to allow pivoting adjustment of the display in a direction toward or away from the operator's face (see also FIG. 6A and FIG. 8). Also shown is the axis 13i perpendicular to the display (and display panel) plane. For the benefit of adjusting distance between the operator and the display, the operator body interface may be thin along the axis perpendicular to the display (see FIG. 6A) and the operator body interface's lateral stability member may be perpendicular to both the axis perpendicular to the display and the prop vertical elongation axis.

FIG. 2 shows a wearable propping display holder apparatus for a display panel 13f, including a display 45. As in FIG. 1, the apparatus is comprised of a display panel clasp 185 and an operator body prop 174p and one or more suspension device attachments 5a to attach the operator body prop to a suspension device used to suspend the apparatus from the operator's neck area and/or shoulder area (see FIGS. 7 and 8). Suspension device attachments may be located on the operator body prop right side and/or left side. If the desired attachment location is blocked by a length adjuster holder, the suspension device attachment 5a8 may be attached to the length adjuster holder instead. The display panel clasp is attached to the operator body prop and is positioned to hold the display panel near the top end 174z of the operator body prop. The operator body prop also has a bottom end 174x. The operator body interface 90 (shown as a shaped blade) may be supplemented by an operator body prop length adjuster 174s3 (shown as one or more adjustment rods) to adjust the length of the operator body prop and better position the apparatus and display for operator viewing. The operator body prop length adjuster may be attached to the operator body prop using one or more operator body prop length adjuster holders 174r, a part of the operator body prop. In this figure, the one or more operator body prop length adjusters are adjustment rods (for example (but not limited to) a rod, a bar, a leg, a pole, a rod-like or bar-like tube or pipe or other columnar structure capable of extending the length of the operator body prop) and may include one or more additional interface features such as a contact band 90t. The operator body prop length adjuster may slide into and out of one or more (but not limited to) tube-like or rail-like operator body prop length adjuster holders with an up/down motion 131a to retract or extend the operator body prop length adjuster. Other operator body prop length adjuster and/or operator body prop length adjuster holder arrangements may be conceived. The operator body prop length adjuster is a type of or feature of the operator body interface with the purpose of adjusting/extending the length 4g of the operator body prop to/from an extended length 4h (indicated by dashed line arrow) to better position the display in the view of the operator. The operator body prop length adjuster is a part of the operator body interface and may include or supplement the interface's stability components for friction enhancement or lateral stability. The operator body prop length adjuster holder is a part of the operator body prop.

The operator body prop length adjuster (for example two operator body prop length adjuster 174s3 adjustment rods) may form an operator body interface with width 174x1 (see FIG. 6A), laterally from one (length adjuster) adjustment rod to the other adjustment rod, which forms a lateral stability member, laterally separated surfaces and provides lateral tipping stability to resist tipping to the right and to the left.

FIG. 3 shows the wearable propping display holder apparatus of FIG. 1 with an operator body prop that including an operator body prop length adjuster 174s that pivots into the extended position. To show the pivoting extension movement 139g of the operator body prop length adjuster this figure shows three images of it; near retracted position (dashed lines); moving into extended position (dashed lines) and; in extended position (solid lines).

This operator body prop length adjuster 174s is comprised of two adjustment rods or legs, which may be attached with a contact band 90t, and are of a length suited to best position the display panel, held in the display panel clasp 185, into the operator's view. The operator body prop's length adjuster holder is a pivoting holder 174r6 such as a bearing, axel, flexible fabric or other pivoting way to attach the operator body prop length adjuster to the prop. This operator body prop length adjuster may be made of heavy wire or plastic. The contact band, if present, may include its own operator body interface such as a friction enhancing feature 90g, lateral stability member or operator linking attachment 90a3. FIG. 3 shows that, as an alternative, a suspension device/clasp attachment 5a2 may be attached to the display panel clasp for the purpose of attaching the suspension device to the display panel clasp.

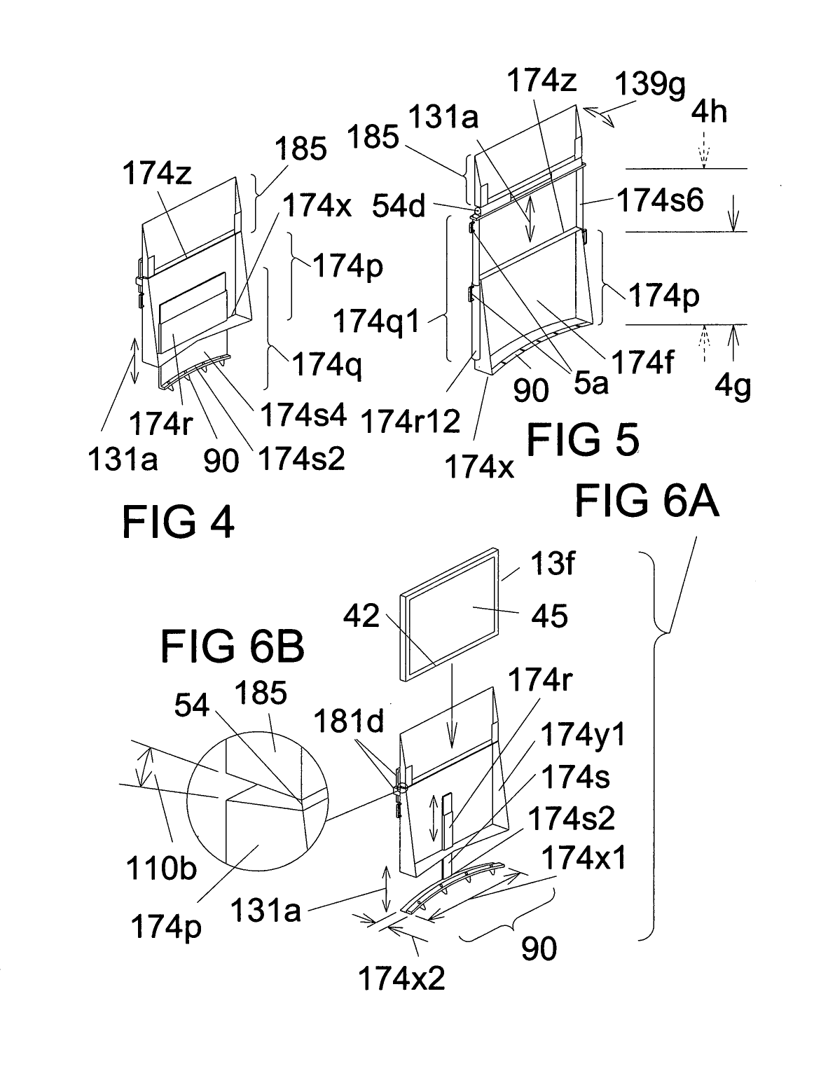

FIG. 4 shows the wearable propping display holder apparatus of FIG. 1 with an operator body interface including an operator body prop length adjuster 174s4 (adjustment panel) that is a panel that slides with an up/down motion 131a from a retracted position parallel to the operator body prop and held to the operator body prop by the operator body prop's length adjuster holder 174r to an extended position lengthening the operator body prop 174p beyond its bottom end 174x. As with FIG. 1, the display panel clasp 185 attaches to the operator body prop and is positioned near the top end 174z of the operator body prop. The operator body prop length adjuster contact end 174s2 may include additional operator body interface 90 features such as (but not limited to) a lateral stability member and/or one or more friction enhancing features.

FIG. 5 shows the wearable propping display holder apparatus of FIG. 1 but in this case the operator body prop includes an operator body prop length expansion mechanism 174q1. The operator body prop length expansion mechanism may include an operator body prop length expander 174s6 which may be held to the operator body prop by an operator body prop length expander holder 174r12. The operator body prop length expansion mechanism is a part of the operator body prop and may be located anywhere on or in the operator body prop, shown in this figure extending between the display panel clasp 185 and the top end 174z of the remainder of the operator body prop 174p. The purpose of the length expansion mechanism is to expand (increase) or adjust the operator body prop length between a mechanism retracted length 4g (indicated by solid line arrows) and a mechanism extended length 4h (indicated by dashed line arrows) to adjust the operating position of the apparatus and display for better viewing by the operator.

The length expander 174s6 may retract and store in a length expander holder 174r12, in this case using (but not limited to) an up/down sliding motion 131a for expansion. The bottom end 174x of the operator body prop may be adapted for sliding stability or tipping stability on the operator's body using an operator body interface 90 (shown as a shaped elastomeric blade with serrations). Also shown is the operator body prop front side 174f.

This kind of arrangement (the operator body prop including a length expansion mechanism) may alternatively be used with an embodiment including a display panel attached directly to the operator body prop (i.e. no display panel clasp). The attachment of the display panel to the operator body prop may be, for example, from the display panel proximal (attachment) edge (42, FIG. 6A) to the operator body prop top end and/or operator body prop expansion mechanism.

The display panel clasp is shown pivotally attached to the operator body prop length expansion mechanism 174q1 using a hinge 54d with an axis of motion 139g parallel to the operator body prop top end. This hinge, which may be located anywhere on the length expansion mechanism, may allow the adjustment of display viewing angle for the operator.

This figure shows that the suspension device attachment 5a may be attached to the operator body prop length expander holder 174r12 and/or to the operator body prop length expander 174s6. If the best position for the suspension device attachment on the operator body prop is blocked by, for example, an operator body prop length expander holder or an operator body prop length adjuster holder (see FIG. 2) attached to the operator body prop in that position, the suspension device attachment may be attached to one or more of those holders instead.

The operator body prop length expander holder and/or an operator body prop length adjuster holder may be part of, molded into, incorporated into or built into the operator body prop and the holder may also be seen as part of the operator body prop, especially for the purpose of attaching the suspension device attachment.

FIG. 6A shows a wearable propping display holder apparatus of FIG. 1 but, in this case, the operator body interface includes an operator body prop length adjuster 174s which extends (increases) and adjusts the length of the operator body prop. In this figure, the operator body prop length adjuster is a single adjustment rod. The length adjuster is a part of the operator body interface. The operator body prop length adjuster may be held to the operator body prop with an operator body prop's length adjuster holder 174r, in this figure a box-like or guide-like structure, so that the operator body prop length adjuster may slide into it with an up/down motion 131a. In this figure the operator body interface 90 is attached to the operator body prop length adjuster contact end 174s2 and is configured to use enhanced friction and shaping to compliment the operator's body and provide sliding stability and lateral tipping stability to temporarily stick the apparatus to the operator without the use of attachments. The interface includes a lateral stability member with width 174x1 (the same as the lateral separation for lateral stability member right and left surfaces) to stabilize the apparatus against lateral tipping. Conversely, the interface is relatively thin 174x2 in a front/back direction to form a lateral pivot axis and to allow the operator to use the suspension device to adjust the display 45 in a direction toward or away from the operator's face (see FIG. 7 and FIG. 8). The operator body prop right side is indicated by 174y1. The display panel 13f, with display 45, is held to the apparatus by the display panel proximal (attachment) edge 42 using a display panel clasp.

FIG. 6B, a magnification of the circled part of FIG. 6A, shows that the top end of the operator body prop 174p and the display panel clasp 185 may be attached using a pivoting attachment 54, such as (but not limited to) a hinge or flexible fabric such as a thin section of flexible plastic. This pivoting attachment allows adjustment of the angle 110b of the display panel (held in the display panel clasp) relative to the operator body prop for both stable positioning of the apparatus and good viewing by the operator. This angle may be held in place with an angle holding lock 181d (FIG. 6A).

An apparatus of this sort may be made of inexpensive material such as expanded rigid polystyrene plastic (cells or foam), polypropylene or other plastic. Components for the operator body interface may be made of elastomeric material such as (but not limited to) rubber, plastic, synthetic rubber or silicone rubber to enhance shaping or friction between the apparatus and the operator but still supply comfort. The suspension device may be made of, for example, line, chain, lanyard, cord, strap or belt, most likely (but not limited to) of a plastic material.

FIG. 7 and FIG. 8 show the stability characteristics of the wearable propping display holder apparatus. In FIG. 7, the wearer's 73 (operator's) face 73i is facing forward (toward the application reader) with the wearable propping display holder apparatus supporting a display panel in an operating position with the suspension device 5 suspending the apparatus from his neck 73b. Visible is the display panel back side 41 (possibly including one or more manual controls) and the operator body prop 174p (back side visible). The operator is viewing the display on the front side of the display panel opposite the display panel back side. The operator body interface 90 is pushing against the operator's front stomach/chest area 73c. It can be seen that the operator body interface includes a width (see 174x1, FIG. 6A) in a lateral direction (right/left) from the operator's body center front in a direction toward the operator's left side 73f and toward the operator's right side 73e. This lateral direction width of the operator body interface forms a lateral stability member 90k5 and includes a right laterally separated surface 90k6 and a left laterally separated surface 90k7, each of these two surfaces being contactable with the operator's body. Hence, the operator body interface width provides lateral direction (right/left) tipping stability because of the lateral direction width of the lateral stability member where the two surfaces contact the operator's body. This lateral direction tipping stability may be in terms of resisting or preventing the operator body prop with display panel from tipping to the right 73e1 or tipping to the left 73f1. For this purpose, the lateral stability member may include or be tipping stability components such as (but not limited to) right and left interface legs, right and left (length adjuster) adjustment rods, right and left (length adjuster) adjustment panel, right and left operator body prop sides or shaping to compliment the operator's body (see also 90k, FIGS. 1, 9B, 28A and 47A).

Lateral direction stability may alternatively or additionally be provided by the operator body interface providing sliding stability in terms of the operator body prop bottom end resisting sliding on the operator's body to the right 73e or sliding to the left 73f. On the other hand, the operator body interface may provide sliding stability in an upward/downward direction in terms of the operator body prop bottom end resisting sliding on the operator's body upward 73g toward or sliding downward 73h away from the operator's face. As sliding stability components, one or more friction enhancing features or surfaces (see, for example, but not limited to, 90g, 90k3, 90g3, 90g4, 90g5, 90g6, 90g6a, 90g6b, 90g7, 90g8, 90g9, 90g10, 90g11, 90g12, 90g13) may be included on the operator body interface to provide this sliding stability that resists sliding of the operator body prop in all directions on the operator's body surface.

FIG. 8 shows the operator 73 of FIG. 7 turned 90 degrees to the side (profile view). The display panel 13f is held in the display panel clasp 185, is in front of the operator and is pushed away from the operator's front stomach/chest surface area 73c by the operator body prop 174p. At or near the contact place between the operator body interface and the operator's front stomach/chest surface area the operator body interface may include, create or be comprised of a lateral pivot axis 90z. This lateral pivot axis allows the operator body prop and display panel to pivot in a toward/away direction (73g1 and 73h1) on the operator's front stomach/chest surface area as regulated by the suspension device length and to adjust the distance between the display and the operators face. The suspension device 5 extends to or around the operator's neck 73b and/or shoulder 73d area to suspend the wearable propping display holder apparatus and to provide stability in a toward/away direction in terms of the display panel with operator body prop tipping toward 73g1 or tipping away 73h1 from the operator's face 73i. In this sense, the suspension device also provides a way to adjust the viewing distance 83c of the display (on the display panel front side) toward 73g1 or away 73h1 from the operator's face.

The wearable propping display holder apparatus along with the way it is used and its stability characteristics (FIGS. 7 to 8) represents a method of use for a display panel holder propped by an operator body prop against an operator's stomach/chest area and suspended by a suspension device from the operator's neck/shoulder area.

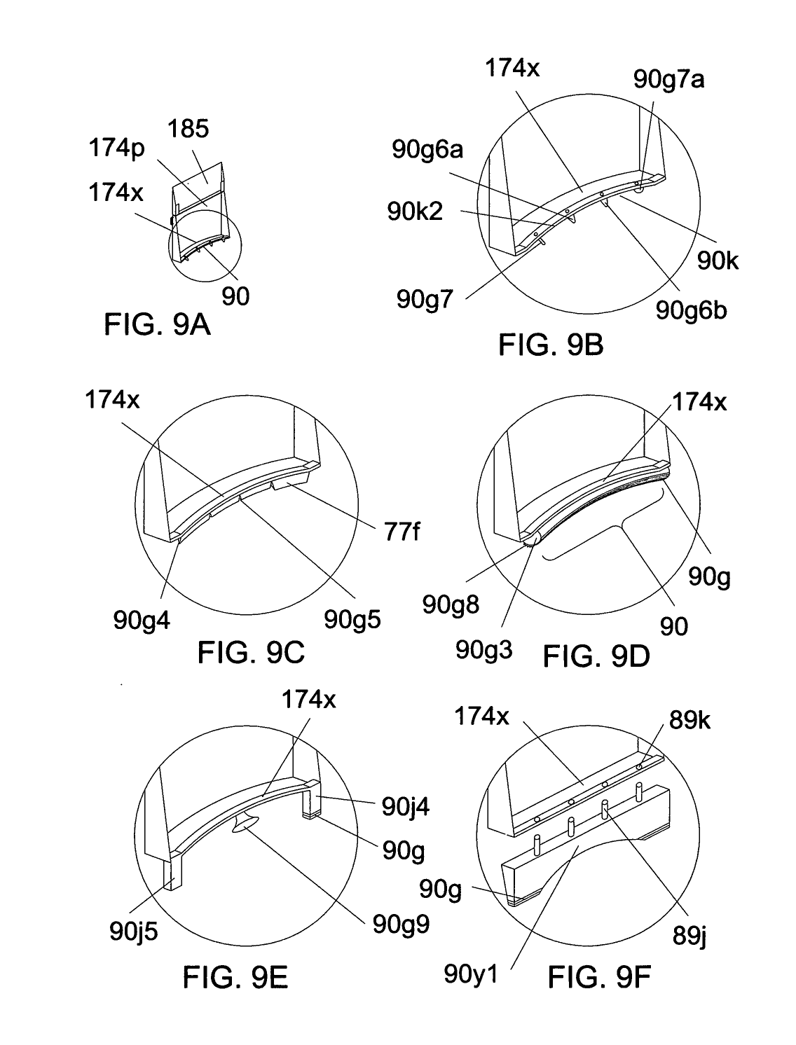

FIG. 9A is the wearable propping display holder apparatus of FIG. 1 with a circle indicating the portion to be shown in magnified views (FIG. 9B through FIG. 9F) of alternative operator body interfaces 90 attaches to the operator body prop 174p and is positioned near its bottom end 174x. The display panel clasp 185 is shown attached to the top end of the operator body prop. The features of the operator body interface attached near the operator body prop bottom end may be several features individually attached or may be a single monolithic features combining a variety of features. Some features may be combined in one drawing for compactness of presentation rather than their necessary functional association.

FIG. 9B shows the operator body prop bottom end 174x with gripping projections 90g7 such as points, fingers, knobs, bumps 90g7a or lugs attached to it to form an operator body interface designed to enhance its friction holding ability. The gripping projections (or any gripping feature or friction enhancing feature presented throughout this application) may be made of a flexible, rubber-like (elastomeric) material 90g6a or may be made of a rigid material 90g6b. The operator body interface may include shaping 90k to compliment the operator's body front to form a lateral stability member and assist with lateral stability and sliding stability on the operator's front stomach/chest area. This shaping may be concave 90k2 to provide right and left laterally separated surfaces.

FIG. 9C shows that the operator body prop bottom end 174x may include an operator body interface made of one or more ridges or blades 90g4 which may be rigid or elastomeric. The operator body interface may include a friction enhancing feature which may be an elastomeric material component 77f. The blade may include serrations 90g5.

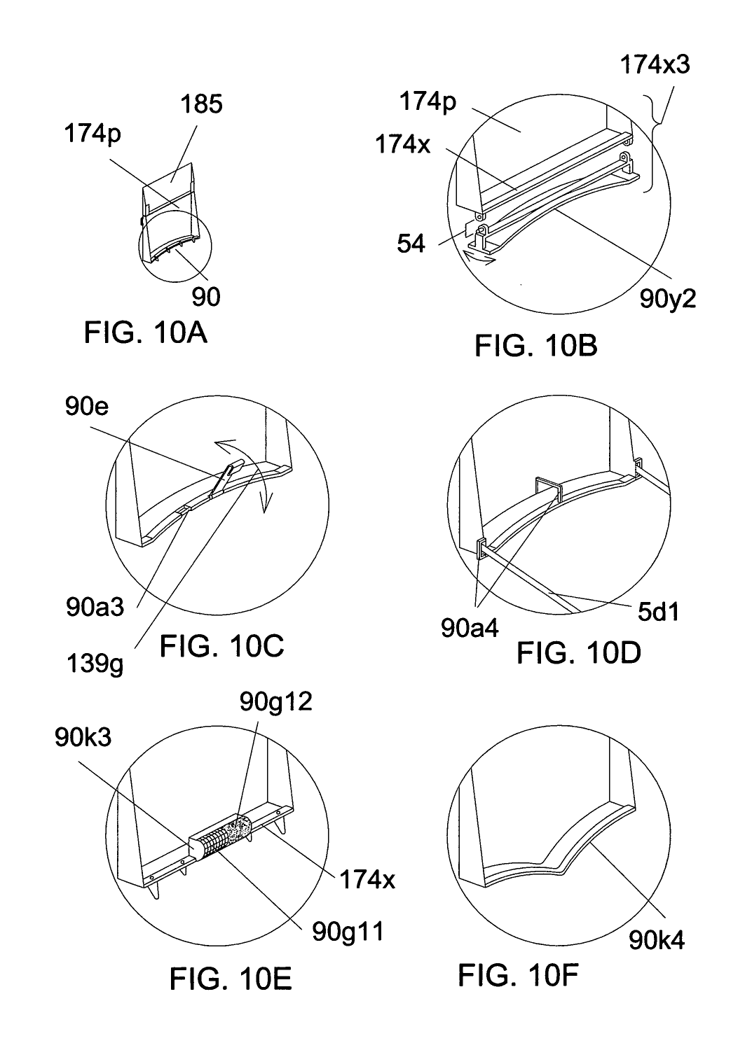

FIG. 9D shows that the operator body prop bottom end 174x may include an operator body interface 90 made of a cushion 90g3 which may include a gripping surface 90g, in this case multiple ridges or ribs 90g8. A gripping surface may include materials that stick (for example, some sticky elastomeric materials, sandpaper-like or abrasive coated materials (see 90g12, FIG. 10E)), gripping surface pattern (such as knurling, knobs, ridges, ribs, lugs, grid (see 90g11, FIG. 10E)), elastomeric material, elastomeric projections or rigid projections. Shaping, legs or rods may be especially good at resisting lateral (right left) sliding as well as providing lateral stability. Shaping may be in a concave way (see FIGS. 9B and 9E) to help fit the operator body interface to the operator's front body surface and facilitate the contact of the gripping surface to the operator. A cushion may serve to assist in shaping the operator body interface to the operator's body.

FIG. 9E shows that the operator body prop bottom end 174x may include an operator body interface made of one or more interface legs (for example, a right interface leg 90j4 and a left interface leg 90j5). One or more legs may also be considered an operator body prop by extending the distance between the display panel and the operator's body. In this case, the two legs (or rods) are an operator body interface and help shape the prop to the operator's body and make laterally separated surfaces to provide tipping stability for the apparatus while in an operating position on the operator. The ends of the interface legs may be shaped or includes features (90g) to resist sliding in any direction. The operator body interface may be or include one or more friction enhancing cups 90g9, for example, suction cups.

FIG. 9F shows that the operator body prop may include an operator body interface near its bottom end 174x that is a removable operator body interface 90y1 made to fit and attach to the operator body prop and/or any operator body interface that may be attached to it. The removable operator body interface may attach to the operator body prop as a covering or as an addition. The removable operator body interface may attach to the prop using, for example, one or more removable interface attachments 89j (shown as, but not limited to, pins) on the operator body interface matching removable interface prop attachments 89k (shown as, but not limited to, sockets) on the operator body prop. Other examples of this type of attachment might include matching snaps or latches, friction fitting, matching channels or tracks or other kinds of attachments found anywhere on the operator body prop and/or interface.

The removable operator body interface may be rigid or flexible, may be made of or include material, such as cloth or cushioning, to comfort the wearer (operator) especially when the apparatus is worn in a reclining position or near the neck area. The removable operator body interface may be shaped and/or include features (e.g. 90g) to assist in wearer's comfort or assist the stability of the apparatus in an operating position contacting the operator. Multiple interchangeable removable operator body interfaces may be provided with a variety of shapes or features so the operator may choose the interface that suites him best. The removable operator body interface may fit an operator body prop bottom end without any operator body interface and serve as a substitute for any permanently attached interface.

FIG. 10A is the wearable propping display holder apparatus of FIG. 1 with a circle indicating the portion to be shown in magnified views (FIG. 10B through FIG. 10F) of alternative operator body interfaces 90 attached to the operator body prop 174p and is positioned near its bottom end. The display panel clasp is shown attached to the top end of the operator body prop. The features of the operator body interface attached to the operator body prop near its bottom end may be several features individually attached or may be a single monolithic features combining a variety of features. Some features may be combined in one drawing for compactness of presentation rather than their necessary functional association.

FIG. 10B shows that the operator body interface of the apparatus may be a pivoting piece configured to attach to the operator body prop 174p, especially to its bottom end 174x. The operator body interface may be a pivoting interface 90y2 pivotally attached to the operator body prop by a pivoting attachment 54 (shown here separated 174x3 but attachable with the pivoting attachment) which may be (but not limited to) a matching bearing and axle (shown in this figure), clamped flexible fabric or other hinge-like device. The pivoting interface may include friction enhancing features or attachments as mentioned elsewhere and/or shaping to compliment the operator's body.

FIG. 10C shows that the operator body interface may be an operator linking attachment 90a3 (shown here as an opening with a bar) attached to the operator body prop. This operator linking attachment, such as a hook 90e, may be designed to attach to some incidental object, attachable site or intentional matching attachment on the operator or his clothes (e.g. pocket, opening between buttons, belt). The operator linking attachment may be attached to the operator body prop in a way to provide for a pivoting motion 139g for a more natural alignment between the operator and the apparatus.

FIG. 10D shows that the operator body interface may be one or more belt adapted operator linking attachments 90a4 attached to the operator body prop and configured to hold an attachment belt 5d1 or lanyard and lead it around the operator's waist. The operator linking attachment may lead to the right and left of the operator body prop near its bottom end. The operator linking attachment may be attached to the operator body prop right side edge, left side edge, bottom end, front side or back side.

FIG. 10E shows that the operator body interface may be shaped as a drum-shaped contact surface 90k3 with a laterally oriented (right/left) axis (i.e. parallel to the lateral pivot axis) to maintain a constant surface contact with the operator's body as the operator body prop may pivot on a lateral pivot axis in a direction toward or away from the operator's face. The operator body interface may include a gripping surface such a pattern 90g11 (shown as a gridding), knurling, or lattice or an abrasive surface 90g12 (e.g. sandpaper-like surface). As seen in this drawing, the operator body prop bottom end 174x may be shaped straight in a lateral direction (right/left).

FIG. 10F shows that the operator body interface may include specialty shaping 90k4, for example, bosom shaped to fit the female chest. Specialty shapes may be included in one or more removable operator body interfaces (see 90y1, FIG. 9F) made to alternatively fit the operator body prop and/or any operator body interface attached to it and adapt the prop to fit the operator.

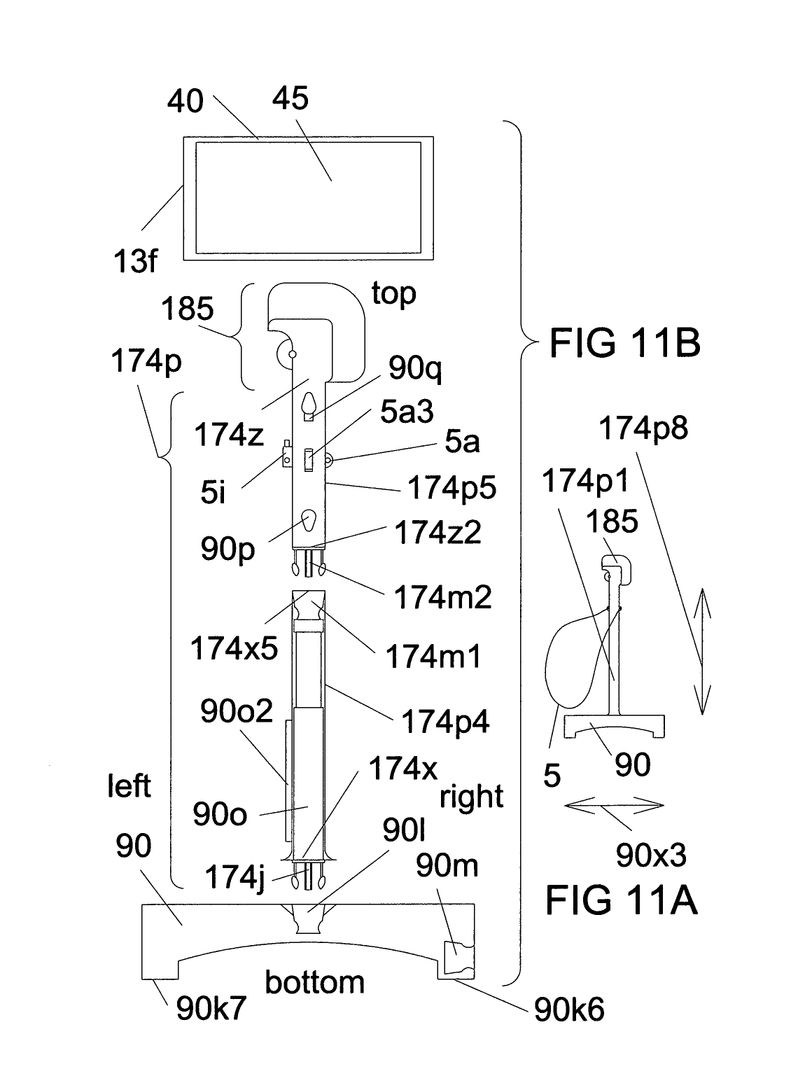

FIG. 11A (shown in one third the scale of FIG. 11B) is a simplified front view of the wearable propping display holder apparatus embodiment with a single elongated operator body prop 174p1 (bar-like or pipe-like) extending between the operator body interface 90 and the display panel clasp 185. A suspension device 5, a filament or line in this case, is included to suspend the apparatus from the operator's neck. This figure also shown that the operator body prop may be elongated along a prop vertical elongation axis 174p8 (arrow) and this axis may be approximately perpendicular to the operator body interface's interface horizontal elongation axis 90x3 (arrow) (when assembled and in an operating position).

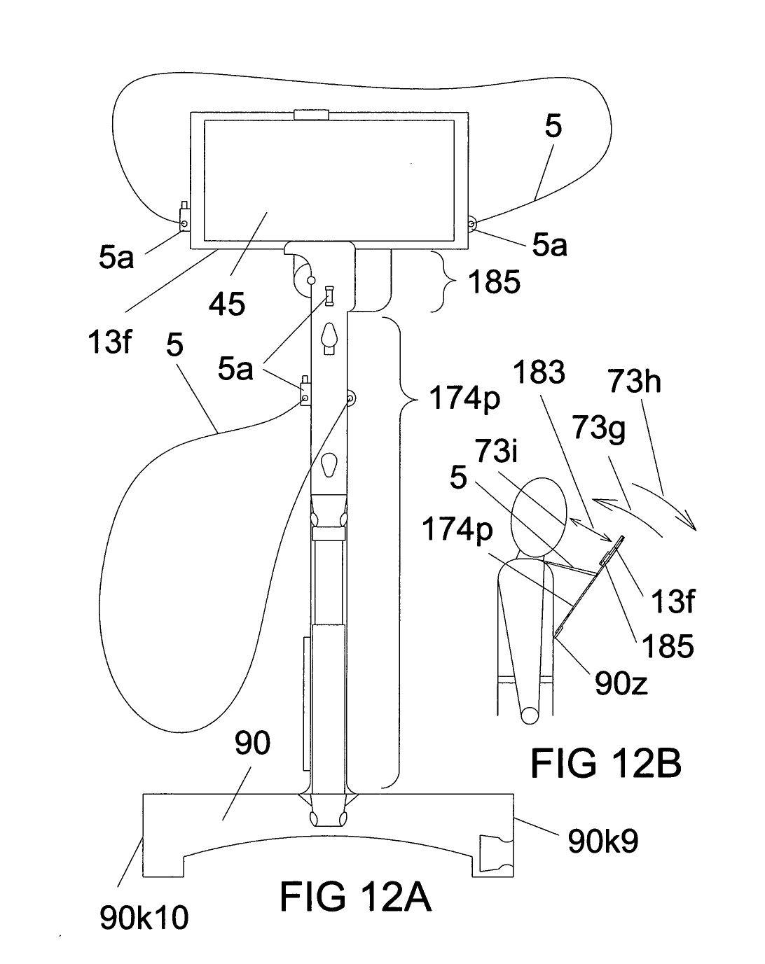

FIG. 11B shows the same wearable propping display holder apparatus of FIG. 11A but increased three time in scale. FIG. 11B is a disassembled view of the parts of this embodiment of the apparatus. There are four basic components: an operator body interface 90, an operator body prop 174p, a display panel clasp 185 and a suspension device and/or one or more suspension device attachment 5a (here show attached to the operator body prop second section—see also 5, FIGS. 12A, 12B and 15). With the exception of the suspension device and some attachment parts (e.g. some clasp parts), the components may be made of rigid material (e.g. rigid plastic or metal).

The operator body interface 90 extends in a lateral direction (to the right and to the left of the operator body prop) and may include a lateral stability member with a right laterally separated surface 90k6 and a left laterally separated surface 90k7 to provide tipping stability in the lateral (right to left) direction. The operator body interface may be elongated along an interface horizontal elongation axis (when assembled and in an operating position) and may be relatively thin in the front to back (profile) direction (see FIG. 6A, 12B and axis perpendicular to the display panel 13i, FIG. 1) and form a lateral stability member and form a lateral pivot axis (see FIGS. 1 and 12B). The operator body interface may be (but not limited to) bar-like, pipe-like or rod-like. The operator body interface may be shaped or have features for the purpose of comfortably and temporarily adhering the interface to the operator's front stomach/chest area when in an operating position. For example, the operator body interface may have shaping to compliment the operator's body, one or more friction enhancing features, legs, nonslip surface, one or more attachments, cushioning, covering, angled or pointed leg/rod ends, leg end grips or other features to provide for tipping stability and/or sliding stability and temporarily hold to the operator.

With the possible exception of package position or operating position attachments, the operator body interface may be flat on the front side and back side to facilitate the compact storage of a first section and/or a second section of the operator body prop against the interface.

The operator body prop 174p extends between the operator body interface and the display panel clasp 185 in order to push the display panel away from the operator's body into an operating position for comfortable viewing by the operator. The prop is elongated in the clasp to interface direction and/or prop vertical elongation axis (top/bottom direction in the figure and when in an operating position) and may be (but not limited to) bar-like, pipe-like or rod-like with the operator body prop bottom end 174x attached to the operator body interface 90 with the prop vertical elongation axis approximately perpendicular to the interface's horizontal elongation axis (creating, for example, a “T” junction).

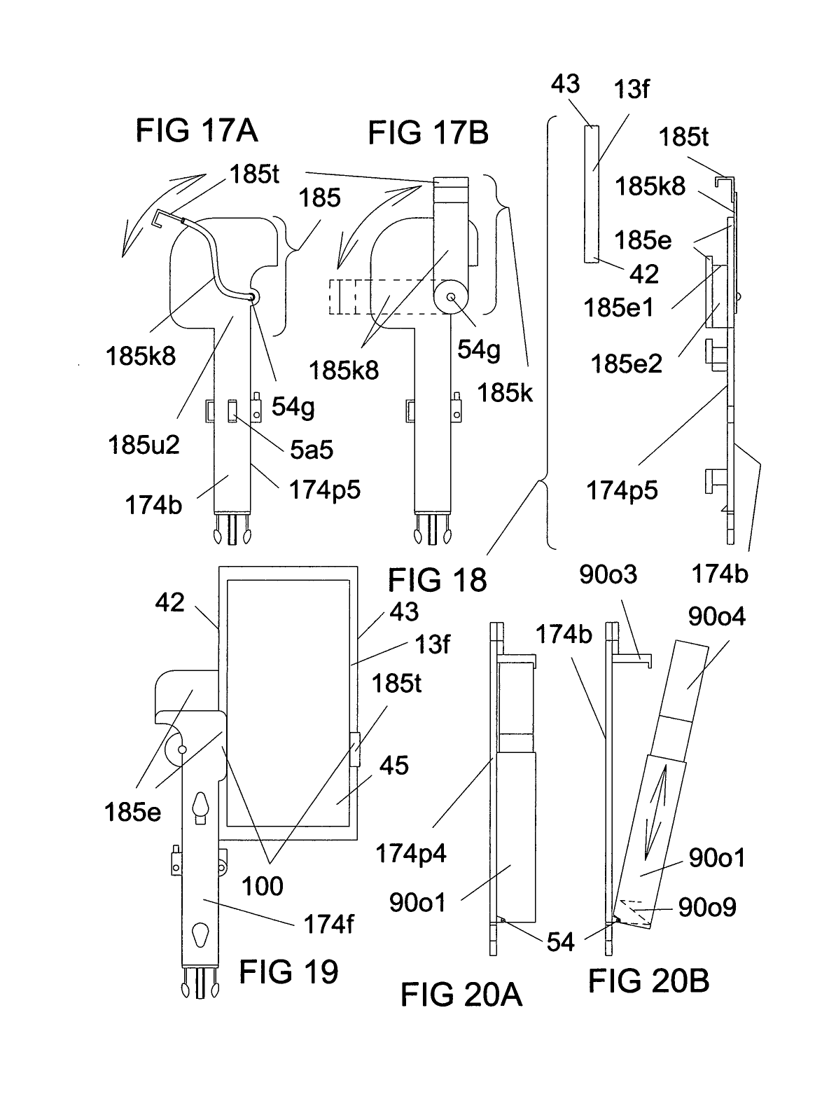

To provide stability (against tipping) in the direction toward (73g) and away (73h) (see FIG. 12B) from the operator's face, the apparatus includes a suspension device, such as a lanyard, line, filament, cord or strap (see 5, FIGS. 12A and 12B) attaching the apparatus to the operator's upper body (e.g. neck and/or shoulder area). The suspension device may be a single line leading around the operator's neck/shoulder area, the line having two ends with both ends attached to the operator body prop, display panel clasp or, in some cases, the display panel. Alternatively, the suspension device may be a loop encircling both the operator neck/shoulder area and the operator body prop, display panel clasp or, in some cases, the display panel. The apparatus may instead include one or more suspension device attachments 5a (or 5i) suitable for holding the suspension device and/or its ends to the apparatus. The suspension device attachment may be attached on the right side and/or left side of the operator body prop. Alternatively, the suspension device attachment 5a3 may be attached to the front side of the operator body prop or to the back side of the operator body prop (see FIG. 17A).

The display panel clasp 185 is attached to the top end 174z of the operator body prop (the end opposite/distal to the operator body interface). A display panel 13f, which includes a front side 40 with a display 45 and may include computer and telecommunications electronics, is held in the display panel clasp while the operator body interface temporarily adheres the apparatus to the operator's front stomach/chest surface area and the operator body prop pushes the display panel away from the operator. The suspension device suspends (or stays) the apparatus while the display is in the view of the operator.

For compact storage and portability, the operator body interface may be removable from the operator body prop. Further, the operator body prop may be divided into more than one piece for storage. For example, the operator body prop may be divided into a first section 174p4 and second section 174p5. For operation, the first section may use a first section to operator body interface attachment 174j (located at the operator body prop bottom end) to attach to a matching operator body interface prop attachment 90l (for operating position) on the operator body interface. For operation, the first section may also included a first section to second section attachment 174m1 (located near the first section top end 174x5) to attach to a matching second section prop attachment 174m2 (located near the second section bottom end 174z2). The operator body prop may attach to the suspension device using an adjustable suspension device attachment 5i, in this case an adjustable attachment, located on the operator body prop (first section or second section) and this adjustable attachment may be designed to attach at more than one place along the suspension device length thus making the suspension device adjustable in length. As shown in this figure, the display panel clasp is adapted to hold a display panel in either a horizontally oriented display mounting position or in a vertically oriented display mounting position. These two mounting positions are approximately perpendicular to each other and configured to hold a rectangular display panel with its long axis either horizontally (laterally, right/left direction) or vertically (top/bottom, upward/downward direction). The display panel clasp may be adapted to hold the display panel in two or more different mounting positions or be adapted to rotate (see FIGS. 17A and 17B) to two or more mounting positions around an axis (see 13i, FIG. 1) perpendicular to the display plane.

Additional features may be included on either the operator body prop first section or the second section or on the operator body interface. These features may include; an accessory holder 90o for eyeglasses or an eyeglass holder; a sound wire storage device 90p to, for example, coil earphone wire; a simulated earphone electrical socket 90q for the earphone end; a stylus container 90o2 for holding a stylus. The operator body interface may include one or more operator body interface package position attachments 90m to match attachments (e.g. j or 174m2) on the operator body prop first section and/or second section for the purpose of attaching those sections to the operator body interface in a package position.

FIG. 12A shows a view of the assembled parts of wearable propping display holder apparatus and in an operating position ready for use. The parts are the same as FIG. 11B including the operator body interface 90, operator body prop 174p, display panel clasp 185 and suspension device 5 (or its attachments 5a on the prop or display panel clasp). The display panel 13f, with electronic display 45, is shown ready for viewing in a horizontally oriented display mounting position in the display panel clasp. Shown in this figure is the suspension device 5, in this case, a flexible lanyard or cord. FIG. 12A also shows that in some situations the operator might, alternatively, want to retain the display panel to his neck when the prop is not being used. In this case the suspension device attachments 5a and suspension device 5 may be located on the display panel (not on the operator body prop) and still serve the same function in combination with the prop and suspend the display panel from the operator's neck while the prop pushes the display away from the operator's body and into his line of sight. Also shown is the operator body interface right side 90k9 and left side 90k10.

FIG. 12B shows a side (profile) view of the operator 73 wearing the wearable propping display holder apparatus in an operating position. The operator body interface is shown from the side as thin and forming a lateral pivot axis 90z allowing the operator body prop 174p to pivot against the operator's body (toward and away from his face) and extending away from his body while the display panel clasp 185 holds the display panel 13f (including, for example, a mobile phone or tablet computer) with its display in the operator's view 183 (line of sight). The suspension device 5 provides stability in the direction toward 73g the operator's face and away 73h from the operators face.

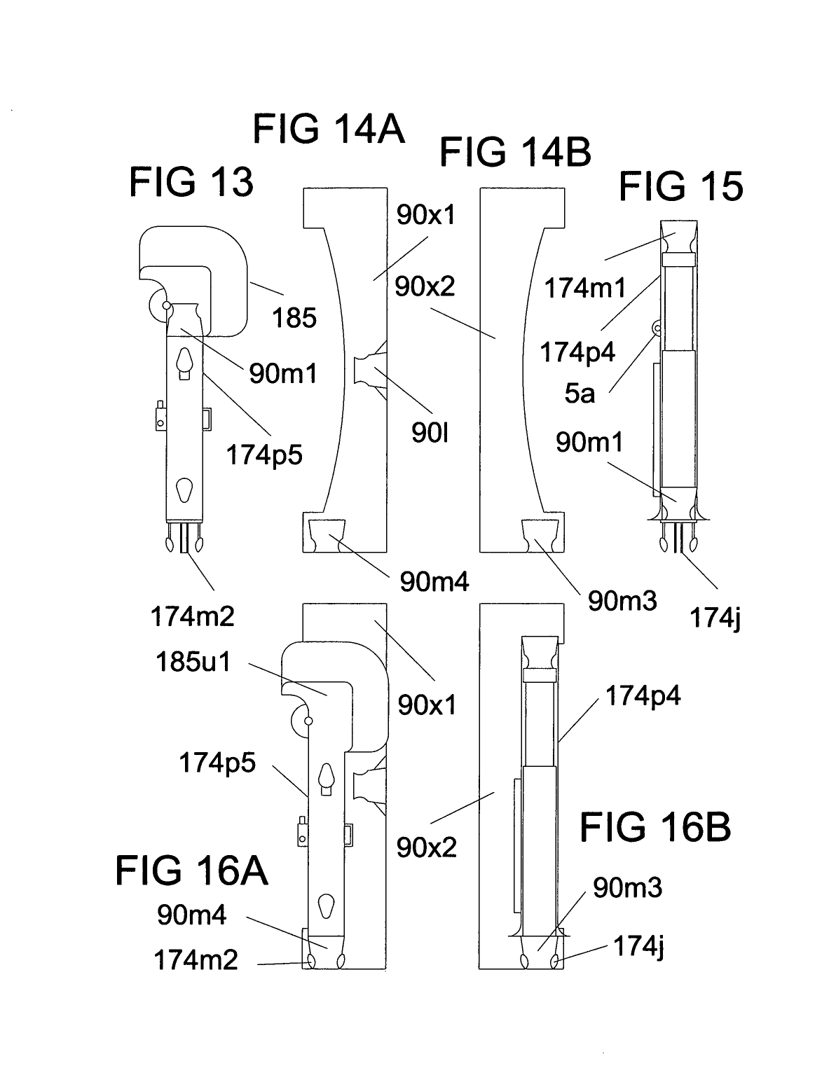

For storage, the wearable propping display holder apparatus may be comprised of two or more compact pieces and these pieces may be adapted to disassemble from an operating position arrangement and reassemble to each other to a compact package position arrangement. As an example, FIGS. 13 to 16B show a package position arrangement for the apparatus embodiment comprised of one operator body interface piece and two operator body prop pieces (first section and second section in this case—see FIG. 11B). An apparatus of this sort with two or more than three pieces may be imagined.

FIG. 13 shows the operator body prop second section 174p5 with the display panel clasp 185 ready for storage to a package position. The second section includes a second section prop attachment 174m2.

FIG. 14A show the operator body interface front side 90x1 and FIG. 14B shows the operator body interface back side 90x2. On the front side or the back side or integrated into the operator body interface there may be included one or more operator body interface prop attachments 90l (for use when assembled in the operating position). This attachment may be located between the right and left sides of the operator body interface (shown, as an example, half way between). On the front side or the back side or integrated into the operator body interface there may be included one or more operator body interface package position attachments, for example an operator body interface second section package position attachment 90m4 and/or an operator body interface first section package position attachments 90m3. The number and placement of the operator body interface package position attachment or operator body interface prop attachment (for operating position) may vary to suit various packaging arrangements. The first and second section package position attachments may be identical and interchangeable, may be located at the right or left side of the operator body interface and/or may be located on the front or back side of the interface with the attachments on opposite sides of the interface (right/left sides or front/back sides).

FIG. 15 shows the operator body prop first section 174p4 including a first section to operator body interface attachment 174j and a first section to second section attachment 174m1. Also shown is that the suspension device attachment 5a may be located on the operator body prop first section.

FIG. 16A shows the operator body prop second section 174p5 in a package position next to the operator body interface front side 90x1 with the second section prop attachment 174m2 attached to the operator body interface second section package position attachment 90m4. The front side 185u1 of the display panel clasp is shown.

FIG. 16B shows the operator body prop first section 174p4 in a package position next to the operator body interface back side 90x2 with the first section to operator body interface attachment 174j attached to the operator body interface first section package position attachment 90m3.

Other package position attachment configurations may be conceived. For example, the second section may store by attaching to the first section and alternative package position attachments (see 90m1, FIGS. 13 and 15) may be provided for this purpose.

Alternatively, more than two operator body prop sections may be used. In another alternative, the operator body prop may be made of only one section detachable from the operator body interface (two pieces). Also possible is that, to shorten the operator body prop in an operating position, the first section may occasionally be left out and the second section attached directly to the operator body interface (174m2 to 90l).

The objective is to make the apparatus a more compact package for storage by, for example, shortening the operator body prop by dividing it into (two or more) sections and/or turning the operator body interface about 90 degrees so that the (vertical or horizontal) elongation axis of all prop sections and interface align and may be attached and stored along their same elongation axis.

It can be seen from FIGS. 14A, 14B, 16A, and 16B that the operator body interface has smooth front and back sides except for the attachments and that the first and second operator body prop sections have smooth surfaces to match the interface. In this way the first and second operator body prop sections may attach to the interface in a way to avoiding the attachments and be stored in a package position flat and compactly against front side and back side of the interface.

FIGS. 17A and 17B show the back side 185u2 of the display panel clasp at the end of the operator body prop second section 174p5. They show that the display panel clasp 185 may have a clasp release part designed to hold or release the display panel to/from the rest of the clasp. Also shown is the back side 174b of the operator body prop (second section). In FIG. 17A, the clasp release part 185k (FIG. 17B) may be comprised of, for example, an attachment part 185t, in this case a hook, and a retainer part 185k8, such as, but not limited to, an elastomeric cord or band, a spring clip, a tightener, a leaf spring or coil spring, attaching the attachment part to the display panel clasp at an attachment point 54g. The clasp release part of the display panel clasp is designed to attach to an edge of the display panel and hold it to the rest of the clasp. The suspension device attachment 5a5 may be located on the back side of the operator body prop.

The end of the clasp release part opposite the attachment part may be attached to the rest of the display panel clasp at an attachment point 54g so the clasp release part can pivot 90 degrees (on an axis perpendicular to the display plane) to hold the display panel in either a horizontally oriented display mounting position or in a vertically oriented display mounting position. In FIG. 17A the attachment point is a hole through which the bungee elastic may be passed and knotted, seized or attached to a piece too large to pass back through the hole. Other attachment methods or features may be envisioned.

In FIG. 17B, the display panel clasp release part 185k includes a different retainer part 185k8 that is, in this figure, an elastomeric band or flexible plastic or flexible metal strip that attaches the display panel clasp to the display panel distal edge 43 (the edge opposite the proximal attachment edge 42) thus holding the display panel to the clasp (see FIG. 18). The clasp release part may attach to the clasp release attachment point 54g with a pivoting attachment. The clasp release part may include an attachment part 185t on the end opposite attachment point to temporarily fasten itself to the display panel distal edge. The dashed image of the clasp release part shows that the release part may pivot 90 degrees on the attachment point.

It can be imagined that other display panel clasp arrangement may be configured including ones without any display panel clasp release part.

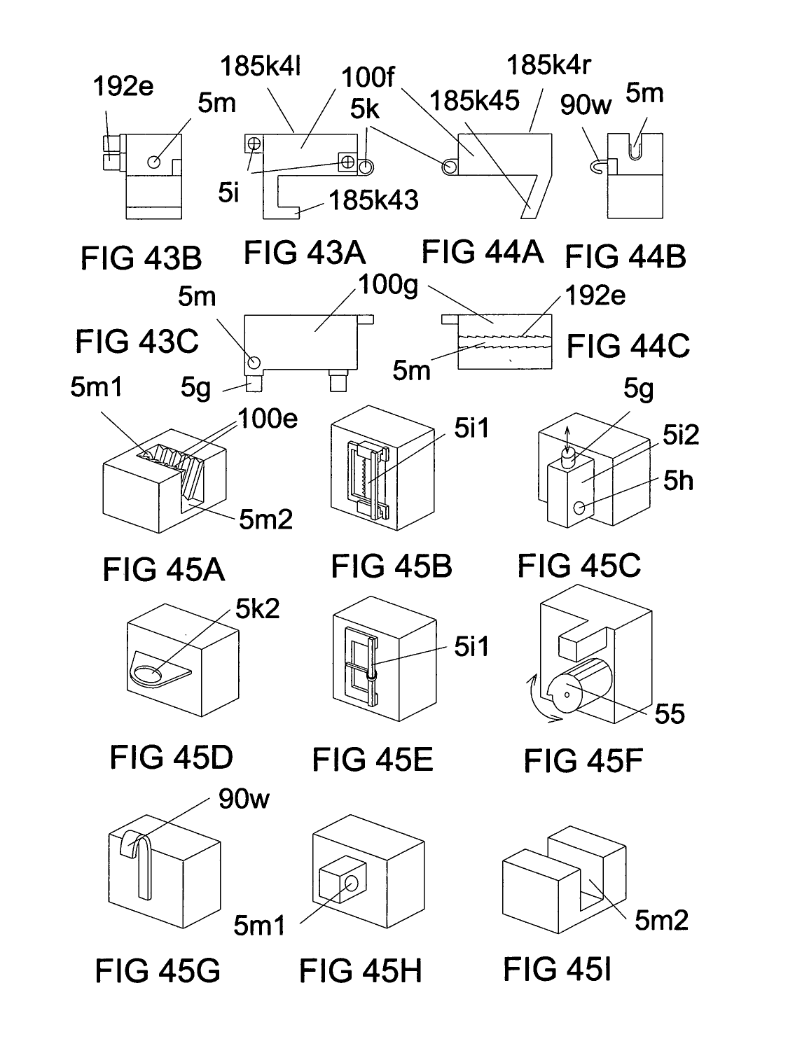

FIG. 18 is a left side view (turned 90 degrees) of the display panel clasp and operator body prop second section 174p5 shown in FIG. 17B. It can be seen that the display panel clasp release part attachment part 185t, shown as a hook, will fit the edge of the display panel 13f (side/profile view) distal edge 43. The clasp release part retainer part 185k8 is shown as an elastomeric band and allows the hook to stretch or flex and reach the display panel top edge and apply pressure to force and hold the display panel into a horizontally oriented display mounting position substructure 185e1 such as (but not limited to) a channel formed by one or more flanges 185e (see also FIGS. 43A and 44A) on the display panel clasp. A vertically oriented display mounting position substructure 185e2, which may be a channel formed by one or more flanges, along with the clasp release part turned 90 degrees on the attachment point may be used, alternatively, to hold the display panel in a vertically oriented display mounting position (see front view FIG. 19) with the display panel rotated about 90 degrees on an axis perpendicular (see FIG. 1) to the display plane from its horizontally oriented display mounting position. The substructures may include friction enhancing material, shape, surface or structures to help hold the display panel proximal attachment edge 42 to the clasp. In each case, the mounting position substructure and the clasp release part attachment part act as two jaws of the display panel clasp configured to hold the display panel to the operator body prop. The substructure and the display panel clasp release part may be configured to leave exposed a large portion of the display on the display panel.

It can be seen that the back side 174b of the operator body prop (second section) and the display panel clasp are, except for the clasp release part, smooth to fit and facilitate its storage against the operator body interface. This allows it to store compactly against the interface.

FIG. 19 is a front view of the display panel 13f with electronic display 45 held in the display panel clasp in a vertically oriented display mounting position by the two jaws 100; jaw 1) the vertically oriented display mounting position substructure (shown as a channel formed by one or more flanges 185e) configured to hold the display panel proximal attachment edge 42 to the clasp and; jaw 2) the attachment part 185t of the clasp release part configured to hold the display panel distal edge 43 to the clasp. The jaws may be made of a rigid material (e.g. rigid plastic or metal) suitable for grasping the display panel edges. This figure shows the front side 174f of the operator body prop (second section).

FIG. 20A and FIG. 20B show two side views of the operator body prop first section 174p4. In FIG. 20A shows an example of a type of eyeglass holder 90o1. This eyeglass holder is shown pivotally attached to the operator body prop and in a storage position against the operator body prop first section 174p4. In FIG. 20B, a second eyeglass holder 90o4 provided with the eyeglasses by the eyeglass manufacturer is in the holder. In this arrangement the second eyeglass holder may compressed against a spring 90o9 (show in dashed lines inside the holder) inside the eyeglass holder 90o1 so that the second eyeglass holder may engage or disengage from an eyeglass holder top part 90o3. The eyeglass holder top part may include a hinged or spring loaded (for example, flexible plastic) locking mechanism. The eyeglass holder and second eyeglass holder are then free to pivot on a hinge 54 for access to the eyeglasses. Other eyeglass holder arrangements may be conceived. The back side 174b of the operator body prop first section is flat to fit and facilitate its storage against the operator body interface.

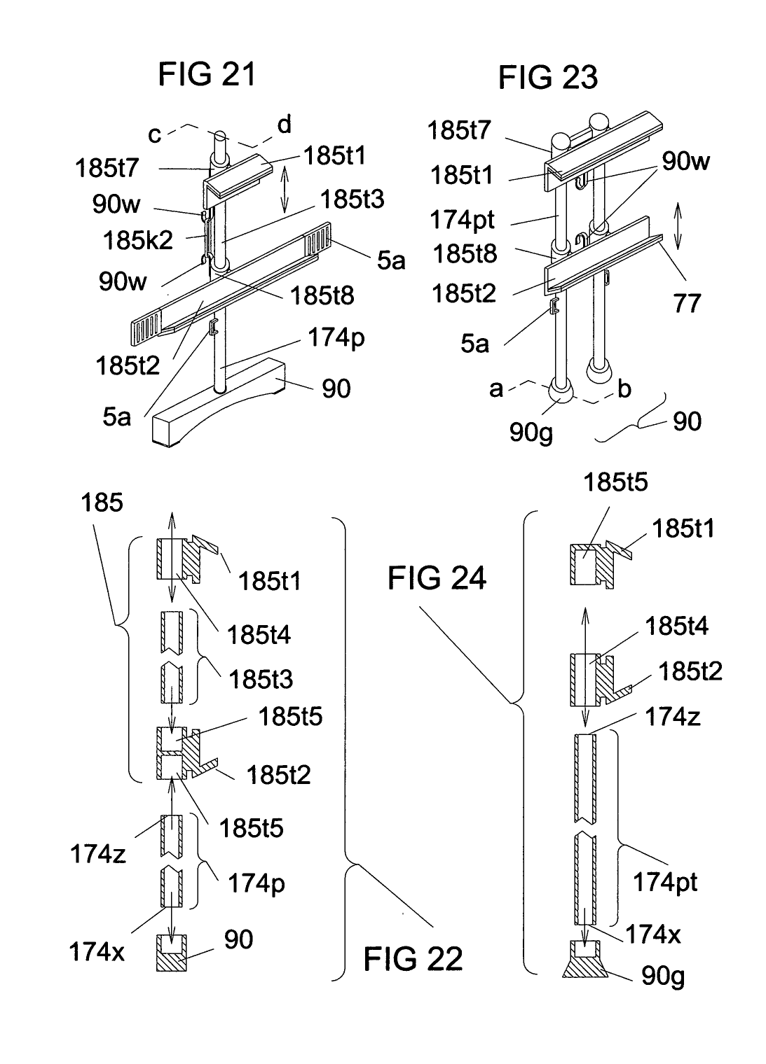

FIG. 21 and FIG. 22 show an embodiment of the wearable propping display holder apparatus adapted for use with a tablet computer. FIG. 21 is a perspective view and FIG. 22 is a top to bottom cross section side view taken at c/d of FIG. 21. These figures include one operator body prop 174p with an operator body interface 90 at the prop's bottom end 174x. The top end 174z of the operator body prop attaches to the display panel clasp 185 at a bottom jaw attachment t8 which is attached to the bottom jaw 185t2 of the display panel clasp.

The display panel clasp, in this figure, includes of a top jaw 185t1 and a bottom jaw 185t2, the two jaws connected together with a jaw connecting piece 185t3. The top jaw includes a top jaw attachment 185t7 (FIG. 21) which attaches the top jaw to the jaw connecting piece. The bottom jaw includes a bottom jaw attachment 185t8 (FIG. 21) which attaches the bottom jaw to the jaw connecting piece. The top and bottom jaws are designed to hold the display panel while leave exposed a large portion of the display.

As explained below, the top jaw attachment and bottom jaw attachment may be of several types (e.g. sliding, fixed, combination). The jaws may be made of a rigid material such as rigid plastic or metal.

In these figures, the display panel clasp top jaw is slidably attached to the jaw connecting piece using a top jaw attachment that is a sliding jaw attachment 185t4 (FIG. 22) and the bottom jaw is fixed to the jaw connecting piece using a bottom jaw attachment that is a fixed jaw attachment 185t5 (FIG. 22). With this arrangement, the top jaw may move with an up/down motion and the distance between the top jaw and the bottom jaw may be adjusted to clamp and hold a display panel (e.g. a tablet computer).

A retraction mechanism may be used to pull the two jaws together and clamp onto the display panel. As an example, a retraction mechanism tightener 185k2 (shown in FIG. 21 as an elastomeric bungee cord) may extend between a first retraction mechanism attachment 90w (shown as a hook), found on either the top jaw or the top jaw's sliding jaw attachment, and a second retraction mechanism attachment (also 90w), found on either the bottom jaw or the bottom jaw's fixed jaw attachment, thus pulling the jaws together and clamping the tablet computer between the two jaws. The tightener pulls the jaws together.

Also shown in FIG. 21 is the suspension device attachment 5a shown attached near the right side end and left side end of the bottom jaw. Alternatively the suspension device attachment 5a may be located on the operator body prop.

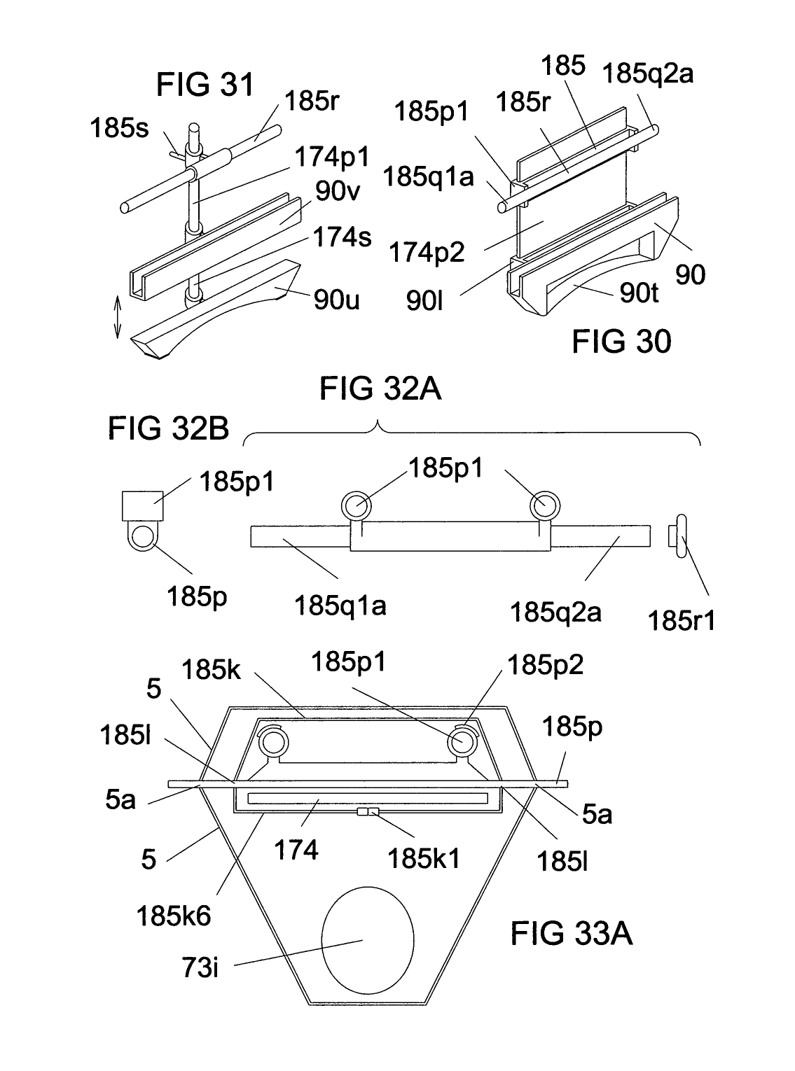

FIG. 23 and FIG. 24 show an embodiment of the wearable propping display holder apparatus adapted for use with a tablet computer. As shown in this figure, the rod-like components may be made of light weight pipe or tube (for example, pipe made of light weight metal or plastic or made of plastic and fiber composite such as (but not limited to) polyethylene or polyester with glass fiber or epoxy with carbon fiber) but, alternative, rod-like, bar-like (e.g. “H”, “L”, “U” or “T” cross sections) or panel-like (see FIG. 30) structures may be used.

FIG. 23 is a perspective view and FIG. 24 is a top to bottom cross section side view taken at a/b of FIG. 23. FIG. 23 shows that more than one (two) operator body props may be used and these in combination may also form an operator body interface (90 shown with brace) with the two props making a width that provides a lateral stability member and separated surfaces for lateral (left and right) tipping stability for the apparatus. The operator body props may also include one or more operator body interface 90g friction enhancing features such as rubber-like (elastomeric) end pieces to temporarily adhere the prop ends to the operator's body.

In FIG. 23 and FIG. 24 the operator body prop and the jaw connecting piece are combined to make one or more combination clasp/prop struts 174pt connecting the top jaw 185t1 and a bottom jaw 185t2 together. The operator body interface is attached near the bottom end 174x of the struts. The jaws may include one or more mounting features 77 such as slots, flanges, gripping surfaces, cushions as desired to hold the display panel to the jaws. The top end 174z of the combination clasp/prop strut 174pt attaches to the display panel clasp top jaw attachment 185t7 (FIG. 23) which is a part of the top jaw 185t1 of the display panel clasp. The display panel clasp bottom jaw includes a bottom jaw attachment 185t8 (FIG. 23) which slidably attaches the bottom jaw to the combination clasp/prop struts.

As explained below, the top jaw attachment and bottom jaw attachment may be of several types (e.g. sliding, fixed, combination).

In these figures, the display panel clasp bottom jaw is slidably attached to the combination clasp/prop strut using a bottom jaw attachment that is a sliding jaw attachment 185t4 (FIG. 24) and the top jaw is fixed to the combination clasp/prop strut using a top jaw attachment that is a fixed jaw attachment 185t5 (FIG. 24). With this arrangement, the bottom jaw may move with an up/down motion and the distance between the top jaw and the bottom jaw may be adjusted to clamp and hold a display panel (e.g. a tablet computer).

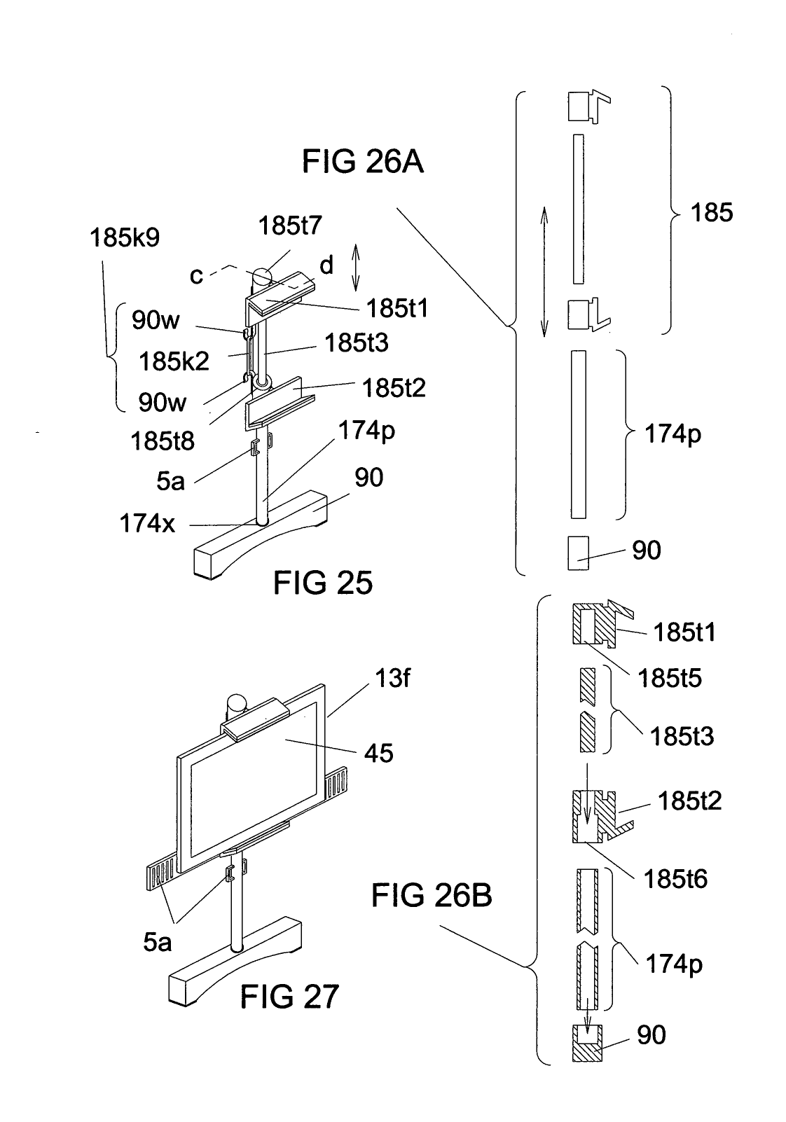

A retraction mechanism may be used to pull the two jaws together and clamp onto the display panel. As an example, a retraction mechanism's (see FIG. 25) retraction mechanism tightener (for example, an elastomeric bungee cord, elastomeric cushion, metal spring, metal of plastic leaf spring or other mechanism to pull the two jaws together) may extend between the first retraction mechanism attachment 90w (shown as a hook fairlead with no tightener included), found on either the top jaw or the top jaw's fixed jaw attachment, and a second retraction mechanism attachment (also 90w), found on either the bottom jaw or the bottom jaw's sliding jaw attachment thus pulling the jaws together and clamping the tablet computer between the two jaws.

Also shown in FIG. 23 is the suspension device attachment 5a shown attached to the combination clasp/prop strut (two attachments shown). Alternatively, there may be a single attachment (e.g. toward the strut back). The suspension device attached to these attachments provides toward/away stability and adjustability for better operator viewing.

FIG. 25, FIG. 26A and FIG. 26B show a wearable propping display holder apparatus embodiment similar to that of FIG. 21 but with a variation in the connection of the operator body prop to the display panel clasp, specifically a “telescoping” movement. FIG. 25 is a perspective view of this embodiment, FIG. 26A is a left side (profile) view of the embodiment (the retraction mechanism is removed) and FIG. 26B is a top to bottom cross section of FIG. 26A at c/d in FIG. 25. FIG. 26B is scaled slightly larger than FIG. 26A. In FIGS. 26A and 26B the clasp, prop and interface parts have been disassembled for better understanding. Components 185t3 and 174p of FIG. 26B have been graphically broken to shorten their length in the drawing. The operator body prop and the jaw connecting piece are shown as round cross section pipes but various other bar-like rods or tubes (e.g. box bar, “H” bar, “L” bar, “T” bar, “U” bar or variation thereof) may be substituted with the same effect. Any alternative bar-like structure may include guides, tracks or travelers to hold the body prop and connecting piece slidably together without necessarily enclosing.

A variety of arrangement may be imagined where these two parts may fit beside, within or around each other while resulting in the same display panel clasp size adjustability and storage ability as described above.

These three figures show that the jaw connecting piece 185t3 may adjust its length by sliding (with up/down motion) a portion of itself into the operator body prop 174p, here shown as a single pipe of a diameter large enough to enclose the jaw connecting piece.

The operator body prop is used to increase the distance between the operator's body and the display panel held in the display panel clasp 185 by the top jaw t1 and the bottom jaw 185t2. The top jaw includes a top jaw attachment t7 (FIG. 25) that attaches the top jaw to the jaw connecting piece. The top jaw attachment in these figures is a fixed jaw attachment 185t5.

The bottom jaw includes a bottom jaw attachment 185t8 (FIG. 25) that attaches the bottom jaw to the jaw connecting piece. The bottom jaw attachment in this figure is a combination sliding/fixed jaw attachment 185t6 (FIG. 26B) adapted to fix the bottom jaw to the operator body prop but slidable attach bottom jaw to the jaw connecting piece.

A retraction mechanism's 185k9 tightener 185k2 (e.g. an elastomeric bungee cord) may extend between a first retraction mechanism attachment 90w (shown as a hook), found on either the top jaw or the top jaw's top jaw attachment, and a second retraction mechanism attachment (also 90w), found on either the bottom jaw or the bottom jaw's bottom jaw attachment thus pulling the jaws together and clamping the tablet computer between the two jaws.

The operator body interface 90 is attached to the operator body prop bottom end 174x to provide lateral (left to right) tipping stability while the suspension device (possibly attached using one or more suspension device attachments) provides stability in a toward/away direction from the operator's head. Friction enhancing features or attachments may be included to temporarily adhere the operator body interface to the operator's body. The operator body prop may include one or more suspension device attachments 5a to hold a suspension device to the apparatus for forward/away tipping stability and to adjust the display panel distance from the operator's face.

FIG. 27 shows an example of a wearable propping display holder apparatus (as in FIG. 25 for example) with a top jaw and a bottom jaw to clamp a display panel 13 to the apparatus so it may be worn and the display 45 viewed by the operator. This example includes two variations of the suspension device attachment 5a; 1) attached to the operator body prop and/or; 2) attached to the display panel clasp or its components (shown here attached to the bottom jaw).

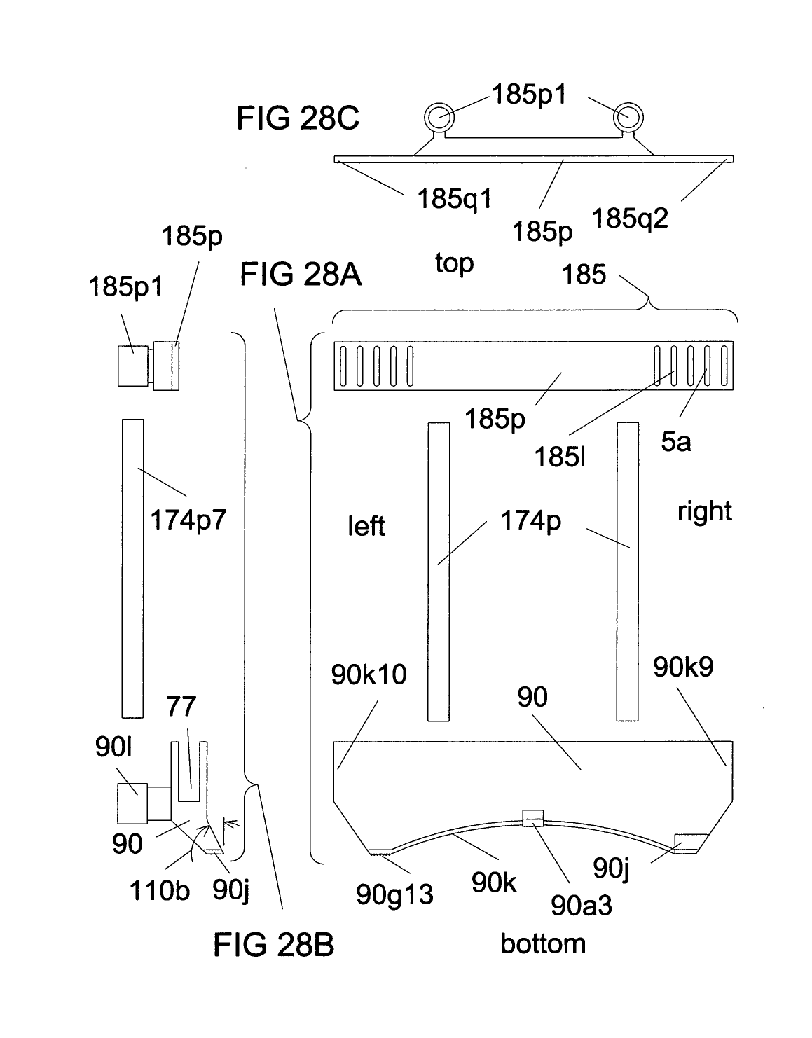

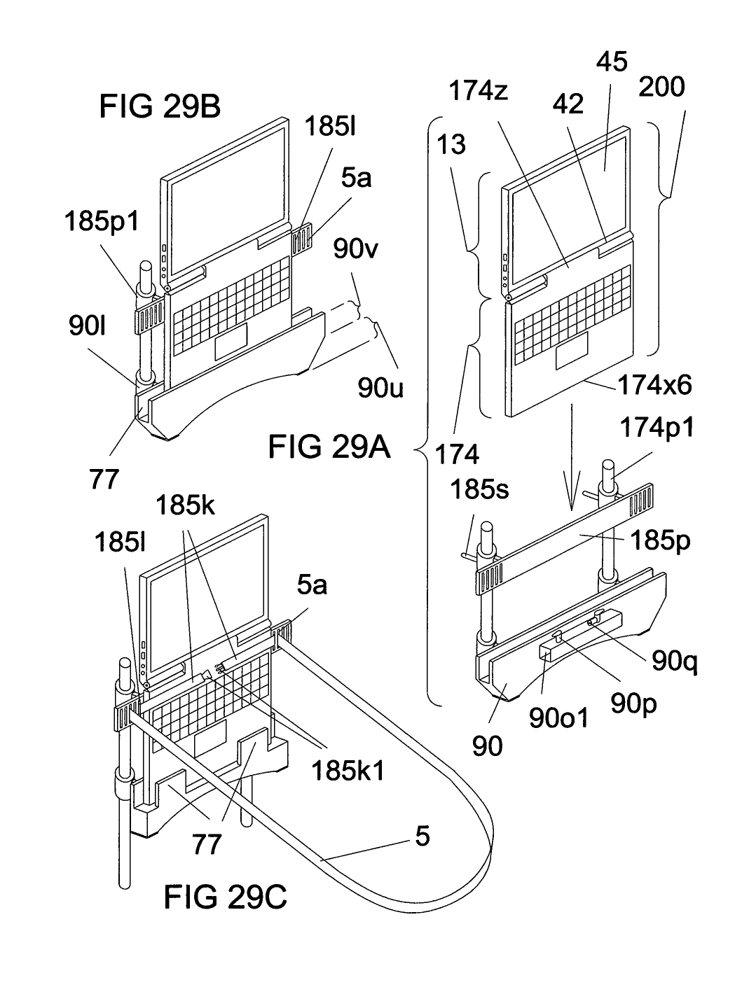

FIG. 28A, FIG. 28B and FIG. 28C show the disassembled parts of the wearable propping display holder apparatus embodiment designed to hold a computer with a display panel and computer body panel hinged together in book-like fashion (also called “lap top computer” or “notebook computer”) (see 200, 174 and 13, FIG. 29A). The holder holds the computer body panel while the display panel is free to pivot above the apparatus for viewing. Once in the holder, the computer and display function as a wearable computer for sitting, standing, lounging or other operator positions. This “computer with a display panel” will be referred to below as a “notebook computer”. This holder may be of wearable frame-like or easel-like construction.

FIG. 28A includes the orientation directions from the front view (as shown in the figure); “top”, “bottom”, “right”, and “left”. Within this orientation is shown the apparatus operator body interface 90 (near the bottom), the display panel clasp 185 (near the top) and one or more rod-like operator body props 175p (two props shown in this figure) positioned to join the operator body interface and display panel clasp. The display panel clasp and interface hold the notebook computer to the apparatus, normally by the computer's body panel (see FIGS. 29A, 29B and 29C). The display panel clasp may include a laterally elongated clasp bar 185p with a right to left orientation so that a clasp release part and a suspension device may be attached to the clasp bar toward its ends to the right and to the left of the notebook computer held to the apparatus. The clasp bar may include one or more suspension device attachments 5a and one or more display panel clasp release part attachments 185l and there may be several of these attachments for the purpose of adjusting the clasp release part and suspension device to fit the right to left dimension of the computer body panel held in the display panel clasp. The figure shows the right side 90k9 and the left side 90k10 of the operator body interface.

The operator body interface may include one or more friction enhancing features, sliding stability features, tipping stability features or attachment features, for example, one or more interface legs 90j, shaping 90k to compliment the operator's front body surface or gripping surfaces 90g13 near the bottom to interface with the operator's body and facilitate the temporary adhering of the apparatus to the operator's front stomach/chest surface area. The operator body interface may include an operator linking attachment 90a3 (shown as a bar and opening) for an alternative way to attach the interface to the operator. The operator body interface features may include cushioning, foam or a contact band between the legs (see FIG. 30) for the purpose of making the fit of the operator body interface to the operator more comfortable while stabilizing the apparatus against tipping and sliding.

FIG. 28B shows the apparatus viewed from the left side (profile) and also showing the operator body interface 90 (near the bottom), the clasp bar 185p (near the top) and one or more operator body props. In this figure, the prop is shown as light weight pipe or tube 174p7 made of, for example, light weight metal or plastic or made of plastic and fiber composite such as (but not limited to) polyethylene/polyester and glass fiber or epoxy and carbon fiber) for the purpose of producing a light strong structure. Other parts of the apparatus such as length adjusters, combined body prop length adjuster, display panel clasp bar or clasp bar horns may also be made of this material. It can be seen that the operator body props are used to connect and hold the relative position of the operator body interface and the display panel clasp and may not make contact with the notebook computer held in the apparatus. The operator body interface and clasp bar designed to hold the computer (especially the computer body panel) to the apparatus while leave exposed a large portion of the display.

The clasp bar may attach to the operator body prop using a clasp bar prop holder 185p1. For adjustment of the apparatus to a variety of notebook computers, the clasp bar prop holder may be configured to slide in an up/down motion along the operator body prop to fit the up/down dimension of the computer body panel held in the display panel clasp.

To attach the operator body interface to the operator body prop, the operator body interface may include an operator body interface prop attachment 90l configured to hold the one or more operator body props, in this figure shown as a rod-like pipe, to the operator body interface. In this figure the operator body interface includes an interface leg 90j that is angled 110b and/or shaped to be able to hold the apparatus and computer in an almost vertical position and nearly parallel to the operator's front stomach/chest area.

The operator body interface may include a bottom end holder part to hold the bottom end of the computer body panel to the apparatus and the bottom end holder part may include one or more mounting features 77. Although a variety of mounting features or attachments may be used for this purpose, for simplicity one or more right-to-left slots, troughs, channels, hooks, angles, grooves, right/left flanges or similar shapes may be used where the bottom end of the computer body panel may enter (or be removed from) the mounting feature with, for example, an approximate up/down motion and hold to the bottom end holder of the interface because of its weight, position and/or additional attachments. This type of mounting feature is adaptable to fitting a wide variety of different notebook computer sizes. This type of feature supplies resistance to twisting of the notebook computer and display panel clasp.

FIG. 28C shows the display panel clasp of FIG. 28A turned 90 degrees to be viewed from a top. The clasp bar 185p has a right end 185q2 and a left end 185q1 and these may extend to the right and left of the notebook computer held by the display panel clasp and provide a place for attachment of the suspension device, suspension device attachment, display panel clasp release and/or display panel clasp release attachment. The clasp bar prop holders 185p1 are shown attached to the clasp bar and including passages (openings) for holding the operator body props in them.

FIG. 29A shows, with a perspective drawing, the wearable propping display holder apparatus assembled including the display panel clasp's clasp bar 185p, the operator body props 174p1 (shown as two pipe or dowel) and the operator body interface 90. Also shown on the operator body interface is an eyeglass holder 90o1, an earphone wire storage device 90p and a simulated earphone socket 90q. A table top tilt support 185s may be included to adjust the angle of the computer and apparatus when setting approximately horizontal on a table top.

This figure includes a notebook computer 200 including a display panel 13 (including electronic display 45) pivotally attached to a computer body panel 174 top end by the display panel attachment edge 42. The computer body panel includes a bottom end 174x6 and a top end 174z. The notebook computer is shown in an open operating position. For mounting the computer to the wearable propping display holder apparatus, the bottom end of the computer body panel sets into a mounting feature of the bottom end holder part (see 77 and 90v, FIG. 29B) of the operator body interface while the top end of the computer body panel is held to the display panel clasp bar with the display panel clasp release part (see 185k, FIG. 29C).

FIG. 29B shows the notebook computer mounted to the wearable propping display holder apparatus. The operator body interface may be further comprised of a bottom end holder part 90v for holding the notebook computer body panel bottom end to the apparatus. In this figure, the bottom end holder includes a mounting feature 77 (in this case a groove formed by two lateral flanges) to hold the computer body panel bottom end to the operator body interface. The operator body interface may also include a body contact part 90u attached to the bottom end holder part and configured to interface the apparatus with the operator. Also shown are one of the display panel clasp's clasp bar prop holders 185p1 and one of the operator body interface's prop attachments 90l. The figure further shows one or more suspension device attachments 5a and one or more display panel clasp release part attachments 185l.

In FIG. 29C, the suspension device 5 (a strap) and the display panel clasp release part 185k are included on the apparatus. Their connections at the suspension device attachment 5a and the clasp release part attachment 185l are shown. For easy opening of the clasp release part, it may include a clasp release part fastener 185k1 for installing the computer. In this drawing it is shown that the bottom end holder's mounting feature 77 may be more than one part while still being adaptable to a variety of computer widths and resisting twisting motion. The operator body props of this figure have been lengthened to push the display further from the operator's body for better viewing.

FIG. 30 shows that the operator body prop 174p2 (a panel) may be a panel or have a rectangular cross section with the operator body interface's prop attachment 90l of the operator body interface 90 and display panel clasp's clasp bar prop holder 185p1 of the display panel clasp adapted to fit it. Also shown is that the display panel clasp bar may be have a round cross section 185r (round) and include no particular shape matching the computer body panel. The right end and left end of the clasp bar may be or serve as right end attachment horn 185q2a and left end attachment horn 185q1a for attaching the suspension device and/or attaching the clasp release part to the display panel clasp. In this case, the suspension device or clasp release part may loop or coil around the horn instead of using a specific attachment. This figure also shows that the operator body interface may include a flexible contact band 90t or filament designed to extend between two operator body interface legs or adjustment rods and contact with, shape to and improve temporary attachment of the apparatus to the operator's body.

FIG. 31 shows that there may be a single operator body prop 174p1 (for example, but not limited to, a pipe or bar). In this figure, the display panel clasp is configured to hold a pipe or dowel 185r including a right end attachment horn and left end attachment horn for attaching the suspension device or the display panel clasp release part to the clasp bar. This figure also shows that the operator body interface may include an operator body prop length adjuster 174s and this length adjuster may be located between the computer bottom end holder part 90v of the operator body interface and the body contact part 90u of the operator body interface. The length adjuster may be removably attached to the operator body interface. Alternatively, the operator body prop length adjuster may slide alongside or into a bar-like or pipe-like operator body prop (telescope fashion) for storage with a up/down motion and lengthening or shortening the apparatus length for better wearer viewing of the display. A table top tilt support 185s is shown attached to the clasp bar prop holder for adjusting the angle of the computer and apparatus when setting approximately horizontal on a table top.

FIG. 32A shows a top view (as in FIG. 28C) of a display panel clasp that includes a one or more clasp bar of round cross section such as pipe or dowel. It (they) extends the display panel clasp (right to left) for use and may be removable for storage. The clasp bar may form a right end attachment horn 185q2a and a left end attachment horn 185q1a for attaching the clasp release part and/or suspension device. The clasp bar prop holders 185p1 are shown as round cross sections in this view. A suspension device line retainer knob 185r1 may be included to provide an obstacle to prevent the suspension device or display panel clasp release part from sliding off the end of the pipe/dowel clasp bar attachment horn.

FIG. 32B shows a left side (profile) view of the same display panel clasp of FIG. 32A. The clasp bar prop holder 185p1 is still visible and the clasp bar 185p can be seen with the round cross section pipe or dowel held in it.

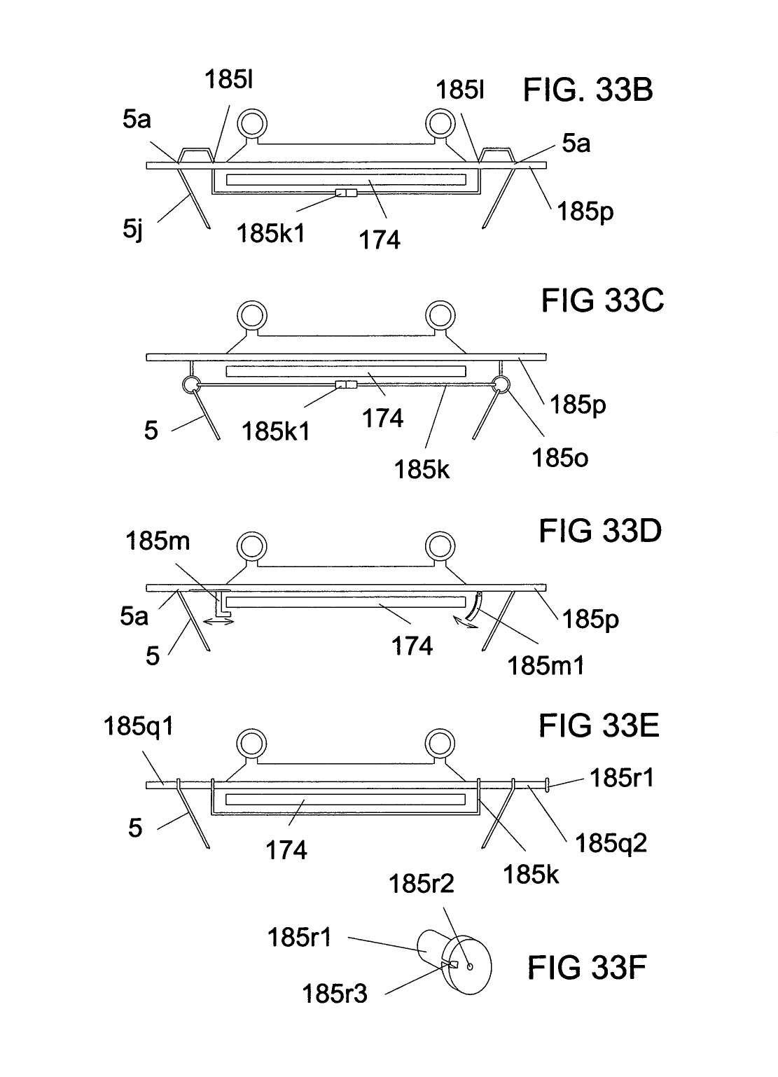

FIG. 33A is a view of the wearable propping display holder apparatus assembled and shown from the top (top view as in FIGS. 28C and 32A and the display panel viewed from the top showing its top edge) and including the suspension device 5, the display panel clasp release part 185k6 (a loop) and the head of an operator 73i. In this arrangement, the suspension device and the display panel clasp release part each form a separate loop extending through suspension device attachment and display panel clasp release part attachment of the display panel clasp bar 185p and around the back of the display panel clasp. The display panel clasp release part holds the computer to the display panel clasp bar. The suspension device passes through the clasp bar at right and left suspension device attachment 5a (shown as openings) and the display panel clasp release part passes through the clasp bar at right and left display panel clasp release part attachments 185l (also shown as openings). The suspension device holds the display panel clasp bar to the operator (neck). The display panel clasp release part may include a release part fastener 185k1 for releasing the computer body panel 174 from the apparatus. The clasp bar prop holders 185p1 are also shown and they may include one or more guides 185p2 to help guide the suspension device and the display panel clasp release part around the back of the apparatus.

FIG. 33B to 33E are views from the top in the style of FIG. 33A but with the operator and the portion of the suspension device near him removed for the purpose of making the drawings compact. FIG. 33B shows an arrangement where the suspension device and the display panel clasp release part are combined into a combination strand 5j passing from the operator through the suspension device attachment 5a (an opening) near the left end of the clasp bar 185p away from the operator. Then the combination strand passes through the display panel clasp release part attachment 185l (another opening near the left end of the clasp bar) back toward the operator and then across the computer body panel 174 to and through the clasp release part attachment near the right end of the clasp bar. The combination strand then passes through the suspension device attachment near the right end of the clasp bar and back to the operator to form a single loop. In this way the combination strand holds the apparatus to the operator and, because of the pulling weight, also holds the computer body panel to the display panel clasp. The combination strand may include a release part fastener 185k1 to quickly release the computer body panel.

FIG. 33C shows another arrangement where the suspension device 5 and the display panel clasp release part 185k are separate strands but the display panel clasp release part attachment and the suspension device attachment are combined into a multipurpose attachment 185o with one such attachment attached to the clasp bar near the right end of the clasp bar and another near the left end of the clasp bar. The display panel clasp release part alone holds the computer body panel 174 to the clasp bar 185p. The suspension device alone suspends the clasp bar (and apparatus) from the operator. The display panel clasp release part may include a release part fastener 185k1 to quickly release the computer.

FIG. 33D shows another arrangement where the suspension device 5 is attached to the display panel clasp bar 185p by one or more suspension device attachments 5a. This figure show two alternative types display panel clasp release parts that are attachments to hold the computer body panel right side edge and left side edge to the display panel clasp bar: a sliding abutment clasp release part 185m and; a pivoting abutment clasp release part 185m1. These are attached to the clasp bar and removably attach the computer body panel to the clasp bar; there is no band, loop or strap across the computer body panel. Either of these clasp release part may be used in combination with, for example, a fixed abutment (not shown) on the clasp bar for the purpose of holding the computer body panel 174 to the clasp bar.

FIG. 33E shows another arrangement where the clasp bar includes a right end attachment horn 185q2 and a left end attachment horn 185q1 and these may serve as multipurpose attachments 185o to serve as both the suspension device attachment and the display panel clasp release part attachment. The suspension device 5 may attach to the attachment horn (such as, but not limited to, a pipe or dowel) using tying or a loop in the suspension device end or using a ring, hook or other attachment attached to the suspension device end. Likewise, the clasp release part 185k may attach to the attachment horn using tying or a loop in the release part end or using a ring, hook or other attachment attached to the release part end. This clasp release part (or clasp release part for any type of notebook holder described in this application) may be made of elastomeric band (e.g. elastomeric bungee cord) and may include one or more hooks, loops or rings, for example, at its ends for attachment to the clasp bar attachment horn. The clasp release part, then, may be engaged or disengaged by stretching it between the right attachment horn and the left attachment horn across the computer body panel 174 and holding the computer body panel and display panel to the clasp bar. The attachment horn may include line retainer knob 185r1 to keep the clasp release part or suspension device from sliding off the attachment horn.

FIG. 33F shows, enlarged and in perspective, the line retainer knob 185r1 of FIG. 33E. The knob may be used to close a clasp bar pipe end and keep the suspension device lanyard from sliding off the end of the clasp bar. The knob may include an opening 185r2 to the interior of the pipe for knotting and hiding the lanyard end. The knob may include a rotation resistor 185r3 such as a notch or aperture which fixes the lanyard to the knob and bar and keeps the lanyard end from rotating on the bar. In this way, the suspension device lanyard length may be adjusted by storing or taking off lanyard length in turns around the bar and the notebook computer may be lowered for typing or raised for close viewing by the operator.

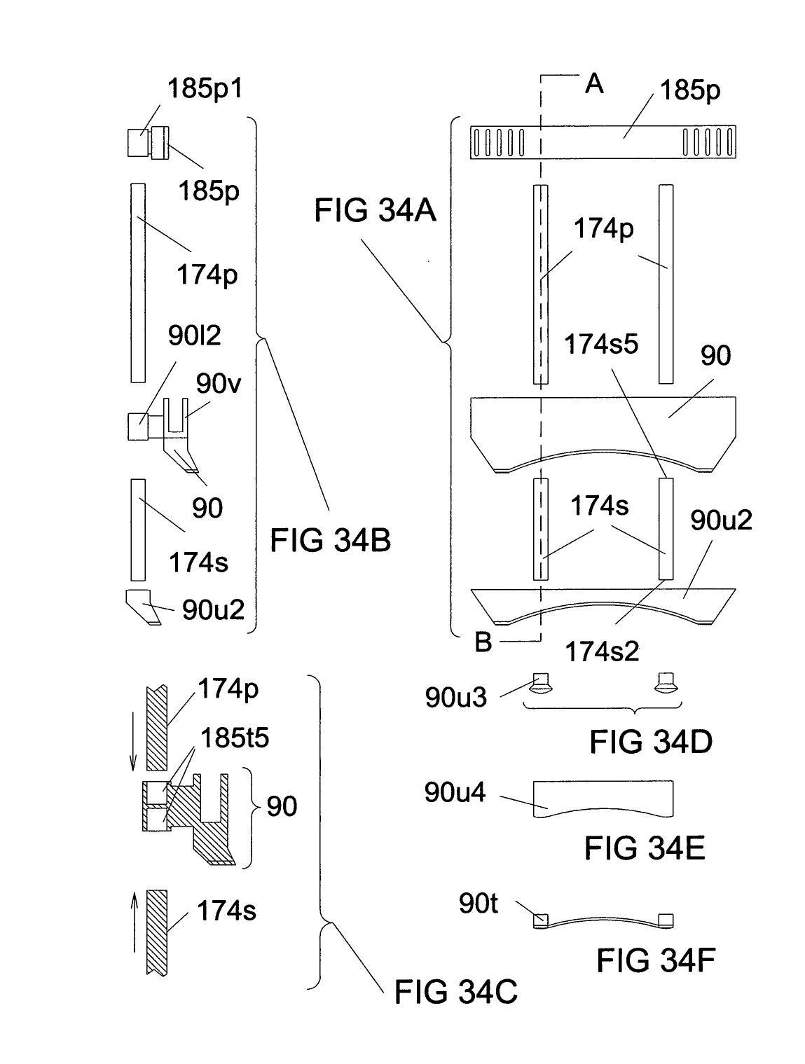

FIG. 34A, FIG. 34B and FIG. 34C show the disassembled parts of the wearable propping display holder apparatus designed to hold a notebook computer. FIG. 34A is a front view and includes the clasp bar 185p, the operator body prop 174p (2 pieces) and the operator body interface 90. In addition, a length adjuster 174s (two) is included. A second operator body interface 90u2 is shown which may be removable and which may be constructed of a variety of structures and materials. The length adjuster is attached to the operator body interface or operator body prop by the length adjuster proximal end 174s5 and is used to lengthen the apparatus and move the computer's display panel into a position better for operator viewing.

FIGS. 34D, 34E and 34F show a few of various alternative second operator body interfaces 90u2 that may be attached to the contact end 174s2 of the length adjuster.

FIG. 34D shows that the second operator body interface may be one or more length adjuster footings 90u3 (one for each of the two length adjusters) used for friction enhancement and operator comfort. FIG. 34E shows that the second operator body interface may be a fabric covering 90u4 designed to fit over the one or more length adjusters. FIG. 34F shows that the second operator body interface may be or include plugs or sockets to fit the length adjuster contact ends and may including a contact band 90t or other body interface feature.

FIG. 34B shows a left side view of the apparatus of FIG. 34A. The clasp bar 185p, clasp bar prop holder 185p1, and operator body prop 174p are again shown. In this figure, the operator body interface 90 is shown including a computer bottom end holder part 90v. The length adjuster 174s is shown including a second operator body interface 90u2. A combined operator body interface prop/adjuster attachment 90l2 is shown attaching both the second operator body interface and length adjuster to the operator body interface. The interface is also used as a holder for the length adjuster.

FIG. 34C is a partial top to bottom side view cross section view on the cross section A/B in FIG. 34A. It shows the connection of the operator body prop 174p and the length adjuster 174s to the operator body interface's 90 prop/adjuster attachment (90l2 in FIG. 34B) using a fixed attachment 185t5 for both the prop and length adjuster. The operator body prop and the length adjuster, as shown here, are separate parts and assemble to the operator body interface's prop/adjuster attachment by separately connecting to it (in this case by inserting).

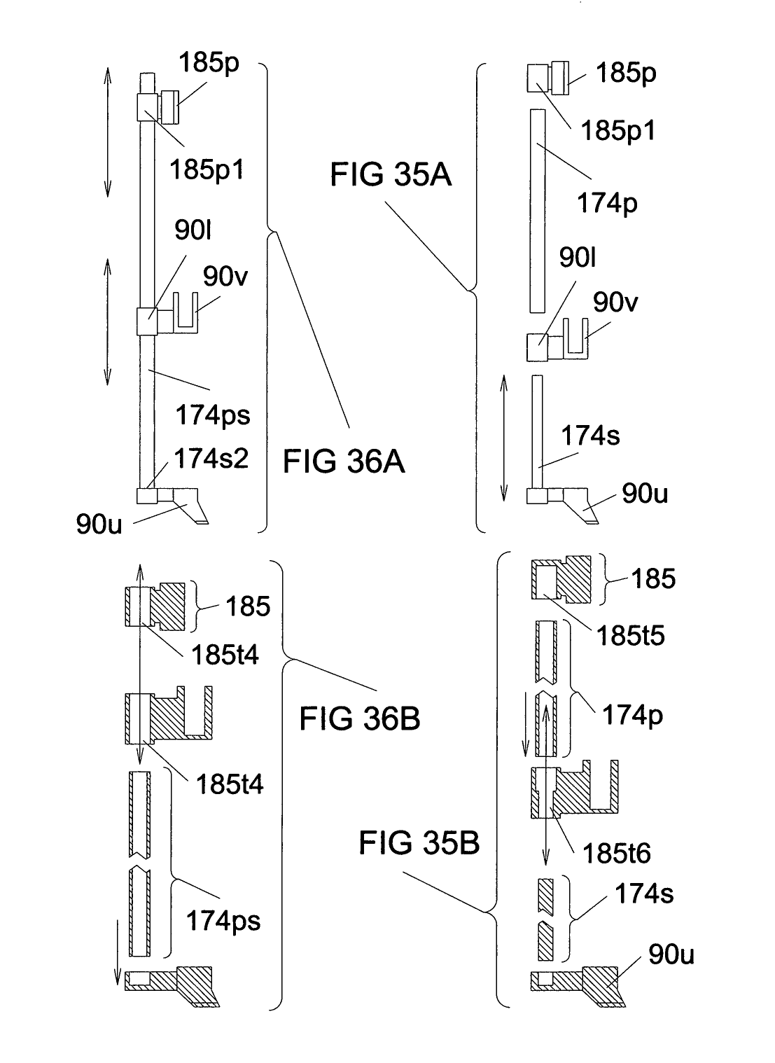

FIGS. 35A and 35B show an alternative arrangement for attaching the display panel clasp and operator body interface to the operator body prop and length adjuster. In FIG. 35A, operator body prop 174p and length adjuster 174s are separate pieces with the length adjuster having a slightly smaller diameter dimension and retracting for storage by sliding into the hollow operator body prop pipe.

As shown in this figure the operator body interface is divided into two parts; the computer bottom end holder part 90v and the body contact part 90u. The body contact part may be attached to the contact end of the length adjuster while the computer bottom end holder part remains attached to the operator body interface's prop attachment 90l. In this way there is no need for a second operator body interface. Toward the top of the drawing, the clasp bar 185p includes a clasp bar prop holder 185p1 adapted to fit the top end of the operator body prop.

FIG. 35B shows the same arrangement of FIG. 35A but in top to bottom side view cross section (at A/B in FIG. 34A). It shows that the contact end of the length adjuster 174s may attach to a body contact part 90u (including friction enhancing and/or attachment features) of the operator body interface and the proximal end of the length adjuster may slidably attach to the operator body interface's prop attachment and slide through it and into the operator body prop 174p which is of larger interior (diameter) measurement and suitable for storage of the length adjuster. The bottom end of the operator body prop may be fixedly attached to the same operator body interface's prop attachment. For the attachment of both the fixed operator body prop and sliding length adjuster to the prop attachment, a combination fixed/sliding jaw attachment 185t6 may be used with the operator body interface's prop attachment. Also shown in this figure is that the display panel clasp's 185 operator body prop holder may be adapted to use a fixed attachment 185t5 to the top end of the operator body prop and may cap it.

Although the operator body prop and length adjuster are shown in these figures as round hollow pipes, they may, alternatively, be made of square, rectangular or polygon pipe, “T” bar, “L” bar, “H” bar, “U” bar or other bar shapes and may include complimentary guides to store their lengths alongside or within each other to work to the same objective.

FIGS. 36A and 36B show another alternative arrangement for attaching the display panel clasp and operator body interface to the operator body prop and length adjuster. In FIG. 36A, the operator body prop and length adjuster are a combined body prop length adjuster 174ps. The display panel clasp bar 185p and clasp bar prop holder 185p1 are slidably attached to the combined body prop length adjuster. The operator body interface's prop attachment 90l, with attached computer bottom end holder part 90v, may be slidably attached to the combined body prop length adjuster. The contact end 174s2 of the combined body prop length adjuster is fixed to the operator body interface's body contact part 90u.

FIG. 36B shows the same arrangement of FIG. 36A but in top to bottom side view cross section (at A/B in FIG. 34A). It can be seen that the combined body prop length adjuster 174ps is configured to match the operator body interface's prop attachment sliding attachment 185t4 and can slide through it. The combined body prop length adjuster also matches the display panel clasp's 185 operator body prop holder sliding attachment (also 185t4) and can slide through it. Any arrangement with sliding parts may include one or more locks to hold the length adjuster or combined body prop length adjuster to a holder.

The various ways of attaching the display panel clasp and operator body interface to the operator body prop and length adjuster may be mixed. For example, in one arrangement (see FIG. 34C, 90, 185t5, and FIG. 36B, 185, 185t4), the clasp bar prop holder 185p1 may be slidably attached to the operator body prop while the bottom end of the operator body prop is fixed to the operator body interface's prop attachment 90l. In this same arrangement, the top end of the length adjuster may be removably attached to the operator body interface's prop attachment 90l when needed. With this arrangement, the clasp bar clasp release part holds the sliding clasp bar to the notebook computer body while the second operator body interface (90u2, FIGS. 34A and 34B) and the length adjuster are only attached to the assembly when needed.

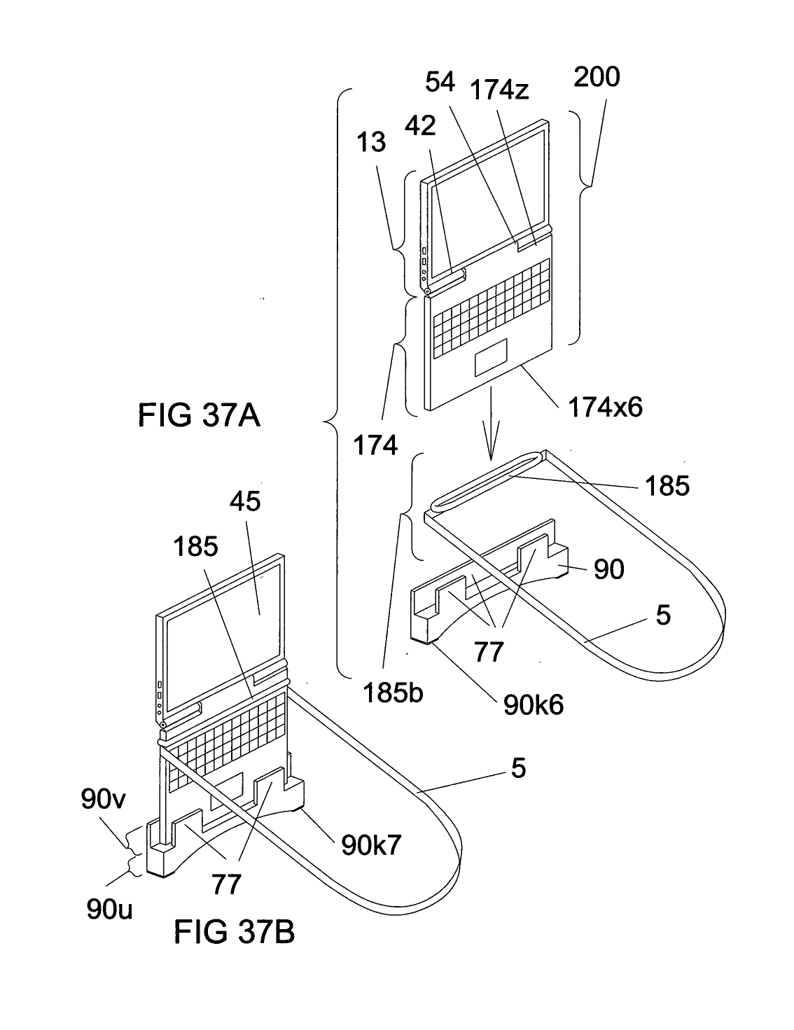

FIGS. 37A and 37B show in perspective drawing another embodiment of the wearable propping display holder apparatus which aims to further reduce and simplify the apparatus. A notebook computer is a computer comprised of a body panel 174 pivotally attached by its top end to a display panel 13 (proximal) attachment edge 42 using one or more hinges 54 so that the two panels may fold together for storage in the manner of a book. FIG. 37A shows the apparatus components and a computer 200 disassembled. The notebook computer is shown in an open operating position. FIG. 37B shows the same components assembled. The figures show that the apparatus has two separate components that work together with the notebook computer body panel 174 to hold the display panel 13 to the operator's body in an operating position in the view of the operator. In this embodiment, the notebook computer body panel 174 substitutes for the operator body prop (elsewhere shown as 174p); the apparatus does not include an operator body prop. The first separate component is the operator body interface component 90 configured to attach to the bottom end of the computer body panel. The operator body interface may include a body contact part 90u and a computer bottom end holder part 90v (the two attached together). The computer bottom end holder part may include one or more mounting features 77 (alternatively called a mounting attachment) to assist in holding the operator body interface to the bottom end 174x6 of the computer body panel. The mounting features may be configured to hold the computer to the operator body interface while leaving exposed the display and the computer controls desired by the operator to operate the computer (for example the keyboard and/or pointing device). The body contact part is configured to provide tipping stability and/or sliding stability for the interface on the operator's body front stomach/chest area and the computer attached to it while it is in an operating position on the operator's body (see FIGS. 7, 8, 9A/F, 10A/F, 12B, 58 and 59). To this end, the operator body interface's body contact part may include a lateral stability member with two laterally separated surfaces (left laterally separated surface 90k6 and right laterally separated surface 90k7 (FIG. 37B)). The second separate component is the combination of the display panel clasp 185 and suspension device 5 component (the combination component called a “combination display panel clasp/suspension device component” 185b is indicated by a brace) which may be attached together. In this embodiment, the display panel clasp holds the computer (for example, the body panel) to the suspension device and may be made of, but not limited to, a circular band or loop of material such as (but not limited to) an elastomeric or partially elastomeric loop (for example, a rubber bungee or elastic band), a line, a strip, a band, a cord, a belt, a binding, a line with jaws, a tightener with jaws, retraction mechanism with jaws or computer left/right side edge holder. The display panel clasp may be configured to hold the computer to the suspension device while leaving exposed the display and the computer controls desired by the operator to operate the computer (for example, the keyboard and/or pointing device). FIG. 37B shows the display panel clasp (in this case, a circular band or loop type) extending in a direction parallel to the notebook computer hinge axis (see FIG. 51) and clasping the computer.

The suspension device may be made of a strap, belt, line, cord, chain, rope or other filament-like material. It may be, but not limited to, a loop enclosing both the computer body panel and operator when in an operating position or a length of material with two ends attached to the display panel clasp and surrounding the operator's neck/shoulder area when in an operating position. The combination display panel clasp/suspension device component installs to the notebook computer central attachment zone (for example, the computer body panel near its top end 174z) and works to suspend the computer body panel and display panel from the neck/shoulder area of the operator while the operator body interface's body contact part 90u pushes against and temporarily adheres to the operator chest/stomach area. The computer's electronic display 45 is in a comfortable viewing position for the operator (apparatus wearer).

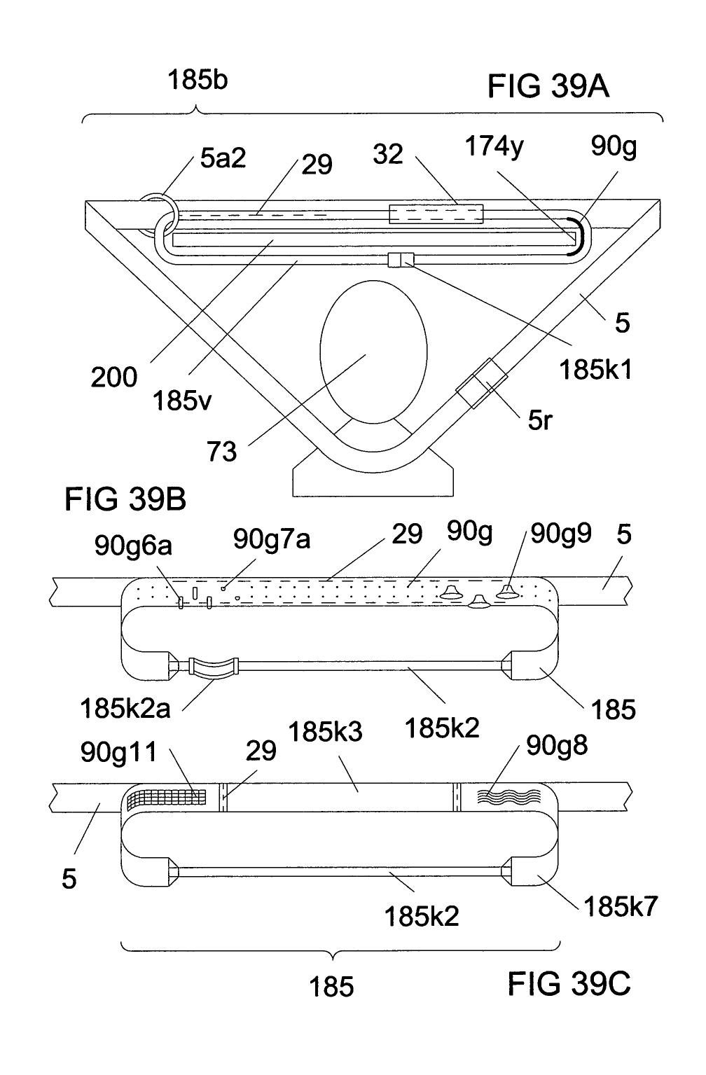

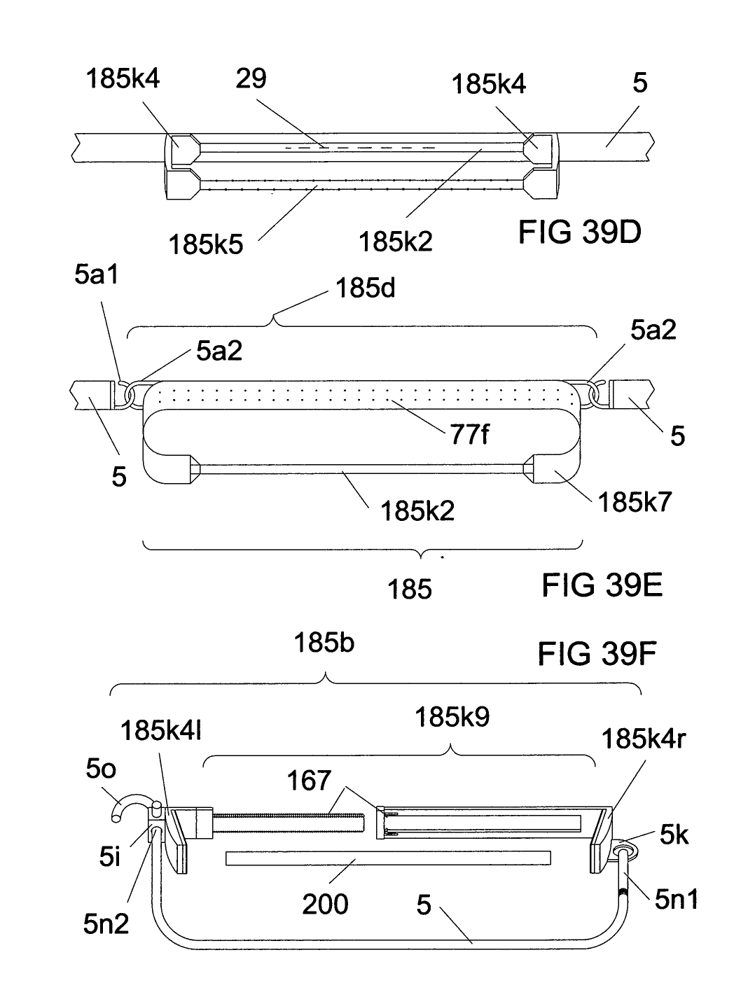

As illustrated later, the suspension device may be removable from the combination display panel clasp/suspension device component and supplied separately. In this case, a combination display panel clasp/suspension device attachment component (see FIG. 39E) may be substituted for the combination display panel clasp/suspension device component.

This embodiment including two separate components used in conjunction to achieve a result and may be seen as a system working toward that result. That result is: The wearable use of a computer with display panel by an operator, wherein the operator body interface presses against and provides lateral tipping and sliding stability for the computer body as it pushes the display away from the operator's front stomach/chest area while the suspension device provides toward/away direction stability and suspends the computer and display panel in an operating position in the comfortable view (line of sight) of the operator.

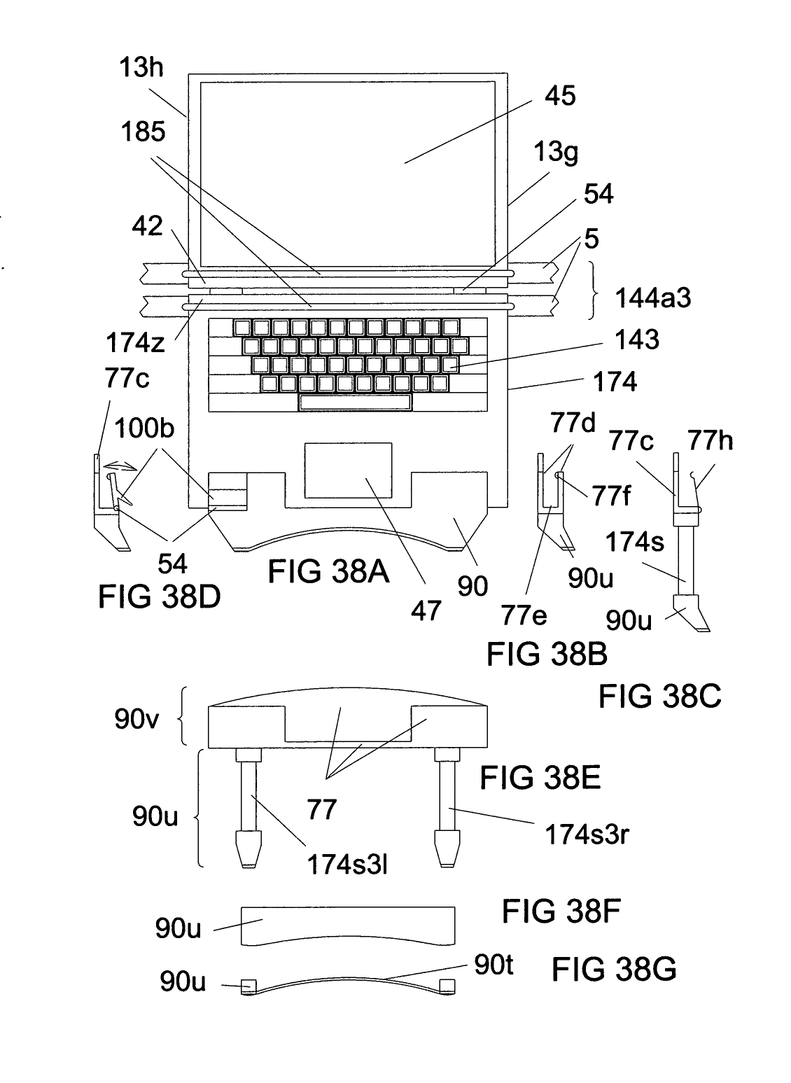

FIG. 38A is a front view of the notebook computer with the operator body interface 90 and the combination display panel clasp 185 and suspension device 5 (truncated right and left in the figure). Two combination display panel clasp/suspension device components (two clasps and two suspension devices) are shown attached to the computer to illustrate that the component may be alternatively attached to the computer body panel or to the display panel. It can be seen that the notebook computer includes a display panel (including a (proximal) attachment edge 42) and a computer body panel 174 (including a top end 174z) with the top end and (proximal) attachment edge pivotally attached to each other with a hinge 54. The computer body panel may include control surfaces including controls such as a pointing device 47 and/or a keyboard 143 and the apparatus may be configured to leave these control surfaces exposed for operator use while being held by the apparatus. The display panel may have a right side edge 13g and a left side edge 13h. In the area near the hinge is located the central attachment zone 144a3, an optimal area on the computer to attach the display panel clasp, the combination display panel clasp/suspension device component or the combination display panel clasp/suspension device attachment component when in an operating position. The central attachment zone extends laterally right to left (parallel to the notebook computer hinge axis) to include portions of the display panel and computer body panel near the hinge that connects them. The electronic display 45, on the display panel, is in view. FIGS. 38B, 38C and 38D show a left side view of the operator body interface (without the computer) to show more detail of the attachment between the operator body interface and the computer body panel. In FIG. 38B, the computer bottom end holder part (see 90v, FIG. 38E) includes mounting features (or mounting attachments) comprised of two jaws 77d forming a channel 77e to hold the computer body panel bottom end. One or more mounting feature flanges (77c, FIG. 38D) may be semi-rigid or flexible enough to adjust to and attach to (for example clamp to) the computer body panel and/or may include one or more flexible friction enhancing features, such as, but not limited to, elastomeric material components 77f, shown here as, elastomeric jaws on the flange surface. The body contact part 90u in this figure is angled (see FIGS. 28B and 46F) toward the operator relative to the plane of the computer body panel and with a tip configured to hold to the operator's body even when the computer body is almost parallel to the operator front stomach/chest surface area.

In FIG. 38C, the mounting feature (or mounting attachment) includes a springy flange 77h, possibly a leaf spring of metal or plastic, configured to press the computer body panel bottom end into the remainder of the computer bottom end holder part 77c (a flange) and attach (for example clamp) the operator body interface and computer body together. The body contact part 90u in this figure includes an operator body interface length adjustment part 174s.

In FIG. 38D, the computer bottom end holder part may include a mounting feature (attachment) comprised of a pivoting arm wedging device 100b (possibly spring loaded) hinged 54 to the rest of the holder. The pivoting arm includes a spring mechanism to push the computer body panel bottom end into an opposite flange 77c of the computer bottom end holder. The pivoting arm or the springy flange (FIG. 38C) may be a part of a mounting feature that includes other, possibly elastomeric or rigid, parts.

FIGS. 38E, 38F and 38G are front views of operator body interface without the computer attached. FIG. 38E shows the computer bottom end holder part 90v with the front and back parts of the mounting feature 77 visible. The body contact part 90u may be or include one or more length adjusters, shown here as a right length adjuster rod 174s3r and a left length adjuster rod 174s31. FIG. 38F shows the body contact part 90u may be or include a removable operator body interface such as, but not limited to, a removable cloth or fabric sheath for fitting the operator's body. FIG. 38G shows the body contact part 90u may include a contact band 90t adapted to attach to length adjuster contact ends and fit the operator's body.

FIG. 39A shows a semi-schematic drawing of the computer 200 (the body panel viewed from the top showing its top edge) encircled by and held in the combination display panel clasp/suspension device component 185b which is (shown in this figure but not limited to) comprised of a display panel clasp 185v (circular band or loop) which may be a circular band or loop of strip-like material adapted to encircle and hold the computer while the clasp is attached to the suspension device 5 that encircles the operator 73 (head/neck/shoulder area) and suspends the computer with display panel from the operator's body for viewing. The display panel clasp may be attached to the suspension device using one or more suspension device/clasp attachments 5a2 and this attachment may include, for example (but not limited to) a ring, sewing 29 and/or a sleeve 32 adapted to hold the clasp and suspension device together. The display panel clasp is adapted to hold the computer and may be (but not limited to) loop-like or band-like and may include a tightening element (a tightener) such as, but not limited to, elastomeric line, elastomeric sponge, spring or other slack absorbing material or mechanism. The display panel clasp may include one or more friction enhancing features 90g, such as nonslip coating, nonslip covering or nonslip structures, and these may be located to contact near (but not limited to) the computer body panel side edges 174y for best traction. The display panel clasp may include a release part fastener 185k1 for opening or closing the clasp loop for computer installation or removal. The fastener may be designed to remove slack from the display panel clasp and make the clasp fit snugly to the computer. The suspension device may include a strap length regulator 5r, such as an adjustable buckle, pinch device or jamming device in association with a suspension device end or loop, as are commonly available on many carrying straps.

For a more compact presentation of the figures, FIG. 39B to 39F concerning the display panel clasp and suspension device are shown in the same style as FIG. 39A but with the operator removed and the suspension device truncated (jagged ends).

FIG. 39B shows a different arrangement of the schematic drawing of FIG. 39A. The majority of the display panel clasp 185 may be a non-elastomeric material (for example, cloth, woven webbing, fabric or plastic) and may include a friction enhancing materials or features 90g such as, but not limited to, elastomeric material, elastomeric knobs, pattern, bumps or ridges stuck to the fabric. Alternative or additional friction enhancing materials or features may include, a (suction) cup 90g9, a gripping projection (bumps) 90g7a, one or more elastomeric projection 90g6a (see also FIG. 9A to FIGS. 9F and 10E). The display panel clasp non-elastomeric part may have ends attached to display panel clasp tightener 185k2 ends and form the loop of the display panel clasp. The display panel clasp tightener may be made of (but not limited to) an elastomeric material, a spring or an elastomeric cushion and have the purpose of removing any slack in the display panel clasp to make the clasp fit snug to and hold to the computer. The display panel clasp non-elastomeric part may be sewn 29, glued, riveted or otherwise attached to the suspension device 5 to attach the clasp and suspension device together. Also shown is that the tightner, for example an elastomeric strip, may be supplemented with a control bypass 185k2a of rigid or semi-rigid material and shaped (for example an arch or ring) to divert the tightner away from (for example, over or around) a computer control such as an on/off switch, button or other control that may otherwise be unintentionally activated by the tightener. The control bypass may be removable from the clasp.

FIG. 39C shows the display panel clasp 185 with the same clasp tightener 185k2 and non-elastomeric part 185k7 of FIG. 39B. In this case, though, the non-elastomeric parts do not completely encircle the computer body panel but are cut short and attached 29 (for example, sewn or riveted) to the suspension device 5. The section of suspension device between the sewn ends of the non-elastomeric parts not encircling the computer body panel represents a combined suspension device/display panel clasp section 185k3. Thus the display panel clasp still encircles and holds the computer. Alternative or additional friction enhancing materials or features may include one or more ridges 90g8, and/or a gripping surface pattern (e.g. grid) 90g11 which may be made of an elastomeric material. Thus, the display panel clasp still encircles the computer and the suspension device attaches to it.

As described and shown in FIGS. 39D and 39F, the display panel clasp and/or suspension device may not always encircle the computer panel.

FIG. 39D shows that the combination display panel clasp/suspension device component may include one or more jaws 185k4 that may be rigid and may be shaped, wedged, tapered, coated or otherwise adapted to fit and hold to the computer body panel side edges. These jaws may be connected using a display panel clasp tightener 185k2 which provides the force to clamp the jaws to the computer body panel and hold the clasp and suspension device to the panel. The display panel clasp is attached to the suspension device 5 (for example, by sewing 29, riveting, binding, tying or otherwise attaching the tightener to the suspension device). In this case the display panel clasp does not encircle the computer. An optional display panel clasp second tightener 185k5 (shown in line with dots) may be used and this would complete the encirclement of the computer (body panel).

FIG. 39E shows that the display panel clasp 185, in this case made of a display panel clasp tightener 185k2 and a display panel clasp non-elastomeric part 185k7, encircle the computer. The clasp (for example the non-elastomeric part) may include one or more friction enhancing features (shown here as a fabric including elastomeric material components 77f such as knobs, bumps or ridges). and may include one or more suspension device/clasp attachments 5a2 (shown as right and left) intended to attach to a strap attachment 5a1 on the suspension device 5 (cut short right and left with jagged line for drawing compactness).

This case illustrates that, in this particular case and in the case of some other types of display panel clasps, a suspension device/clasp attachment 5a2 may be substituted for the suspension device and the suspension device may be removable from the clasp and may be supplied separately from the clasp. Therefore, the combination display panel clasp/suspension device component may be instead a combination display panel clasp/suspension device attachment component 185d.

In the description of a display panel clasp comprised of two jaws the designations “right jaw” and “left jaw” have been used to make the description more understandable. In a case where the arrangement is a mirror image, right and left may be reversed without any change in the function or purpose of the apparatus. Therefore, for claiming purpose, the right jaw 185k4r is equivalent to a “first jaw” and the left jaw 185k41 is equivalent to a “second jaw”. For the same reason, the right end 5n1 of the suspension device is equivalent to the “first end of the suspension device” and the left end 5n2 of the suspension device is equivalent to the “second end of the suspension device”.

FIG. 39F shows, in semi-perspective slightly from above (as in FIG. 39A), an embodiment of the combination display panel clasp/suspension device component 185b, including the display panel clasp and the suspension device 5, for holding a computer 200 to an operator for wearable operation.

In this example, the display panel clasp includes a display panel clasp right jaw 185k4r and a display panel clasp left jaw 185k41. The jaws may be made of a rigid material such as rigid plastic or metal. The jaws are connected with a retraction mechanism 185k9 (in this figure, shown as a ratchet mechanism) capable of drawing together the two jaws and holding the display panel (computer) between the jaws. The retraction mechanism may include one or more matching ratcheting parts 167, elastomeric parts (e.g. bungee cord), friction parts, connecting line (for example, a section of a suspension device), wedging parts or other parts capable of drawing and holding together the jaws with the display panel between the jaws. The display panel clasp right jaw may include a suspension device end attachment 5k designed to attach to a right end 5n1 of the suspension device 5. The display panel clasp left jaw may include an end attachment, in this case shown as an adjustable suspension device attachment 5i designed to attach to the left end 5n2 of the suspension device.

The end of the suspension device is found at its last (final) attachment to the display panel clasp (for example, at a jaw). The suspension device may include surplus length 5o beyond the attachment to the clasp as a consequence of the adjustability of the suspension device. Likewise, because of knotting or looping or splicing or adjustability of the suspension device length, a jaw's suspension device end attachment may not attach to the extreme end of the suspension device (e.g. line or strap).

The attachment of the display panel clasp to the notebook computer may alternatively be to the display panel. To fit the display panel or its edges, instead of the computer body panel, the description of the display panel clasp is the same and no alteration is needed to fit the display panel. Hence, any reference to the computer body panel with regard to the attachment of the display panel clasp to it may be substituted with a reference to the display panel.

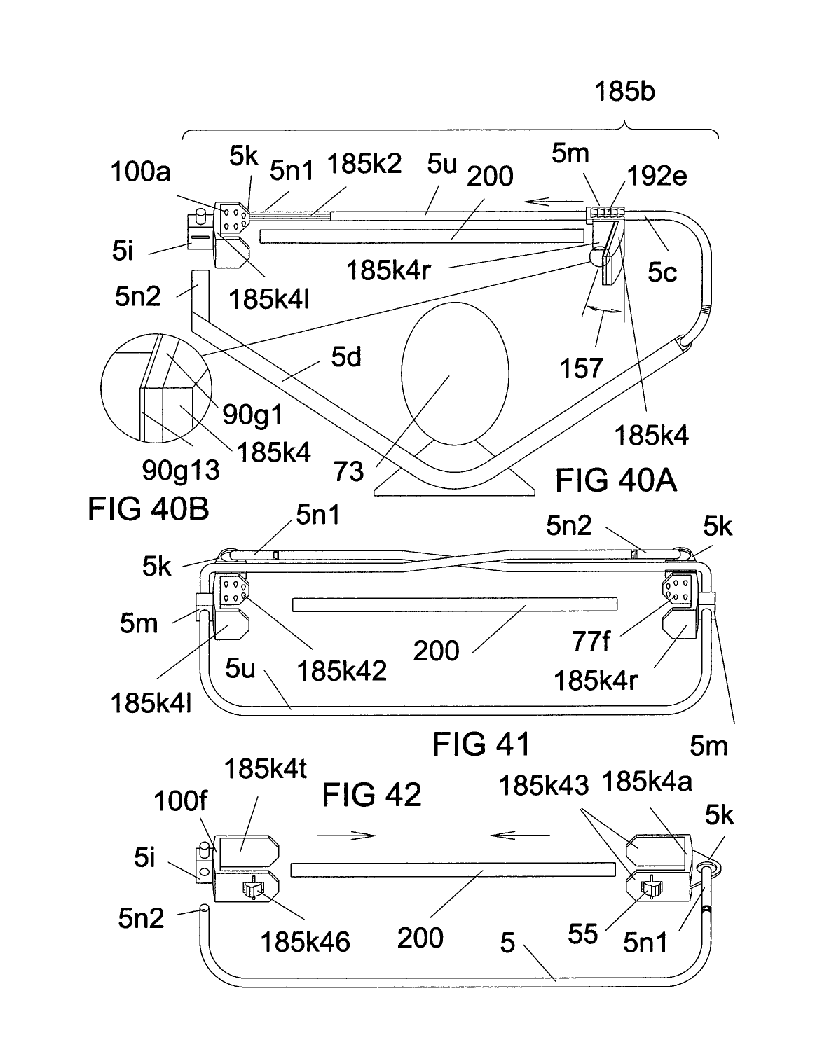

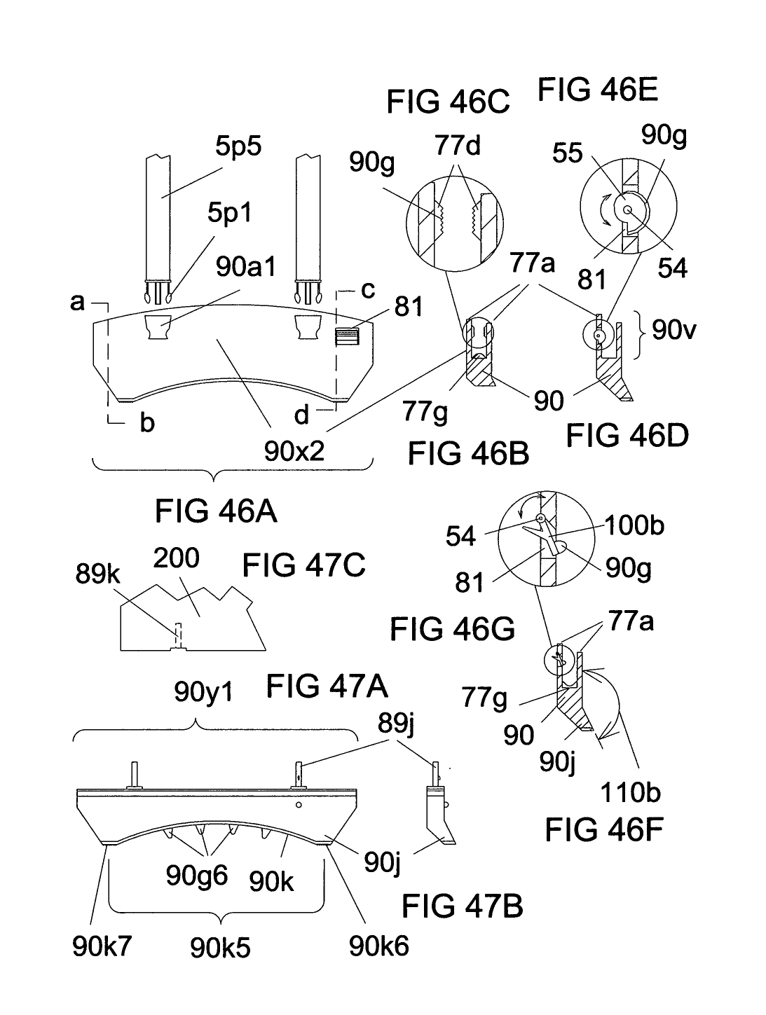

FIG. 40A and FIG. 40B (a magnification of the right jaw) show (schematically in semi-perspective expanded in a top to bottom direction and showing the computer's top edge as in FIG. 39A) the combination display panel clasp/suspension device component 185b of the wearable propping display holder apparatus. This embodiment of the display panel clasp includes two rigid jaws, the right jaw 185k4r and left jaw 185k41. These jaws may include mounting features such as one or more channel forming flanges (see 185k43, FIG. 42) or a flange with angle 157 (see FIGS. 43A and 44A, respectively). The jaws 185k4 may include one or more gripping features 100a (e.g. a friction enhancing feature, a gripping surface pattern, a ridge, a nub, a nodule or other protuberance which may be made of elastomeric material or rigid material) or gripping surface 90g13 such as (but not limited to) a gripping layer which may overlay a compressible and/or elastomeric material 90g1 to aid in the gripping. The right and left jaws may be connected by and configured to clamp to (clasp to) the computer body panel using a combination suspension device/retraction mechanism 5u (including a suspension device right end and a suspension device left end). In this figure, the combination suspension device/retraction mechanism extends from the suspension device right end 5n1 attached to a suspension device end attachment 5k on the left jaw 185k41, then leads behind the computer 200 past the right jaw 185k4r using a fairlead 5m, then around the operator's 73 neck in front of the computer; the suspension device left end 5n2 then attaches to an end attachment on the left jaw, in this case an adjustable suspension device attachment 5i. The combination suspension device/retraction mechanism may include a line 5c, cord or filament and/or may include a strap 5d or belt. The fairlead in this arrangement may include a brake 192e, in this case (but not limited to) jamming wedges in the fairlead channel of the right jaw (see also FIG. 45A). A tightener 185k2, here shown as a short length of elastomeric material (e.g. bungee cord), may be included as a part of the combination suspension device/retraction mechanism to help assure the suspension device remains held by the brake.

FIG. 41 shows a similar arrangement of the combination display panel clasp/suspension device component. In this arrangement, the combination suspension device/retraction mechanism 5u suspension device right end 5n1 attaches to a suspension device end attachment 5k on the left jaw 185k4l with the combination suspension device/retraction mechanism then leading behind the computer 200 past the right jaw 185k4r using a fairlead 5m, then around the operator's neck in front of the computer. The combination suspension device/retraction mechanism then leads past the left jaw 185k41 using a fairlead 5m with the suspension device left end 5n2 again leading behind the computer 200 and attaching to a suspension device end attachment 5k on the right jaw 185k4r. With this arrangement any pull by the operator on the combination suspension device/retraction mechanism increases the clamping force of the right and left jaws on the notebook computer body panel. The clasp jaws may include one or more jaw to computer attachments 185k42, in this case, (but not limited to) one or more friction enhancing features to assure the jaws do not release from the computer if suspension tension is released. A jaw may include a gripping feature such as an elastomeric material component 77f. Alternatively or additional types of jaw to computer attachments may include, for example but not limited to, a holder to computer attachment, a rotating cam, clamping channel forming flanges (see 185k46, 55 and 185k43 respectively, FIG. 42).

FIG. 42 shows another arrangement of the combination display panel clasp/suspension device component may be comprised of one or more computer side edge holders such as a computer right side edge holder 185k4a and a computer left side edge holder 185k4t with each holder configured to attach to the edge of the computer (display panel or body panel). Each computer side edge holder may include one or more holder to computer attachments 185k46 adapted to hold (clasp) the holder to the computer by, for example, the clamping or wedging. For example, the holder to computer attachments may be one or more channel forming flanges 185k43 which may be configured to clamp onto and hold to the computer by, for example, elastomeric material component, jaws or springy flange (see 77f, 77d and 77h, respectively, FIG. 38c). In this figure, one of the holder to computer attachments is (but not limited to) a flange with a rotating cam 55 wedging device which wedges between the holder and the computer to clamp the computer 200 to the computer side edge holder. The suspension device 5 right end 5n1 attaches to a suspension device end attachment 5k on the computer right side edge holder and the suspension device left end 5n2 attaches to a suspension device attachment, shown as an adjustable suspension device attachment 5i (line pinch), on the computer left side edge holder. The top side 100f of the computer left side edge holder is indicated.

FIGS. 43A, 43B and 43C show three views of a display panel clasp left jaw 185k41 which is an example of either a right jaw or a left jaw. FIG. 43A shows a view of the top side 100f of the jaw (i.e. viewed from the top as depicted in FIG. 42). It can be seen that the jaw has a channel forming flange 185k43 mounting feature and may include one or more suspension device attachments 5i (shown as adjustable types), in this case one line pinch as a brake in a fairlead opening and another line pinch for the suspension device length adjustment. This figure also shows a suspension device end attachment 5k, an eye for attaching the end of the suspension device. The jaw may be made of a rigid material such as rigid plastic or metal.

In FIG. 43B, the jaw of FIG. 43A has been rotated 90 degrees to show a view of the jaw of FIG. 43A from the right side. Shown is the fairlead 5m to lead the suspension device around the jaw. A brake 192e (a button for line pinch) associated with this fairlead is also shown.

In FIG. 43C, the jaw of FIG. 43A has been rotated 90 degrees to show a view from the back side 100g of the jaw (the side of FIG. 43A nearest the top of the page). Shown is the fairlead 5m for the suspension device length adjustment. The pinch button 5g for brake of the suspension device length adjustment is also shown.

FIGS. 44A, 44B and 44C show three views of a display panel clasp right jaw 185k4r which is an example of either a right jaw or a left jaw. FIG. 44A shows a view of the top side 100f of the jaw. It can be seen that the jaw has an angled flange 185k45 mounting feature and may include one or more a suspension device end attachment 5k, in this case an eye for attaching the end of the suspension device. The jaw may be made of a rigid material such as rigid plastic or metal.

In FIG. 44B, the jaw of FIG. 44A has been rotated 90 degrees to show a view of the jaw in FIG. 44A from the left side. Shown here, the fairlead 5m is a channel. FIG. 44B also shows that the jaw may include a hook 90w.

In FIG. 44C, the jaw of FIG. 44A has been rotated 90 degrees to show a view of the jaw from the back side 100g (the side of FIG. 44A nearest the top of the page). Shown is the fairlead 5m channel including a brake 192e that is configured of jamming wedges to hold a suspension device line in the channel without slipping.

FIG. 45A to FIG. 45I show details of some various alternative features that may be located on a display panel clasp jaw for attachment, adjustment and guidance of a suspension device or combination suspension device/retraction mechanism. These jaw features are shown attached to a facsimile jaw to present a likeness of specific detail.

FIG. 45A shows a channel fairlead 5m2 and a hole fairlead 5m1 (two types of fairleads) on the same facsimile jaw with the channel fairlead including a jamming wedge 100e brake (a type of brake). This jamming wedge brake is also called a jam cleat or “V” cleat which is a type of belaying cleat.

FIG. 45B shows an adjustable suspension device attachment buckle 5i1 including a sliding bar (a type of brake, suspension device length adjuster or suspension device end attachment).

FIG. 45C shows an adjustable suspension device attachment pinching device 5i2 (a type of brake, suspension device length adjuster or suspension device end attachment) including an opening 5h for the line to be braked (pinched) and a spring loaded button 5g to engage or disengage the pinching device (brake).

FIG. 45D shows an eyelet 5k2 (a type of suspension device end attachment). An eyelet may alternatively be seen as a type of fairlead.

FIG. 45E shows an adjustable suspension device attachment buckle 5i1 including a pivoting bar to block the suspension device movement (a type of brake, suspension device length adjuster and/or suspension device end attachment)

FIG. 45F shows a rotating cam 55 configured to wedge and jam the suspension device (a line or strap) against an abutment (a type of brake and/or suspension device length adjuster).

FIG. 45G shows a hook 90w (a type of fairlead).

FIG. 45H shows and opening 5m1 (a type of fairlead).

FIG. 45I shows channel 5m2 (a type of fairlead).

FIG. 46A to FIG. 46G show the operator body interface adapted to attach to the bottom end of the computer (body panel) such as a notebook computer body panel. In FIG. 46A, the operator body interface back side 90x2 is shown and includes one or more channel forming flanges comprising a computer holding mounting feature. In this figure, the flange includes one or more openings 81 for one or more mounting feature attachments to contact through the flange to the computer panel held in the mounting feature. FIG. 46A also shows that the operator body interface, for example its back side 90x2, may include one or more operator body interface carrier attachments 90a1 meant to attach to one or more interface carrier to interface attachments 5p1 on interface carriers 5p5 (shown as a strap).

FIG. 46B and magnification FIG. 46C show the operator body interface 90 viewed from the right side of FIG. 46A at cross section a/b. Its back side 90x2 is on the left. In this figure, the mounting feature serving to attach the operator body interface to the computer body panel bottom end includes two channel forming flanges 77a which have one or more jaws 77d with friction enhancing features 90g. The flanges and jaws may provide enough elasticity to flex when the computer is installed to the operator body interface and apply pressure and friction to hold the computer to the interface.

Examples may include (but not limited to) knobs, fingers, ridges, blades, points or leaves made of elastomeric and/or plastic material. With this arrangement, the operator body interface is installed and detached to the computer body panel bottom end using force only. The channel formed by the flanges may also include a channel bottom stabilizer 77g, a shaped cushion intended to contact the bottom end of the computer body panel held in the channel and stop the end from moving.

FIG. 46D and magnification FIG. 46E show the operator body interface 90 viewed at cross section c/d and shown from the right side of FIG. 46A. They show a rotating cam type 55 wedging device pivoting on an axle 54 and projecting through an opening 81 in the mounting feature flange 77a of the computer bottom end holder part 90v. The cam may include a friction enhancing features 90g which contacts the computer body panel and will not allow the interface to be removed from the computer unless the cam is rotated to release its grip.

FIG. 46F and magnified in FIG. 46G show the operator body interface 90 shown viewed from the right side of FIG. 46A at cross section c/d. They show the same operator body interface of FIG. 46F but with an alternative mounting feature (attachment) including a pivoting arm wedging device 100b pivoting on an axle 54 and projecting through an opening 81 in the mounting feature flange 77a. The pivoting arm wedging device may include a friction enhancing feature 90g which contacts the Computer body panel and will not allow it to be removed unless the arm is pivoted to disengage the arm. Also shown in FIG. 46F is that a mounting feature channel bottom stabilizer 77g may be included to improve the fit of the computer body panel bottom end to the computer bottom end holder part 90v (see FIG. 46D) of the operator body interface. The channel bottom stabilizer may include compressible material, an angled, concave or convex surface and/or gripping surface and may be adapted to meet and restrict the movement of the computer body panel bottom end of one or more different types of computers. FIG. 46F also shows that the operator body interface 90 leg 90j may be angled 110b (shown in the figure with a 154 degree outside angle but may be set to any useful angle) toward the operator's body to allow the interface to hold the apparatus and computer in an almost vertical position and nearly parallel to the operator's front stomach/chest area when in operation.

FIG. 47A and FIG. 47B show the operator body interface (shown as a removable operator body interface 90y1) in a front view and a side view from the left, respectively. They show that the operator body interface may include one or more mounting features that are removable interface attachments 89j specifically made to attach to one or more matching attachments on the computer panel bottom end (for example, a display panel proximal attachment edge or a computer body panel bottom end). In this figure, the removable interface attachment is shown as a dowel, pipe or rod designed to match a hole or socket in the bottom end of the computer panel. Alternatively, other examples of an attachment on the interface matching the computer may include (but not limited to) matching snaps or latches, friction fitting, matching channels or tracks, clamp or other kind of attachment.

The removable interface attachment may be made to match any intentional attachment feature on the computer panel or display panel. Also shown are additional features on the operator body interface which serve to provide tipping stability and slipping stability between the operator body interface and the operator's front stomach/chest surface area. These include a shaping 90k to stabilize the apparatus against the operator's body and gripping projections 90g6 (for example, bumps or points) which may be made of elastomeric material for grip and comfort. The left side view, FIG. 47B, shows the operator body interface with the removable interface attachments 89j and a lower part of the operator body interface that acts as an interface leg 90j for stabilizing the computer on the operator's body.

FIG. 47A is an example of an operator body interface 90, in this case a removable operator body interface, providing for tipping stability by including a lateral stability member 90k5 with two laterally separated surfaces (90k6 and 90k7) contactable with the operator's body front stomach/chest surface area.

FIG. 47C shows a bottom left section of a computer panel 200 (top and right parts of the panel cut away with jagged lines). The computer panel, such as a computer body panel or display panel, may include one or more removable interface prop attachments 89k (including dashed lines) to match the removable interface attachment such as the one shown in FIG. 47A (89j) and hold the removable operator body interface to the computer panel, for example, at its computer body panel bottom end or display panel proximal attachment edge.

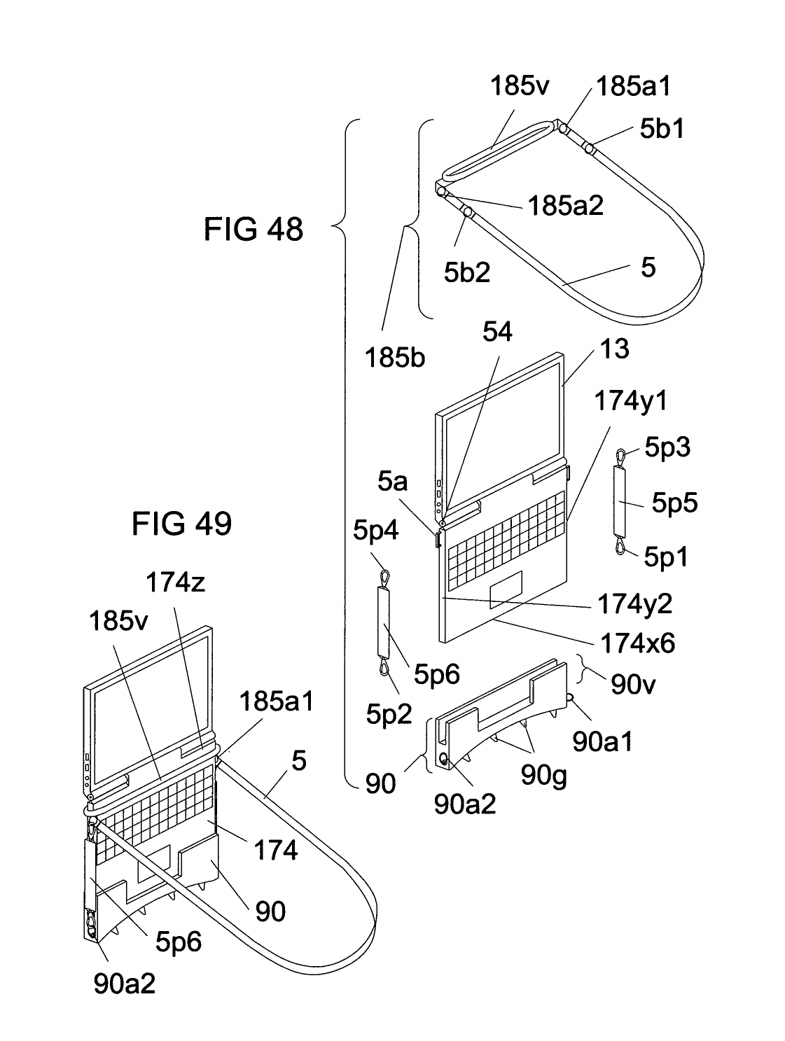

FIG. 48 is an exploded view of a notebook style computer and a wearable propping display holder apparatus embodiment adapted to double as a notebook computer carrier. The notebook style computer includes a display panel 13 and a computer body panel 174 pivotally attached using a hinge 54. The operator body interface 90 includes a computer bottom end holder part 90v meant to attach the interface to the bottom end 174x6 of the computer body panel. The operator body interface may include one or more operator body interface carrier attachments, for example (but not limited to), a right side operator body interface carrier attachment 90a1, a left side operator body interface carrier attachment 90a2. The operator body interface carrier attachments may be used to attach one or more interface carriers to the operator body interface. The operator body interface may include a body contact part with one or more friction enhancing features 90g designed to provide slipping stability and temporarily hold the interface to the operator's body without sliding.

The wearable propping display holder apparatus may also include a combination display panel clasp/suspension device component 185b. The suspension device 5 is designed to suspend the computer from the operator's upper body (neck/shoulder area) while the operator body interface is pressing against the operator's body front surface. The combination display panel clasp/suspension device component also includes a display panel clasp 185v, shown in this figure as a circular band or loop of strip-like material designed to encircle the computer and hold the suspension device in place to the computer while covering little of the computer surface to allow access to computer controls (for example, the keyboard or pointing device) found there. The display panel clasp loop may be made partially or wholly of a tightener element (for example, a spring or elastomeric material) to tighten the clasp and hold it to the computer. The combination display panel clasp/suspension device component may include one or more display panel clasp carrier attachments, for example, a right side display panel clasp carrier attachment 185a1 and a left side display panel clasp carrier attachment 185a2. These attachments may be used to attach one or more interface carriers to the suspension device and/or display panel clasp. FIG. 48 also shows that the notebook computer may be supplied with built-in suspension device attachments 5a positioned near the central attachment zone and designed to hold the computer for use in combination with the operator body interface in a wearable operating position on the operator. The combination of the built-in suspension device attachment and suspension device may be an alternative for the combination display panel clasp/suspension device component.

The suspension device may include one or more carrier to suspension device attachments to attach the suspension device to the interface carrier independently from the suspension device/clasp attachments (see 5a2, FIGS. 39A and 39E). There may be, for example (but not limited to), a right side carrier to suspension device attachment 5b1 and a left side carrier to suspension device attachment 5b2 and these may attach to, for example, the right side interface carrier to display panel clasp attachment 5p3 and the left side interface carrier to display panel clasp attachment 5p4 (respectively). The purpose for separately attaching the suspension device to the interface carrier is to allow the suspension device to take the weight of the computer while in a storage position hanging (for example) from the operator's shoulder and allowing the section of suspension device between the display panel clasp carrier attachment and the carrier to suspension device attachment to become slack and remove any force which may tend to disengage the clasp from the computer.

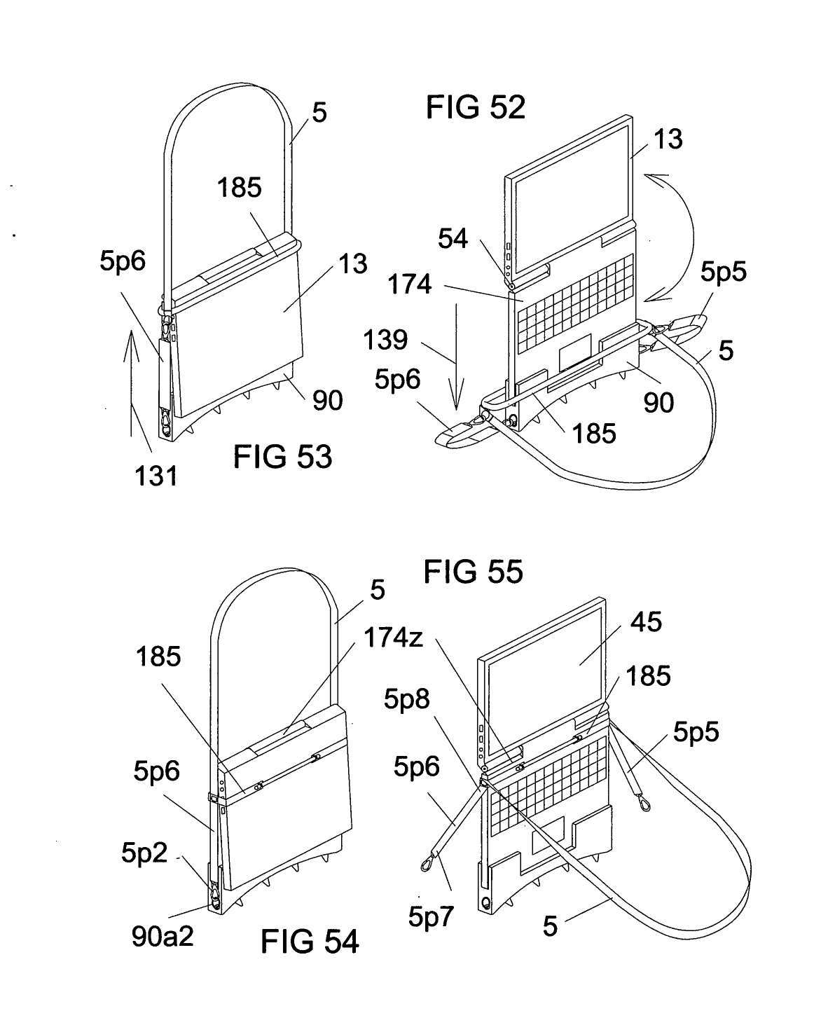

The operator may be in a situation where he wants to continuously move and keep the notebook computer with him while using the computer intermittently. He may want to occasionally close the computer and hang it from his shoulder by the suspension device and do this with the minimal set up. The loop-like display panel clasp is simple to use but may inhibit the closing of the display panel to the body panel. The display panel clasp may be moved downward (see FIG. 52), the display panel pivoted closed against the computer body panel and the clasp moved back upward over both panels to near its original position. However, the clasp may not hold the computer securely enough to hang the computer by the suspension device (see FIG. 60). To solve this problem this embodiment of the wearable propping display holder apparatus may include one or more interface carriers such as (but not limited to) a right side interface carrier 5p5 and a left side interface carrier 5p6 (both shown as straps). The interface carrier may be made of strap, fabric, fabric sheet, belt, line, cord, chain, cable, or other material capable of suspending the operator body interface and computer from the clasp and suspension device. There may be more than one interface carrier and they may be attached to each other with fabric or additional straps. Each interface carrier includes an interface carrier interface end and an interface carrier clasp end (see 5p7 and 5p8 in FIG. 55) for attaching the interface carrier to the operator body interface and the display panel clasp (and/or suspension device), respectively, and for connecting the interface, clasp and suspension device together. The one or more interface carriers may extend between the operator body interface and the combination display panel clasp/suspension device component 185b. As shown in FIG. 48, there may be two interface carriers, one near the computer body panel right side edge 174y1 and one near the computer body panel left side edge 174y2.

In the example shown in the figure, the apparatus includes two interface carriers (right and left). One or more of the attachments shown may be removably or permanently attached. For attaching the interface carrier interface end to the operator body interface, the right side interface carrier may include a right side interface carrier to interface attachment 5p1. For attaching the interface carrier clasp end to the display panel clasp, the right side interface carrier may include a right side carrier to display panel clasp attachment 5p3. These are designed to fit the right side operator body interface carrier attachment 90a1 and the right side display panel clasp carrier attachment 185a1 (or suspension device/clasp attachment 5a2 (FIG. 39E) or right side carrier to suspension device attachment 5b1) respectively. In this way, the interface carrier may be attached to the display panel clasp, to the suspension device, to the suspension device attachment, to the combination display panel clasp/suspension device component or to the combination display panel clasp/suspension device attachment component.

Similarly, the left side interface carrier may have a left side interface carrier to interface attachment 5p2 and left side carrier to display panel clasp attachment 5p4. These are designed to fit the operator body interface left side operator body interface carrier attachments 90a2 and the left side display panel clasp carrier attachment 185a2 (or suspension device/clasp attachment 5a2 (FIG. 39E) or left side carrier to suspension device attachment 5b2) respectively. In this way, the interface carrier may be attached to the display panel clasp, to the suspension device, to the suspension device attachment, to the combination display panel clasp/suspension device component or to the combination display panel clasp/suspension device attachment component.

FIG. 49 shows the computer and apparatus components of FIG. 48 assembled and the notebook computer in an operating position. The display panel clasp v (circular band or loop) attaches to the computer near the computer body panel 174 top end 174z (in the central attachment zone) and holds the suspension device 5 to the computer. This type of display panel clasp (circular band or loop) extends in a direction parallel to the notebook computer hinge axis (see 54i, FIG. 51) to encircle the computer. It can be seen that, because of the narrow band-like or strip-like structure of the clasp, the computer's controls are still accessible by the operators while the computer is mounted to the apparatus. The operator body interface 90 is attached to the computer body panel bottom end. The one or more interface carriers (e.g. 5p6) attach the operator body interface 90 to the combination display panel clasp/suspension device component 185b. Right and left side operator body interface carrier attachment (e.g. 90a2), interface carrier to interface attachment (e.g. 5p2), interface carrier (e.g. 5p6), interface carrier to display panel clasp attachment (e.g. 5p4) and display panel clasp carrier attachment (e.g. 185a2) may be used to serve this purpose. As shown in this figure, the display panel clasp may move downward but not upward.

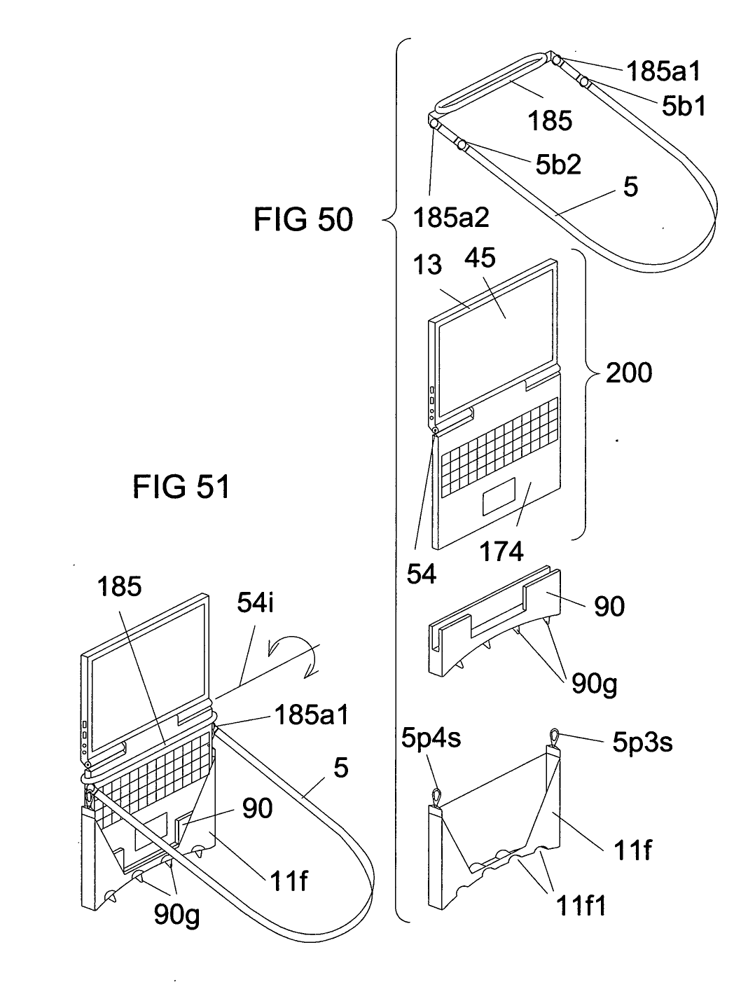

FIG. 50 is an exploded view of a notebook style computer and a wearable propping display holder apparatus adapted to double as a notebook computer carrier. It shows that, alternatively to the carrier arrangement of FIGS. 48 and 49, the interface carrier may be an interface carrier sling 11f and may be substituted for the one or more strap-like interface carriers and used to attach the display panel clasp 185 to the operator body interface 90. The notebook style computer 200 includes a display panel 13 with an electronic display 45 and a body panel 174 pivotally attached using a hinge 54. The operator body interface 90 attaches to the computer body panel bottom end as in, for example, FIGS. 37A and 38A. One or more friction enhancing features 90g (e.g. gripping projections) may be included on the operator body interface.

The wearable propping display holder apparatus in this figure also includes a combination display panel clasp/suspension device component including a suspension device 5 designed to suspend the computer from the operator's upper body (neck/shoulder) while the operator body interface is pressing against the operator's body front stomach/chest surface area. The combination display panel clasp/suspension device component also includes a display panel clasp 185, shown in this figures as (but not limited to) a loop designed to encircle the computer and hold the suspension device in place to the computer. The combination display panel clasp/suspension device component may include one or more attachments to attach this component to an interface carrier sling 11f, the attachments being, for example (but not limited to), a right side display panel clasp carrier attachment 185a1 and a left side display panel clasp carrier attachment 185a2.

For an alternative way to attach the interface carrier sling to the combination display panel clasp/suspension device component or suspension device, the suspension device may include one or more carrier to suspension device attachments such as a right side carrier to suspension device attachment 5b1 and a left side carrier to suspension device attachment 5b2. This arrangement may shift the weight of the computer from the display panel clasp to the suspension device while hung in a storage position.

An interface carrier sling 11f may be used to hold the operator body interface and computer especially when it is being carried in a storage position hung by the suspension device from the operator's (wearer's) shoulder. The sling may be (but not limited to) strap-like, net-like, pocket-like or bag-like and may enclose part of the computer and/or leave part of the computer exposed (for example, the keyboard). The sling may use its shape or attachments to hold itself to the operator body interface and/or computer. The sling may include one or more attachments such as a right side sling to display panel clasp attachment 5p3s and a left side sling to display panel clasp attachment 5p4s configured to attach the interface carrier sling to the display panel clasp, to the suspension device, to the suspension device attachment, to the combination display panel clasp/suspension device component or to the combination display panel clasp/suspension device attachment component. The sling may include one or more carrier sling openings 11f1 to allow friction enhancing features 90g to contact the operator through the sling material and provide tipping stability and sliding stability between the operator body interface and the operator's front stomach/chest surface.

FIG. 51 shows the computer and apparatus components of FIG. 50 assembled with the computer in an operating position. The display panel clasp 185 attaches to the computer near the computer body panel top end and holds the combination display panel clasp/suspension device component, including the suspension device 5, to the computer. The operator body interface 90 is attached to the computer body panel bottom end. The interface carrier sling 11f may hold the computer body panel bottom end, the operator body interface and/or possibly some area near the computer body panel bottom end, and uses one or more sling to display panel clasp attachments to attach the interface carrier sling to the display panel clasp, to the suspension device, to the suspension device attachment, to the suspension device/clasp attachment, to the combination display panel clasp/suspension device component or to the combination display panel clasp/suspension device attachment component. For this purpose, this figure shows one or more display panel clasp carrier attachment (e.g. 185a1). One or more of the attachments or the attachment between the operator body interface and the sling may be removably or permanently attached. The openings in the bottom of the sling allow the friction enhancing feature 90g (e.g. gripping projections) to contact and stick to the operator (wearer). FIG. 51 also shows the notebook computer hinge axis 54i of the hinge that attaches the display panel to the body panel of the notebook computer. This axis is parallel to the display panel proximal attachment edge and to the body panel top end. The display panel clasp (shown as a circular band or loop) is shown attached to the computer and extending in a direction parallel to the notebook computer hinge axis.

FIG. 52 shows the notebook computer in an open operating position with the combination display panel clasp/suspension device component (display panel clasp 185 and suspension device 5) slid in a downward direction 139 toward the bottom end of the computer body panel 174. The right side interface carrier 5p5 and a left side interface carrier 5p6 collapse on the right and left of the computer. The operator body interface 90 stays in place. The display panel 13 of the computer may now be pivoted on the hinge 54 into a closed storage position.

In FIG. 53, the computer display panel and body panel have been moved into a closed storage position with the combination display panel clasp/suspension device component (display panel clasp 185 and suspension device 5) moved in an upward direction 131 back to their operating position location near the top end of the computer body panel. The display panel clasp has been moved on the outside of the display panel 13 to encircle both the computer body panel and display panel, now side by side in a closed storage position. The notebook computer can be shut nearly completely. The interface carriers (e.g. 5p6, a strap), attached to the operator body interface 90, keep the display panel clasp from disengaging (detaching) upward from the computer.

For security, while carrying the computer in storage position, the interface carriers may be shorter than appropriate for placement of the display panel clasp during operation. This places the display panel clasp well below the hinge area (central attachment zone) while the computer is hung by the operator's shoulder in a storage position so there is no chance the computer might slip below and out of the clasp and fall. To change to an operating position, the interface carriers may be disconnected from the operator body interface to shift the display panel clasp closer to the top end of the computer body panel and into the central attachment zone.

The connection between the interface carriers, display panel clasp and/or suspension device may be done partially or completely by permanent attachment (for example, sewn or riveted). This connection may include a ring to hold the suspension device which may pivot (about 90 degrees) from the operating position (neck suspended) to a storage position (shoulder suspended). The attachments from the interface carriers to the operator body interface may be of a quick release type.

FIG. 54 shows the notebook computer again in a closed storage position. The interface carrier to display panel clasp attachment (5p3 and 5p4 in FIG. 48) and the display panel clasp carrier attachments (185a1 and 185a2 in FIG. 48) have been removed and the interface carrier attached (shown as sewn) directly to the display panel clasp where the suspension device, display panel clasp and interface carrier join together. The interface carriers may be extensions of the suspension device. Notice that the display panel clasp 185 is located slightly further downward from the computer body panel top end 174z. This is because the interface carriers (e.g. 5p6) are shorter and serves the purpose of carrying security so the clasp cannot possibly slip up and off the computer. The interface carrier to interface attachment (e.g. 5p2) is attached to the operator body interface carrier attachment (e.g. 90a2). The suspension device 5 is in a position for carrying the computer hanging from a shoulder.

FIG. 55 shows the arrangement of FIG. 54 except that the notebook computer is in an open operating position with the electronic display 45 visible. It can be seen that, now, the display panel clasp 185 is located closer to the computer body panel top end 174z. Because the interface carriers, 5p5 and 5p6 (shown as straps), are shorter, they are detached from the operator body interface to properly position the display panel clasp in the central attachment zone during operation. The suspension device 5 is in a position for suspending from the operator's neck or shoulder for viewing. Also shown in this figure is that each of the one or more interface carriers has an interface carrier interface end 5p7 for attaching to the operator body interface and an interface carrier clasp end 5p8 for attaching to the display panel clasp, the suspension device and/or a suspension device attachment.

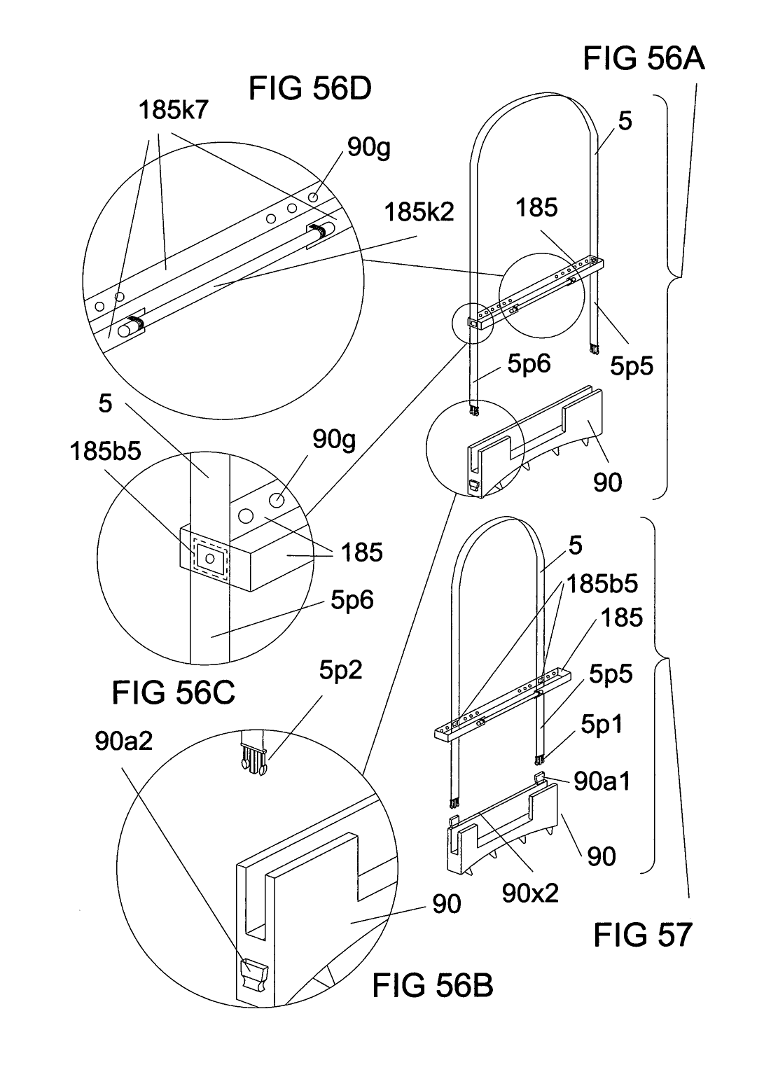

FIGS. 56A, 56B, 56C and 56D show detail of a simplified version of the wearable propping display holder apparatus with carrier for a notebook style computer as shown in FIG. 55. FIG. 56A shows the basic parts including a suspension device 5, a display panel clasp 185 (shown as a loop of a combination of elastomeric and non-elastomeric materials), an operator body interface 90 and right and left interface carriers, 5p5 and 5p6, for connecting the operator body interface to the suspension device and display panel clasp.

FIG. 56B shows a magnified view of the interface carrier to interface attachment 5p2 (left side shown) positioned for attachment to the operator body interface 90 carrier attachment 90a2 (left side shown). These matching attachments simplify the attachment and detachment of the combination display panel clasp/suspension device component (or combination display panel clasp/suspension device attachment component) to/from the operator body interface when using the interface carriers to shift between an operating position and a storage position.

FIG. 56C shows a magnified view of the area of attachment of the suspension device 5, display panel clasp 185 and interface carrier 5p6 (left side). For simplification, this attachment may be a clasp multi connection 185b5 of the device, clasp and carrier by (but not limited to) sewing, riveting or shared ring attachment. Also show is that the display panel clasp may include one or more friction enhancing features 90g, such as elastomeric material or other sticking material, gripping surface patterns, projections or shapes.

FIG. 56D shows that the display panel clasp may be made of a non-elastic part 185k7, such as belt, cloth, webbing, strap or line, and a tightener 185k2, possibly made of elastomeric material such as rubber, bungee cord or spring, configured to allow the clasp to alternately be expanded or retracted for securely installing, positioning or removing the clasp to/from the computer. Again, friction enhancing features 90g on the clasp inner surface are shown.

FIG. 57 shows an arrangement of the suspension device 5, display panel clasp 185, interface carriers (e.g. 5p5, shown as a strap) and operator body interface 90 similar to FIG. 56A. In this figure, though, the interface carriers have been moved from the right and left sides to the back side of the operator body interface, display panel clasp and, when installed, the computer. Mounting (fixing) the operator body interface carrier attachments 90a1 to the back side 90x2 of the operator body interface (shown as a flange on the interface back side) may serve to reduce the size (especially right to left length) of the operator body interface for easier storage in baggage when not being used (see FIG. 46A). The operator body interface carrier attachments attach to the interface carrier to interface attachments 5p1 and on the interface carrier 5p5. The suspension device, interface carriers and display panel clasp may be attached together by a clasp multi connection 185b5 using, for example (but not limited to) sewing, riveting or shared ring attachment, at their junction. The one or more interface carriers may be extensions of the suspension device.

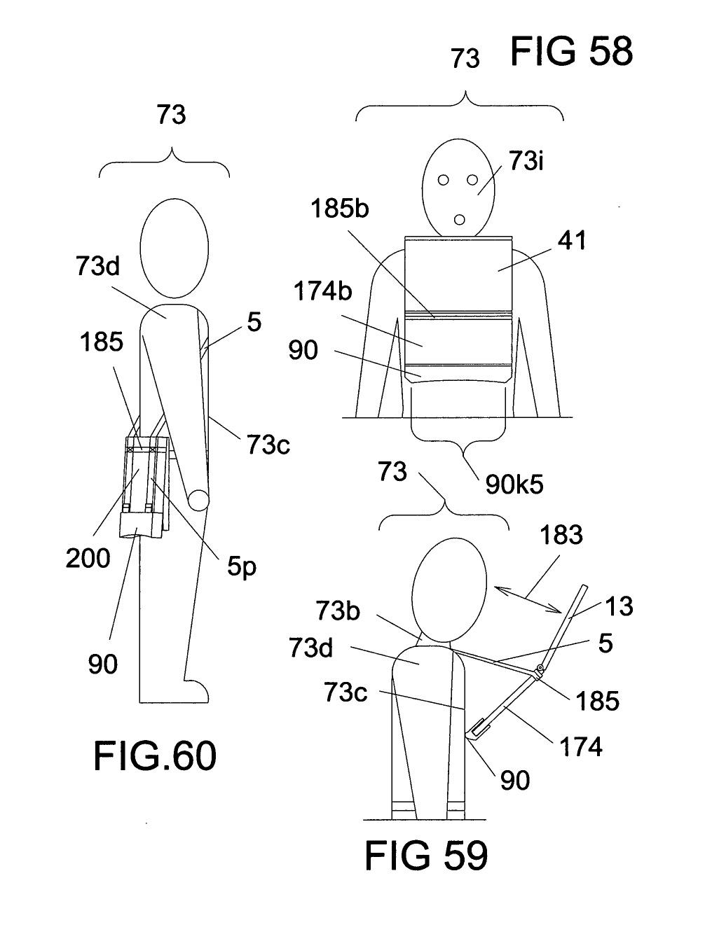

FIG. 58 to FIG. 60 show the wearable propping display holder apparatus for a notebook computer being used by an operator. FIG. 58 shows the operator 73 with his face 73i facing front (toward the application reader) and wearing the wearable propping display holder apparatus in an operating position. The back side 41 of the notebook computer display panel and the back side 174b of the computer body panel are visible. The operator body interface 90 is in contact with the operator's front stomach/chest surface area and forms a lateral stability member 90k5 with two laterally separated surfaces which provides tipping stability for the apparatus and computer combination. The combination display panel clasp/suspension device component 185b clasps the computer and suspends it from the operator's neck/shoulder area.

FIG. 59 shows the operator 73 and wearable propping display holder apparatus shown in FIG. 58 but from a left side view (profile). The operator body interface 90 is attached to the bottom end of the computer body panel 174 and in contact with the operator's front stomach/chest surface area 73c (see also FIG. 60). The computer body panel acts as an operator body prop to push the display panel away from the operator's body and into his comfortable line of sight 183. The suspension device 5 suspends the notebook computer from the operator's neck 73b and/or shoulder 73d area. The suspension device 5 may attach to the computer using the display panel clasp 185 (for example a combination display panel clasp/suspension device component) so that the display of the display panel 13 is in the view (line of sight) of the operator.

FIG. 60 shows a left side view (profile of FIG. 58) of the operator with the notebook computer 200 in a storage position and suspended from the operator's 73 shoulder 73d by the suspension device 5. The interface carrier 5p (two straps shown) attaches the operator body interface 90 (back side shown) to the display panel clasp 185 and suspension device so the display panel clasp will not disengage (detach) upward and off the computer while being hung and carried in a storage position.

The inventions and components presented in FIG. 37A to FIG. 60 may be seen as a system for holding a display panel to an operator's body for mobile use and may include 1) the operator body interface adapted to attach to a computer body panel bottom end and 2) the combination display panel clasp/suspension device component adapted to attach to the computer. The intent of this system is wearable viewing of the display by using the suspension device to suspend the computer from the operator's head/shoulder area while the operator body interface temporarily holds the computer bottom end to the operator and the computer body panel pushes the computer's display panel away from the operator's front chest/stomach area and into the operator's line of sight.

1. A system for attaching a computer to an operator for mobile usage, the system comprised of:
a) a combination display panel clasp/suspension device component comprising;
i) a suspension device;
ii) a display panel clasp configured to attach the suspension device to the computer while in an operating position;
b) an operator body interface component comprising;
i) a bottom end holder part including at least one mounting feature; and
ii) a body contact part attached to the bottom end holder part and including a lateral stability member with two laterally separated surfaces contactable with the operator when the operator body interface is in an operating position.

2. The system of claim 1 wherein the suspension device is removably attached to the display panel clasp.

3. The system of claim 2 wherein the display panel clasp is further comprised of a structure selected from a group consisting of a suspension device/clasp attachment, a suspension device attachment, an adjustable suspension device attachment, an eyelet, a fairlead, a suspension device end attachment, a brake and a combination thereof.

4. The system of claim 1 wherein the display panel clasp is comprised of a circular band configured to extend in a direction parallel to a computer hinge axis, encircle the computer and hold the suspension device to the computer.

5. The system of claim 4 wherein the circular band is further comprised of a friction enhancing feature.

6. The system of claim 5 wherein the friction enhancing feature is comprised of a structure selected from a group consisting of a friction enhancing material, an elastomeric projection, an elastomeric material component, a gripping projection, a gripping surface, an elastomeric gripping surface, a ridge, a cup, a gripping surface pattern and a combination thereof.

7. The system of claim 1 wherein the display panel clasp includes two jaws.

8. The system of claim 7 wherein the two jaws are connected using a one of a retraction mechanism and a combination suspension device/retraction mechanism.

9. The system of claim 7 wherein one of the jaws is further comprised of a gripping feature.

10. The system of claim 9 wherein the gripping feature is comprised of a structure selected from a group consisting of an elastomeric material, an elastomeric material component, a gripping surface, a flange, a flange with angle, a rotating cam, a jaw to computer attachment, a clamping channel forming flange, a holder to computer attachment and a combination thereof.

11. The system of claim 1 wherein the display panel clasp is comprised of one or more computer side edge holders.

12. The system of claim 1 wherein the display panel clasp is further comprised of a tightener.

13. The system of claim 1 wherein the body contact part is further comprised of a friction enhancing feature.

14. The system of claim 13 wherein the friction enhancing feature is comprised of a structure selected from a group consisting of a gripping surface, a cushion, a blade, an elastomeric material component, a rigid material, a gripping projections, a bump, a ridge, a friction enhancing cup, a sticking surface pattern, an abrasive surface, an interface leg, an angled interface leg, a shaping, a concave shaping, a drum-shaped contact surface, a specialty shaping, a pivoting interface and a combination thereof.

15. The system of claim 1 wherein the body contact part is further comprised of an operator linking attachment.

16. The system of claim 1 wherein the lateral stability member is further comprised of a structure selected from a group consisting of a right interface leg and left interface leg, a right length adjuster rod and left length adjuster rod, a shaping to compliment the operator's body and a combination thereof.

17. The system of claim 1 wherein the bottom end holder is further comprised of a mounting feature.

18. The system of claim 17 wherein the mounting feature is comprised of a structure selected from a group consisting of a rotating cam, a channel, a jaw, a flange, an opposite flange, an elastomeric material component, a channel bottom stabilizer, a springy flange, a channel forming flange, a mounting feature flange, a friction enhancing feature, a pivoting arm wedging device, a wedging device, a removable interface attachment and a combination thereof.

19. The system of claim 1 wherein the operator body interface is further comprised of a length adjuster.

20. An interface apparatus for fitting a computer to an operator for wearable use, the apparatus comprised of:
a) an operator body interface including a bottom end holder part with at least one mounting feature configured to removably attach the operator body interface to the computer; and
b) a body contact part attached to the operator body interface and including a lateral stability member with two laterally separated surfaces contactable with an operator when the operator body interface is in the operating position.

21. The apparatus of claim 20 wherein the body contact part is further comprised of a friction enhancing feature.

22. The apparatus of claim 21 wherein the friction enhancing feature is comprised of a structure selected from a group consisting of a gripping surface, a cushion, a blade, an elastomeric material component, a rigid material, a gripping projections, a bump, a ridge, a friction enhancing cups, a sticking surface pattern, an abrasive surface, an interface leg, an angled interface leg, a shaping, a concave shaping, a drum-shaped contact surface, a specialty shaping, a pivoting interface and a combination thereof.

23. The apparatus of claim 20 wherein the body contact part is further comprised of an operator linking attachment.

24. The apparatus of claim 20 wherein the lateral stability member is further comprised of a structure selected from a group consisting of a right interface leg and left interface leg, a right length adjuster rod and left length adjuster rod, a shaping to compliment the operator's body and a combination thereof.

25. The apparatus of claim 20 wherein the mounting feature is comprised of a structure selected from a group consisting of a rotating cam, a channel, a jaw, a flange, an opposite flange, an elastomeric material component, a channel bottom stabilizer, a springy flange, a channel forming flange, a mounting feature flange, a friction enhancing feature, a pivoting arm wedging device, a wedging device, a removable interface attachment and a combination thereof.

26. The apparatus of claim 20 wherein the operator body interface is further comprised of a length adjuster.

27. An apparatus for holding a computer to an operator for wearable use, the apparatus comprised of:
a. a suspension device; and
b. a display panel clasp comprised of a circular band configured to extend in a direction parallel to a computer hinge axis, encircle the computer and hold the suspension device to the computer while in an operating position.

28. The apparatus of claim 27 wherein the suspension device is removably attached to the display panel clasp.

29. The apparatus of claim 28 wherein the display panel clasp is further comprised of suspension device/clasp attachment.

30. The apparatus of claim 27 wherein the display panel clasp is further comprised of friction enhancing feature.

31. The apparatus of claim 30 wherein the friction enhancing feature is comprised of a structure selected from a group consisting of a friction enhancing material, an elastomeric projection, an elastomeric material component, a gripping projection, a gripping surface, an elastomeric gripping surface, a ridge, a cup, a gripping surface pattern and a combination thereof.

32. The apparatus of claim 27 wherein the display panel clasp is further comprised of a tightener.
